(19) United States
(12) Patent Application Publication
(10) Pub. No.: US 2007/0099692 A1
(43) Pub. Date: May 3, 2007

(54) Gaming machine

(75) Inventors: Takaaki Hishinuma, Tokyo (JP); Takayuki Hirauchi, Tokyo (JP); Yousuke Kamada, Tokyo (JP); Yasutaka Kuroda, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/392,933

(22) Filed: Mar. 30, 2006

(30) Foreign Application Priority Data
Oct. 28, 2005 (JP) 2005-315256
Oct. 28, 2005 (JP) 2005-315257
Oct. 28, 2005 (JP) 2005-315258
Nov. 25, 2005 (JP) 2005-340587

(51) Int. Cl. A63F 13/00

(52) U.S. Cl. 463/20

(57) ABSTRACT

Disclosed is a gaming machine. The gaming machine 1 comprises a main control circuit 71, which starts an operation of replay time, on condition that a combination of symbols consisting of at least two types of symbols is displayed by a combination of symbol display areas connected by an activated line.

### CROSS-REFERENCE TO RELATED APPLICATIONS

This application is based upon and claims the benefit of priority from the prior Japanese patent Application No. 2005-315256, filed on Oct. 28, 2005, No. 2005-315257, filed on Oct. 28, 2005, No. 2005-315258, filed on Oct. 28, 2005, No. 2005-340587, filed on Nov. 25, 2005.

### BACKGROUND OF THE INVENTION

1. Field of the Invention

The present invention relates to a gaming machine.

2. Description of Related Art

It has been conventionally known a gaming machine, so-called, a pachi-slot machine comprising a plurality of reels, each of which having plural symbols arranged on a periphery thereof; plural display windows mounted to correspond to each of the reels and displaying some of the plural symbols arranged on the periphery of each reel so as to allow a player to see them; a start switch for outputting a signal requesting start of rotation of each reel, based on an operation by the player (hereinafter, referred to as ┌start operation┘), on condition that a medal has been inserted; a stop switch for outputting a signal requesting stop of the rotation of the reel, correspondingly to types of the reels, based on an operation by the player (hereinafter, referred to as ┌stop operation┘); a control unit for controlling an operation of a stepping motor to rotate and stop the respective reels, based on the signals outputted from the start switch and the stop switch. In the pachi-slot machine, it is determined whether a winning combination is achieved on the basis of a combination of symbols displayed by the display windows, and a medal is paid out when it is determined that a winning combination is achieved.

At present time, in the pachi-slot machine forming the mainstream, if the start operation by the player is detected, an internal lottery is carried out and an operation of stopping the reel rotation is performed, based on the lottery result and the timing of the stop operation by the player. In other words, benefit such as winning is awarded, on condition that a result relating to a winning by the internal lottery (hereinafter, a kind of the result of the internal lottery will be referred to as ┌internal winning combination┘) is obtained and the stop operation is carried out at an appropriate timing.

In recent years, as disclosed in a Japanese Patent Laid-Open No. 2005-131323, it is suggested a gaming machine wherein a replay time, in which a probability of displaying a combination of symbols relating to a so-called replay is high, operates, with the opportunity that a combination of specific symbols is displayed by the display windows. According to this gaming machine, it is possible to easily perceive the beginning of replay time.

In addition, it is suggested a gaming machine having a gaming state (i.e., CT (Challenge Time) gaming state) in which if a combination of symbols predetermined is displayed by the plural display windows, an internal winning combination relating to the winning is determined, irrespective of types of internal winning combination determined by the lottery, and it is carried out an operation of stopping the rotation of the reel. In the CT gaming state, since the reel rotation is stopped on the basis of a timing at which the stop operation is carried out by a player (for example, the number of sliding symbols is ┌zero (0)┘) or a timing near at the timing (for example, the number of sliding symbols is ┌1┘), a player's ability to perform the stop operation is reflected on benefit to be awarded to the player.

In addition, as disclosed in a Japanese Patent Laid-Open No. 2005-204922, it is suggested a gaming machine wherein the replay time, in which a probability of displaying a combination of symbols relating to a so-called replay is high, operates and it is notified that the operation of the replay time has started, with the opportunity that a combination of specific symbols is displayed by the display windows.

However, according to the above gaming machines, since it is possible to easily perceive the opportunity that the replay time operates, it is always possible for the player to recognize whether the replay time has operated or not. Owing to this, when the replay time does not operate, it is not possible to give the player expectations that the replay time may operate.

In addition, according to the above gaming machines, the combination of symbols relating to the operation of the replay time is not displayed during which the replay time is operating. Accordingly, in case that the predetermined number of games has been carried out during which the replay time is operating, the operation is over. Therefore, during which the replay time is operating, the player's expectations are limited.

Further, when the CT gaming state is being carried out, if the combination of specific symbols, due to which the replay time operates, is displayed, there occurs a great difference between benefit to be awarded to a player who is able to perform the stop operation at the timing at which the combination of symbols is displayed and a player who cannot do it. Therefore, it is not possible to keep the balance between the players, with regard to the benefit to be awarded to the players.

### SUMMARY OF THE INVENTION

Accordingly, the invention has been made to solve the above-mentioned problems occurring in the prior art. An object of the invention is to provide a gaming machine capable of maintaining player's expectations even when an operation of replay time is being carried out.

Another object of the invention is to provide a gaming machine capable of keeping the balance between players, with regard to benefit to be awarded to the players.

In order to achieve the above objects, there is provided a gaming machine comprising replay time operating means for starting an operation of a replay time, on condition that a combination of symbols consisting of at least two types of symbols is displayed by a predetermined combination of symbol display areas.

More specifically, the invention provides following gaming machines.

(1) There is provided a gaming machine comprising: symbol display means (for example, reels 3L, 3C, 3R described later and display windows 21L, 21C, 21R described later) having plural symbol display areas (for example, symbol display areas described later), each of which areas displaying a symbol (for example, ┌Bell┘ described later), and displaying plural symbols; start operation detection means (e.g., start switch 6S described later) for detecting a start operation (for example, start operation described later and operation of a start lever 6 described later); internal winning combination determination means (for example, means for carrying out an internal lottery process described later and a main control circuit 71 described later) for determining an internal winning combination (e.g., internal winning combination described later) based on the start operation detection carried out by said start operation detection means; symbol varying means (e.g., stepping motors 49L, 49C, 49R described later and a main control circuit 71 described later) for varying symbols to be displayed by said symbol display means, on the basis of the start operation detection carried out by said start operation detection means; stop operation detection means (for example, stop switches 7LS, 7CS, 7RS described later) for detecting a stop operation (e.g., operation of stop buttons 7L, 7C, 7R described later); stop control means (for example, means for carrying out a reel stop control process in FIG. 26 described later, and a main control circuit 71 described later) for carrying out a stop control of the symbol variation carried out by said symbol varying means, based on the internal winning combination determined by the internal winning combination determination means and the stop operation detection carried out by said stop operation detection means; and replay time operating means (for example, means for carrying out a process in a step S189 of FIG. 29 described later) for starting (for example, updating a flag under RT2 operation to ON) an operation of replay time (for example, a game in which a replay section operates, which will be described later), on condition that a combination of symbols consisting of at least two types of symbols (e.g., ┌Replay-Replay-E┘ described later) is displayed by a predetermined combination of the symbol display areas (for example, a combination of an central symbol display area of a left reel 3L, a central symbol display area of a center reel 3C and a central symbol display area of a right reel 3R, and a combination of symbol display areas connected by a center line 8c, which will be described later).

According to the gaming machine described in the above (1), the replay time operating means starts the operation of replay time, on condition that a combination of symbols consisting of at least two types of symbols is displayed by a predetermined combination of the symbol display areas. Herein, since the combination of symbols, which is the occasion for the operation of the replay time, consist of two or more types of symbols, it is relatively difficult for a player to recognize it, as compared to a combination of symbols consisting of same symbols. Accordingly, even though the combination of symbols, which is the occasion for the operation of the replay time, has been displayed, the replay time may start to operate without the player's recognizing it. Therefore, for example, in case that a player assumably recognizes that a replay time is operating after the replay time has started to operate, without recognizing a combination of symbols which is an occasion for an operation of replay time, it is possible to give the player a surprise that the replay time has started to operate without the player's knowing it. In addition, since it is difficult for the player to recognize whether the replay time is operating or not, it is possible to provide the player with expectations that the replay time may be operating, even though the replay time is not operating.

(2) According to the invention, the replay time operating means may start the operation of replay time, on condition that a combination of symbols (for example, ┌Bell-Replay-Bell┘) in which same symbols are not arranged to be adjacent to each other is displayed by the predetermined combination of the symbol display areas.

According to the gaming machine described in the above (2), the replay time operating means starts the operation of replay time, on condition that a combination of symbols in which same symbols are not arranged to be adjacent to each other is displayed by the predetermined combination of the symbol display areas. In other words, the replay time starts to operate, with the opportunity that a combination of symbols, which is relatively difficult for the player to recognize as compared to a combination of symbols having same type of symbols, is displayed. Accordingly, for example, in case that a player assumably recognizes that a replay time is operating after the replay time has started to operate, without perceiving a combination of symbols which is an occasion for an operation of replay time, it is possible to give the player a surprise that the replay time has started to operate without the player's knowing it. In addition, since it is difficult for the player to recognize whether the replay time is operating or not, it is possible to provide the player with expectations that the replay time may be operating, even though the replay time is not operating.

(3) In the gaming machine described in the above (2), the replay time operating means may start the operation of replay time, on condition that a combination of symbols (for example, ┌Replay-Bell-E┘) consisting of symbols different from each other is displayed by the predetermined combination of said symbol display areas.

According to the gaming machine described in the above (3), the replay time operating means starts the operation of replay time, on condition that a combination of symbols consisting of symbols different from each other is displayed by the predetermined combination of the symbol display areas. In other words, the replay time starts to operate, with the opportunity that a combination of symbols, which is relatively difficult for the player to recognize as compared to a combination of symbols having same type of symbols, is displayed. Accordingly, for example, in case that a player assumably recognizes that a replay time, is operating after the replay time has started to operate, without recognizing a combination of symbols which is an occasion for an operation of replay time, it is possible to give the player a surprise that the replay time has started to operate without the player's knowing it. In addition, since it is difficult for the player to recognize whether the replay time is operating or not, it is possible to provide the player with expectations that the replay time may be operating, even though the replay time is not operating.

According to the invention, there is provided a gaming machine comprising: bonus game operating means for operating a bonus game; first replay time operating means for starting an operation of replay time when the operation of the bonus game is over; second replay time operating means for starting an operation of replay time, on condition that a predetermined condition is fulfilled, when a combination of symbols predetermined is displayed by symbol display means; numerical value information update means for updating numerical value information, on condition that a start operation detection is carried out by start operation detection means or a stop operation detection is carried out by stop operation detection means; and replay time ending means for ending the operation of replay time, when the numerical value information becomes a predetermined value as a result of the update carried out by the numerical value information update means, wherein the predetermined condition is fulfilled when the replay time does not operate, which has started according as the combination of symbols predetermined is displayed by the symbol display means.

More specifically, the invention provides following gaming machines.

(4) There is provided a gaming machine comprising: symbol display means (for example, reels 3L, 3C, 3R described later and display windows 21L, 21C, 21R described later) for displaying plural symbols; start operation detection means (e.g., start switch 6S described later) for detecting a start operation (for example, start operation described later and operation of a start lever 6 described later); internal winning combination determination means (for example, means for carrying out an internal lottery process described later and a main control circuit 71 described later) for determining an internal winning combination (e.g., internal winning combination described later) based on the start operation detection carried out by said start operation detection means; symbol varying means (e.g., stepping motors 49L, 49C, 49R described later and a main control circuit 71 described later) for varying symbols to be displayed by said symbol display means, on the basis of the start operation detection carried out by said start operation detection means; stop operation detection means (for example, stop switches 7LS, 7CS, 7RS described later) for detecting a stop operation (e.g., operation of stop buttons 7L, 7C, 7R described later); stop control means (for example, means for carrying out a reel stop control process in FIG. 26 described later, and a main control circuit 71 described later) for carrying out a stop control of the symbol variation carried out by the symbol varying means, based on the internal winning combination determined by said internal winning combination determination means and the stop operation detection carried out by said stop operation detection means; bonus game operating means (for example, means for carrying out a bonus operation checking process in FIG. 29, main control circuit 71, which will be described later) for carrying out an operation (for example, process of updating a flag under MB operation to ON) of a bonus game (for example, game in a MB gaming state described later); first replay time operating means (for example, means for carrying out a process in a step S175 of FIG. 28) for starting (for example, updating a flag under RT1 operation to ON) an operation of replay time (for example, game in which a replay section operates, which will be described later) when the operation of the bonus game is over (for example, when a process in a step S172 of FIG. 28 is carried out); second replay time operating means (for example, means for carrying out a process in a step S189 of FIG. 29) for starting (for example, updating a flag under RT2 operation to ON, which will be described later) an operation of the replay time, on condition that a predetermined condition is fulfilled, when a combination of symbols predetermined (for example, ┌Replay-Replay-E┘) is displayed by said symbol display means; numerical value information update means (for example, means for carrying out a process in a step S8 of FIG. 18) for updating numerical value information (for example, a RT game number counter), on condition that a start operation detection is carried out by said start operation detection means or a stop operation detection is carried out by said stop operation detection means; and replay time ending means (for example, the means for carrying out a process in a step S8 of FIG. 18 described later) for ending the operation of replay time, when said numerical value information becomes a predetermined value (for example, when a RT game number counter becomes ┌0┘) as a result of the update carried out by said numerical value information update means, wherein the predetermined condition is fulfilled when the replay time does not operate (for example, RT1 section, base section which will be described later), which has started according as the combination of symbols predetermined is displayed by said symbol display means.

According to the gaming machine described in the above (4), the first replay time operating means starts to operate the replay time when the operation of the bonus game is over. In addition, the second replay time operating means starts to operate the replay time, on condition that the predetermined condition is fulfilled, when the combination of symbols predetermined is displayed by the symbol display means. In addition, the numerical value information update means updates the numerical value information, on condition that a start operation detection is carried out by the start operation detection means or a stop operation detection is carried out by the stop operation detection means. In addition, the replay time ending means for ending the operation of replay time ends the operation of replay time when the numerical value information becomes a predetermined value as a result of the update carried out by the numerical value information update means. Further, the predetermined condition is fulfilled when the replay time does not operate, which has started according as the combination of symbols predetermined is displayed by the symbol display means. In other words, the predetermined condition is fulfilled when the replay time, which has started according as the bonus game is over, is operating. Accordingly, in case that the replay time, which has started according as the bonus game is over, is operating, when the combination of symbols predetermined is displayed by the symbol display means, the operation of replay time is started by the second replay time operating means. In other words, in case that the replay time, which has started according as the bonus game is over, is operating, the replay time may newly operate. Accordingly, it is possible to maintain the player's expectations that the replay time will newly operate, even during the operation of the replay time. In the mean time, the predetermined condition is not fulfilled when the replay time, which has started according as the combination of symbols predetermined is displayed by the symbol display means, is operating. Accordingly, in case that the replay time, which has started according as the combination of symbols predetermined is displayed by the symbol display means, is operating, even though the combination of symbols predetermined is displayed by the symbol display means, the replay time does not newly operate, and the operation of the replay time is over when the numerical value information becomes a predetermined value. Accordingly, it is possible to prevent the replay time from continuing beyond necessity due to the repeated new operations of replay time.

According to the invention, there is provided a gaming machine comprising: means for operating a specific effect section in which a mode of a specific effect is determined by effect mode determination means irrespective of whether an operation of replay time is carried out or not; numerical value information update means for updating numerical value information, on condition that a start operation detection is carried out by start operation detection means or a stop operation detection is carried out by stop operation detection means; and specific effect section ending means for ending the specific effect section, when the numerical value information becomes a predetermined value as a result of the update carried out by the numerical value information update means, wherein on condition that the operation of replay time is carried out when the operation of the specific effect section is carried out or when the operation of the specific effect section is over, the effect mode determination means determines an effect mode notifying that the operation of the corresponding replay time is carried out.

More specifically, the invention provides the following gaming machine.

(5) There is provided a gaming machine comprising: symbol display means (for example, reels 3L, 3C, 3R described later and display windows 21L, 21C, 21R described later) for displaying plural symbols; start operation detection means (e.g., start switch 6S described later) for detecting a start operation (for example, start operation described later and operation of a start lever 6 described later); internal winning combination determination means (for example, means for carrying out an internal lottery process described later and a main control circuit 71 described later) for determining an internal winning combination (e.g., internal winning combination described later) based on the start operation detection carried out by the start operation detection means; symbol varying means (e.g., stepping motors 49L, 49C, 49R described later and a main control circuit 71 described later) for varying symbols to be displayed by the symbol display means, on the basis of the start operation detection carried out by said start operation detection means; stop operation detection means (for example, stop switches 7LS, 7CS, 7RS described later) for detecting a stop operation (e.g., operation of stop buttons 7L, 7C, 7R described later); stop control means (for example, means for carrying out a reel stop process in FIG. 26 described later, means for carrying out a priority attraction-in process in FIG. 27 described later, main control circuit 71 described later) for carrying out a stop control of the symbol variation carried out by said symbol varying means, based on the internal winning combination determined by the internal winning combination determination means and the stop operation detection carried out by the stop operation detection means; replay time operating means (for example, means for carrying out a process in a step S189 of FIG. 29 described later) for carrying out (for example, updating a flag under RT2 operation to ON) an operation of replay time (for example, a game in which a RT section operates, which will be described later); effect mode determination means (for example, means for determining effect data, image control MICOM 81, which will be described later) for determining an effect mode (for example, effect date described later); specific effect section operation means (for example, means for carrying out a process in a step S162, means for determining effect data corresponding to baseball winning and baseball losing, image control MICOM 81, which will be described later) for operating a specific effect section (for example, section in which a continuous effect is carried out, which will be described later) in which a mode of a specific effect (for example, effect data corresponding to a continuous effect which will be described later) is determined by said effect mode determination means, irrespective of whether the operation of the replay time is carried out or not; numerical value information update means (for example, means for carrying out a process in a step S243 described later) for updating numerical value information (for example, the number of premonition games described later), on condition that a start operation detection is carried out by said start operation detection means or a stop operation detection is carried out by said stop operation detection means; and specific effect section ending means (for example, means for carrying out a process in a step S243 described later, image control MICOM 81) for ending the specific effect section, when said numerical value information becomes a predetermined value (for example, the number of premonition games is ┌0┘) as a result of the update carried out by said numerical value information update means, wherein on condition that the operation of replay time is carried out when the operation of the specific effect section is carried out or when the operation of said specific effect section is over, said effect mode determination means determines an effect mode (for example, effect data such as ┌homerun┘, effect data corresponding to an effect under RT operation, which will be described later) notifying that the operation of the corresponding replay time is carried out.

According to the gaming machine described in the above (5), the specific effect section operating means operates a specific effect section in which a mode of a specific effect is determined by the effect mode determination means irrespective of whether the operation of the replay time is carried out or not. In addition, the effect mode determination means determines an effect mode notifying that the operation of the corresponding replay time is carried out, on condition that the operation of replay time is carried out when the operation of the specific effect section is carried out or when the operation of the specific effect section is over. In other words, the specific effect section may be operated when the operation of replay time is carried out and when the operation of replay time is not carried out. And, in case the operation of the specific effect section is carried out or is over, only when the operation of the replay time is carried out, it is determined the effect mode notifying that the operation of replay time is carried out. Accordingly, even though the operation of replay time is not carried out, in case that the operation of the specific effect section is carried out, the player may expect that it is determined the effect mode notifying that the operation of replay time is carried out, i.e., the operation of replay time is carried out. Therefore, it is possible to maintain the player's expectations, even while the operation of replay time is not carried out.

In addition, according to the invention, there is provided a gaming machine comprising: bonus game operating means for carrying out an operation of a bonus game in which stop control means carries out a stop control of symbol variation carried out by symbol varying means, based on a stop operation detection carried out by stop operation detection means, with regard to at least one of plural rows; and replay time operating means for carrying out an operation of replay time when a combination of specific symbols is displayed by symbol display means, wherein the stop control means carries out the stop control of the symbol variation carried by the symbol varying means, based on priority ranking information in which a combination of symbols different from the combination of specific symbols has a priority over the combination of specific symbols.

More specifically, the invention provides a following gaming machine.

(6) There is provided a gaming machine comprising: symbol display means (for example, reels 3L, 3C, 3R described later and display windows 21L, 21C, 21R described later) for displaying plural symbols; start operation detection means (e.g., start switch 6S described later) for detecting a start operation (for example, start operation described later and operation of a start lever 6 described later); internal winning combination determination means (for example, means for carrying out an internal lottery process described later and a main control circuit 71 described later) for determining an internal winning combination (e.g., internal winning combination described later) based on the start operation detection carried out by the start operation detection means; symbol varying means (e.g., stepping motors 49L, 49C, 49R described later and a main control circuit 71 described later) for varying symbols to be displayed by said symbol display means, on the basis of the start operation detection carried out by said start operation detection means; stop operation detection means (for example, stop switches 7LS, 7CS, 7RS described later) for detecting a stop operation (e.g., operation of stop buttons 7L, 7C, 7R described later); stop control means (for example, means for carrying out a reel stop process in FIG. 26 described later, means for carrying out a priority attraction-in process in FIG. 27 described later, main control circuit 71 described later) for carrying out a stop control of the symbol variation carried out by the symbol varying means, based on the internal winning combination determined by said internal winning combination determination means and the stop operation detection carried out by the stop operation detection means; bonus game operating means (for example, means for carrying out a bonus operation checking process in FIG. 29, main control means 71, which will be described later) for carrying out an operation (for example, process of updating a flag under MB operation to ON, which will be described later) of a bonus game (for example, game in a MB gaming state described later) in which said stop control means carries out a stop control (for example, stop control having the maximum number of sliding symbols ┌1┘ for a left reel 3L) of the symbol variation carried out by the symbol varying means, based on the stop operation detection carried out by said stop operation detection means, with regard to at least one (for example, left reel 3L described later) of plural rows; and replay time operating means (for example, means for carrying out a process in a step S189 of FIG. 29 described later) for carrying out an operation (for example, process of updating a flag under RT2 operation to ON, which will be described later) of replay time (for example, game in which a replay section operates, which will be described later) when a combination of specific symbols (for example, ┌Replay-Replay-E┘) is displayed by said symbol display means, wherein said stop control means carries out the stop control of the symbol variation carried by said symbol varying means, based on priority ranking information (for example, priority attraction-in ranking table in FIG. 15, which will be described later) in which a combination of symbols (for example, ┌Replay-Replay-Replay┘ corresponding to Small Win of 10 pieces, which will be described later) different from the combination of specific symbols has a priority (for example, priority attraction-in ranking of RT is lower than Small Win of 10 pieces) over the combination of specific symbols.

According to the gaming machine described in the above (6), the bonus game operating means carries out an operation of a bonus game in which the stop control means carries out a stop control of the symbol variation carried out by the symbol varying means, based on the stop operation detection carried out by the stop operation detection means, with regard to at least one of plural rows. In addition, the replay time operating means carries out an operation of replay time when a combination of specific symbols is displayed by the symbol display means. Additionally, the stop control means carries out the stop control of the symbol variation carried by the symbol varying means, based on priority ranking information in which a combination of symbols different from the combination of specific symbols has a priority over the combination of specific symbols. Accordingly, in a bonus game, for example, a combination of symbols may be displayed by the symbol display means, based on a timing at which the stop operation carried out by the player is detected by the stop operation detection means. In addition, since the stop control means carries out the stop control so that the combination of symbols different from the combination of specific symbols is displayed preferentially over the combination of specific symbols by the symbol display means, based on the priority ranking information, the combination of symbols different from the combination of specific symbols is also displayed preferentially over the combination of specific symbols by the symbol display means in the bonus game. Accordingly, in the bonus game, it is possible to prevent the combination of specific symbols from being displayed by the symbol display means, based on a timing at which the stop operation carried out by the player is detected by the stop operation detection means, and thus the replay time from operating. Therefore, in the bonus game, it is possible to prevent a great difference between benefit to be awarded to an expert who can perform the stop operation in a timely fashion and a beginner who has an insufficient ability in the stop operation from occurring, which difference caused by a fact that the expert operates the replay time in a relatively high probability as compared to the beginner. In other words, it is possible to keep the balance between the players, with regard to the benefit to be awarded to the players.

### BRIEF DESCRIPTION OF THE DRAWINGS

Other and further objects, features and advantages of the invention will appear more fully from the following description taken in connection with the accompanying drawings, in which:

FIG. 1 is a perspective view showing an external appearance of a gaming machine according to an embodiment of the invention;

FIG. 2 is a view showing a panel display unit, a liquid crystal display unit and a fixed display unit of a liquid crystal display device;

FIG. 3 is a perspective view of schematically showing a structure of a liquid crystal display device;

FIG. 4 is a view showing an example of symbols arranged on a reel;

FIG. 5 is a block diagram of an electric circuit;

FIG. 6 is a block diagram of an electric circuit;

FIG. 7 is a view of showing an internal lottery table determining table;

FIG. 8 shows an internal lottery table;

FIG. 9 is a view of showing an internal winning combination determining table;

FIG. 10 shows a symbol combination table;

FIG. 11 is a view showing a bonus operation table;

FIG. 12A shows areas for storing an internal winning combination;

FIG. 12B shows areas for storing an internal carryover combination;

FIG. 12C shows areas for storing a display combination;

FIG. 12D shows areas for storing a flag under operation;

FIG. 13 shows a symbol storing area;

FIG. 14 shows an identifier list of symbols;

FIG. 15 shows a priority attraction-in ranking table;

FIG. 16 shows an expected display combination storing area;

FIG. 17 shows a correspondence table of a reel and an expected display combination storing area;

FIG. 18 is a main flow chart of a main control circuit;

FIG. 19 is a flow chart showing a medal receiving•start checking process;

FIG. 20 is a flow chart showing an internal lottery process;

FIG. 21 is a flow chart showing a reel stop initialization process;

FIG. 22 is a flow chart showing an expected display combination storing process;

FIG. 23 is a flow chart showing a display checking process;

FIG. 24 is a flow chart showing a display combination retrieving process;

FIG. 25 is a flow chart showing a priority ranking checking process;

FIG. 26 is a flow chart showing a reel stop control process;

FIG. 27 is a flow chart showing a priority attraction-in control process;

FIG. 28 is a flow chart showing a bonus end checking process;

FIG. 29 is a flow chart showing a bonus operation checking process;

FIG. 30 is a flow chart showing an intervention process under control of a main CPU;

FIG. 31A shows an example of data stored in an expected display combination storing area;

FIG. 31B shows an example of data stored in an expected display combination storing area;

FIG. 32A shows an example of data stored in an expected display combination storing area;

FIG. 32B shows an example of data stored in an expected display combination storing area;

FIG. 33A shows an example of a display mode of a display window;

FIG. 33B shows an example of a display mode of a display window;

FIG. 34A shows an example of a display mode of a display window;

FIG. 34B shows an example of a display mode of a display window;

FIG. 35 is a view showing an effect table;

FIG. 36 is a flow chart showing a priority attraction-in control process;

FIG. 37 is a flow chart showing a RESET-intervention process under control of a sub-CPU;

FIG. 38 is a flow chart showing a BET command receiving process;

FIG. 39 is a flow chart showing a start command receiving process;

FIG. 40 is a flow chart showing a reel stop command receiving process;

FIG. 41 is a flow chart showing a display combination command receiving process;

FIG. 42 is a flow chart showing a bonus operation command receiving process;

FIG. 43 is a flow chart showing a bonus end command receiving process;

FIG. 44 is a flow chart showing a periodic intervention process under control of a sub-CPU;

FIG. 45 is a view showing an example of an image displayed on an effect display area;

FIG. 46 is a view showing an example of an image displayed on an effect display area;

FIG. 47 is a view showing an example of an image displayed on an effect display area;

FIG. 48 is a view showing an example of an image displayed on an effect display area;

FIG. 49 is a view showing an example of an image displayed on an effect display area;

FIG. 50 is a view showing an example of an image displayed on an effect display area;

FIG. 51A is a view showing an example of an image displayed on an effect display area;

FIG. 51B is a view showing an example of an image displayed on an effect display area;

FIG. 52A is a graph showing an output pattern of music A in a music game;

FIG. 52B is a graph showing an output pattern of music B in a music game;

FIG. 52C is a graph showing an output pattern of music C in a music game; and

FIG. 52D is a graph showing an output pattern of music D in a music game.

### DESCRIPTION OF THE PREFERRED EMBODIMENTS

### First Embodiment

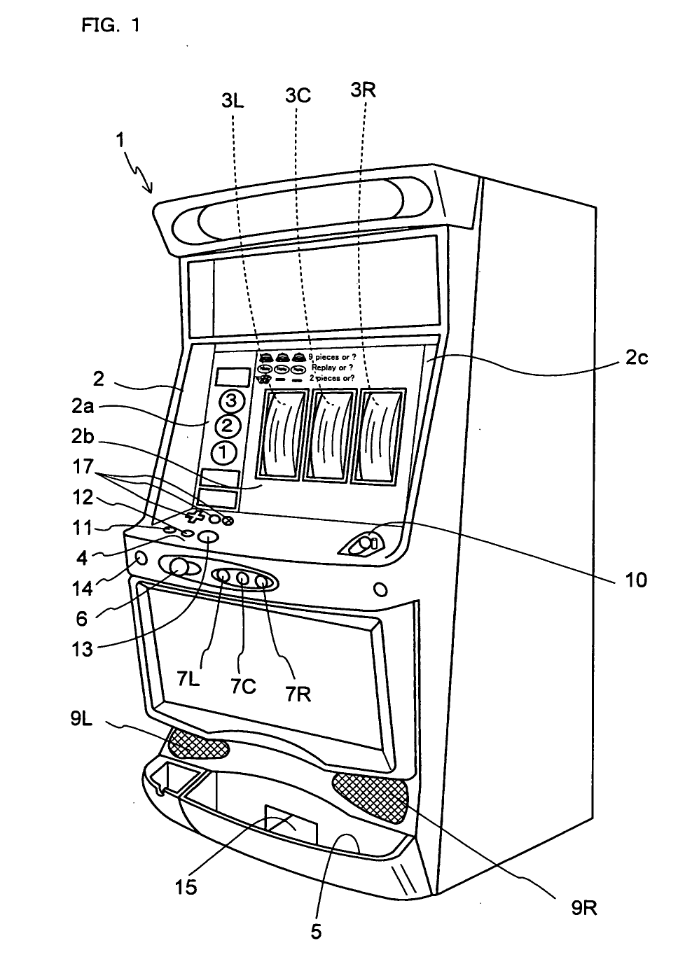

FIG. 1 is a perspective view of schematically showing a gaming machine 1 according to an embodiment of the invention. The gaming machine 1 is a so-called pachi-slot machine. The gaming machine 1 is a gaming machine carrying out a game using a game medium such as card storing information of a game value which has been awarded or will be awarded to a player, as well as coin, medal, gaming ball and token. In the following descriptions, a medal is used as the game medium.

A front door 2 is provided at a front surface thereof with a panel display unit 2a having an approximate vertical surface, a liquid crystal display unit 2b and a fixed display unit 2c. In addition, three reels 3L, 3C, 3R having plural symbols drawn on peripheries thereof are mounted horizontally in a row at the rear of the front door 2 to be freely rotatable. Each of the reels 3L, 3C, 3R is rotated at a constant speed (for example, 80 revolutions/min)

A base portion 4 having an approximate horizontal surface is provided below the panel display unit 2a, the liquid crystal display unit 2b and the fixed display unit 2c. A medal insertion slot 10 for inserting a medal is formed at a right side of the base portion 4. The inserted medal is credited (i.e., stacked) and consumed to play a game. The base portion 4 is provided at a left side thereof with a 1-BET switch 11, a 2-BET switch 12 and a MAX-BET switch 13 for selecting the number of medals (hereinafter, referred to as ┌insertion number┘) among the credited medals, which are consumed to play a game by a push operation.

The 1-BET switch 11 selects ┌1┘ as an insertion number by one push operation. The 2-BET switch 12 selects ┌2┘ as an insertion number by one push operation. The MAX-BET switch 13 selects ┌3┘ as an insertion number by one push operation.

When the BET switches 11 to 13 are pushed, a display line is activated (which will be specifically described later). Hereinafter, the push operation of the BET-switches 11 to 13 and the operation of inserting a medal into the medal insertion slot 10 are referred to as ┌insertion operation┘. In addition, an operating unit 17 is mounted above the BET switches 11 to 13. The operating unit 17 is manipulated so as to display information such as game history on a liquid crystal display device 131.

A C/P switch 14 for switching credits/payouts of medals, which are obtained by a player through the game, through a push operation is mounted on the left front side of the base portion 4. When the C/P switch 14 is operated, the medals are paid out from a medal payout slot 15 at a front lower side and the paid out medals are collected in a medal tray 5. Speakers 9L, 9R for producing an effect sound regarding the game effect are provided at the upper left and right sides of the medal tray 5.

A start lever 6 for rotating the reels to vary the symbols in display windows 21L, 21C, 21R by a manipulation of the player is mounted at the right side of the C/P switch 14 to be rotatable within a predetermined range of angles. An operation of the start lever 6 carried out by a player so as to vary the symbols is referred to as ┌start operation┘.

Three stop buttons 7L, 7C, 7R for stopping rotations of the reels 3L, 3C, 3R are provided at the right side of the start lever 6 in the frontal center of the base portion 4. In addition, in one embodiment, a one game (i.e., unit game) is basically started by the start operation and is over when all the reels 3L, 3C, 3R are stopped. In addition, in one embodiment, in case that the start operation is carried out when the insertion number is not ┌3┘, the corresponding start operation is annulled.

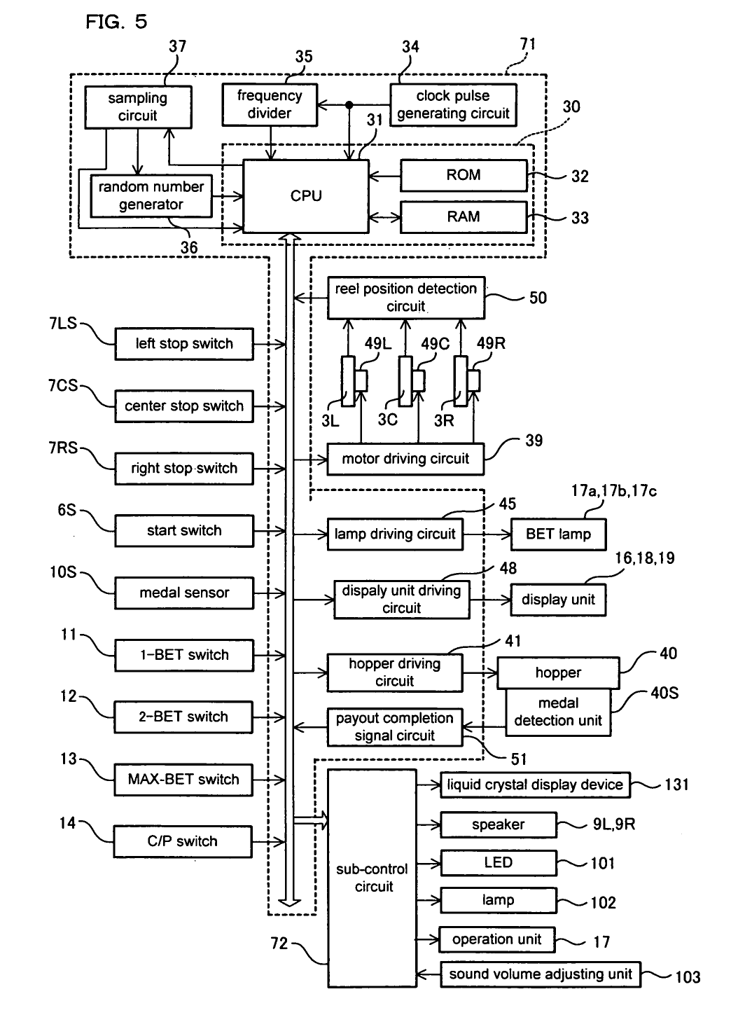

Herein, in one embodiment, a stop operation of the reel (i.e., operation of the stop button) carried out while all the reels are being rotated is referred to as a first stop operation, a stop operation which is carried out following the first stop operation is referred to as a second stop operation, and a stop operation which is carried out following the second stop operation is referred to as a third stop operation. In addition, stop switches 7LS, 7CS, 7RS are arranged at the rear of the stop buttons 7L, 7C, 7R, which will be described with reference to FIG. 5. The stop switches detect push operations (i.e., stop operations) of the corresponding stop buttons.

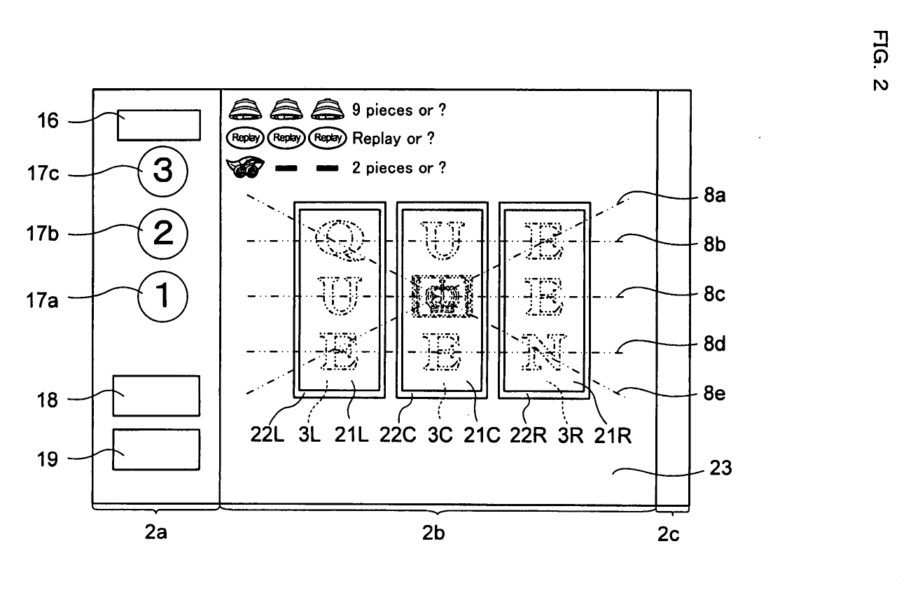

Hereinafter, the panel display unit 2a, the liquid crystal display unit 2b and the fixed display unit 2c are described with reference to FIG. 2.

The panel display unit 2a consists of a bonus game information display unit 16, BET lamps 17a to 17c, a payout display unit 18 and a credit display unit 19. The bonus game information display unit 16 consists of 7-segment LEDs and displays game information during a bonus game (for example, MB gaming state). The 1-BET lamp 17a, the 2-BET lamp 17b and the MAX-BET lamp 17c are turned on in correspondence with the insertion number.

The 1-BET lamp 17a is turned on when the insertion number is 1. The 2-BET lamp 17b is turned on when the insertion number is 2. The MAX-BET lamp 17c is turned on when the insertion number is 3. The payout display unit 18 and the credit display unit 19 consist of 7 segment LEDs, respectively, and display a payout number of medals when a winning is made and a number of medals credited, respectively.

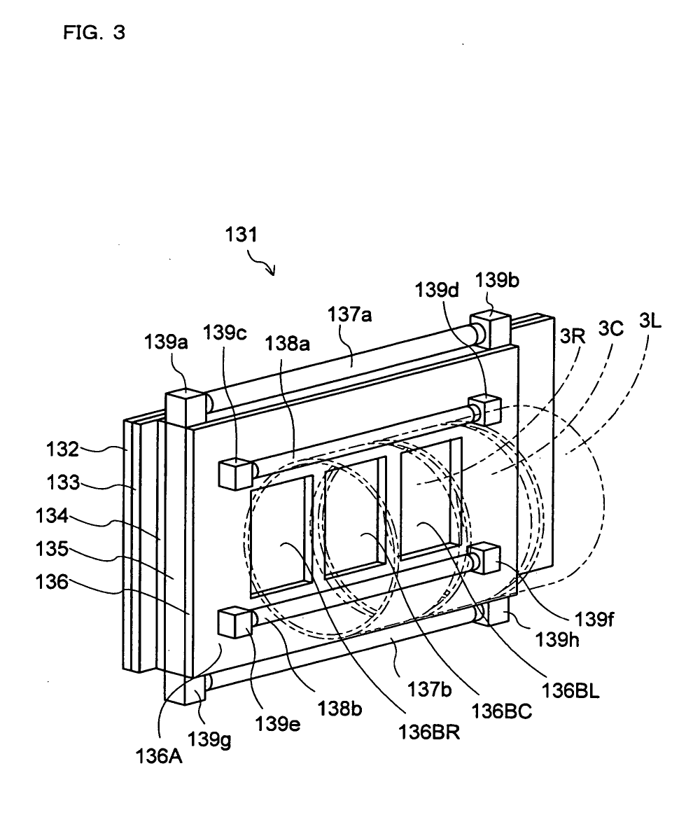

The liquid crystal display unit 2b consists of display windows 21L, 21C, 21R, window frame display areas 22L, 22C, 22R and an effect display area 23. The display contents of the liquid crystal display unit 2b are adopted to vary in accordance with the rotation and stop modes of the reels 3L, 3C, 3R (i.e., modes of combinations of symbols displayed on the display window 21L, 21C, 21R when the rotations of the reels 3L, 3C, 3R are stopped) and an operation of the liquid crystal display device 131 which will be described with reference to FIG. 3.

Each of the display windows 21L, 21C, 21R is mounted to correspond to each of the reels 3L, 3C, 3R and carries out the display of symbols arranged on the reels 3L, 3C, 3R or various displays for effects.

The display windows 21L, 21C, 21R are provided with display lines, i.e., top line 8b, center line 8c and bottom line 8d which are horizontally directed and cross-up line 8a and cross-down line 8e which are diagonally directed. In one embodiment, on condition that a player pushes the BET switches 11 to 13 or inserts a medal into the medal insertion slot 10 and thus the insertion number becomes ┌3┘, only the center line 8c of the five display lines 8a to 8e is activated (hereinafter, activated display line is referred to as ┌activated line┘).

Herein, each of the display windows 21L, 21C, 21R is formed with three symbol display areas (i.e., upper, central and lower parts) in a longitudinal direction (i.e., vertical direction), respectively. In other words, a total of 9 symbol display areas are formed at the upper, central and lower parts of the left reel 3L, the upper, central and lower parts of the center reel 3C and the upper, central and lower parts of the right reel 3R. In case that the variation of symbols is stopped in each of the display windows 3L, 3C, 3R, the symbols are stopped and displayed on the symbol display areas formed in each of the display windows 21L, 21C, 21R, respectively. Each of the display lines 8a to 8e connects the symbol display areas in each of the display windows 21L, 21C, 21R.

The display windows 21L, 21C, 21R are under transmissive state so that the player can see the symbols on the reels 3L, 3C, 3R, at least when the corresponding reels 3L, 3C, 3R are being rotated and when the corresponding stop buttons 7L, 7C, 7R can be pushed.

The window frame display areas 22L, 22C, 22R are mounted to surround each of the display windows 21L, 21C, 21R, and display the frames of the display windows 21L, 21C, 21R arranged on the front of the reels 3L, 3C, 3R.

The effect display area 23 is an area except the display windows 21L, 21C, 21R and the window frame display areas 22L, 22C, 22R of the liquid crystal display unit 2b. The effect display area 23 displays an image definitely notifying that a bonus (for example, MB1 and MB2) has been determined as an internal winning combination, an effect for increasing an interest in a game and information required so that a player can advantageously play a game.

In addition, information about a payout, which is awarded to the player in accordance with the combination of symbols displayed along the display lines 8a to 8e, is displayed on the upper left side of the effect display area 23, which will be specifically described later.

The fixed display unit 2c is an area in which a predetermined pattern, picture and the like are drawn. It may be such structured that the pattern, picture and the like drawn on the fixed display unit 2c and the image displayed on the effect display area 23 are correlated to display one still image or moving image.

FIG. 3 is a perspective view of schematically showing a structure of the liquid crystal display device 131. An inside structure of the reels 3L, 3C, 3R is first described. In the reels 3L, 3C, 3R, LED receiving circuit boards are mounted at the rear of the three rows of symbols (i.e., total 9 symbols) which are stopped and displayed on each of the display windows 21L, 21C, 21R when the rotations of reels 3L, 3C, 3R are stopped. The LED receiving circuit boards include three LED receiving units (i.e., a total nine), respectively, and plural LED lamps are mounted therein.

The LED lamps illuminate rear surfaces of reel sheets mounted along the peripheries of the reels 3L, 3C, 3R with white lights. More specifically, they illuminate areas corresponding to the display windows 21L, 21C, 21R. The reel sheet is structured to have a transparent property and the lights emitted from the LED lamps pass through the front surface of the reel sheet.

In addition, the left reel 3L consists of a cylindrical frame structure formed by spacing two ring-shaped frames having a same shape at an interval and connecting them with plural connection members, and a transfer member transferring a driving force of a stepping motor 49L mounted at a center of the frame structure to the ring-shaped frames. In addition, the reel sheet is mounted along the periphery of the left reel 3L.

The LED receiving circuit board arranged in the reel 3L includes three LED receiving units for receiving plural LED lamps. The LED receiving circuit board is mounted in such a way that the LED receiving units are respectively located at the rears of the symbols (i.e., total 3 symbols) that a player can see through the display window 21L. In addition, the center reel 3C and the right reel 3R have also the same structure as the left reel 3L and comprise the LED receiving circuit boards therein, respectively.

Next, the transmissive liquid crystal display device 131 is described. The liquid crystal display device 131 consists of a protecting glass 132, a display plate 133, a liquid crystal panel 134, a light guide plate 135, a reflecting film 136, fluorescent lamps 137a, 137b, 138a, 138b which are so-called white light sources (for example, means for generating lights, including all wavelengths of lights, with a proportion that a specific color is unnoticeable), lamp holders 139a to 139h and the like.

The liquid crystal display device 131 is mounted just at the front, viewing from the reels 3L, 3C, 3R. In addition, the reels 3L, 3C, 3R and the liquid crystal display device 131 are separately (for example, at an interval) mounted.

The protecting glass 132 and the display plate 133 are made of transmissive members. The protecting glass 132 is provided to protect the liquid crystal panel 134. In the display plate 133, a pattern, picture and the like are drawn on areas corresponding to the panel display unit 2a and the fixed display unit 2c (see FIG. 2).

Herein, in FIG. 3, it is not shown an electric circuit arranged at the rear of the display plate 133 corresponding to the panel display unit 2a, which is provided to control operations of the bonus game information display unit 16, the payout number display unit 18, the credit display unit 19 and the BET lamps 17a to 17c.

In the liquid crystal panel 134, liquid crystals are sealingly injected in a gap between a transparent board such as glass plate having a thin film transistor layer formed thereon and a transparent board opposite to the board. A display mode of the liquid crystal panel 134 is set as a normally white. The normally white is such a structure that it becomes a white display (i.e., the lights traveling from the reels 3L, 3C, 3R of the liquid crystal panel 134 penetrate) under state that the liquid crystal is not driven (i.e., a voltage is not applied to the liquid crystal panel 134). Accordingly, it is possible to see the penetrated lights from the exterior.

Accordingly, by adopting the liquid crystal panel 134 structured with the normally white, even when there occurs a state at which the liquid crystal cannot be driven, it is possible to see the symbols arranged on the reels 3L, 3C, 3R through the display windows 21L , 21C, 21R and to continuously play the game. In other words, even when there occurs such state that the liquid crystal cannot be driven, it is possible to play the game in relation to the rotations and stops of the reels 3L, 3C, 3R.

The light guide plate 135 is provided at the rear of the liquid crystal panel 134 so as to guide the light from the fluorescent lamps 137a, 137b into the liquid crystal panel 134 (i.e., to illuminate the liquid crystal panel 134) and consists of a transmissive member (i.e., a member having a light guide function) such as acryl-based resin having about 2 cm thickness, for example.

For the reflecting film 136, it is possible to use a material having silver deposition film formed on a white polyester film or aluminum thin film, for example. The reflecting film reflects the light, which is introduced into the light guide plate 135, toward the front. Thereby, the liquid crystal panel 134 is illuminated. The reflecting film 136 consists of a reflecting area 136A and non-reflecting areas (i.e., transmissive areas) 136BL, 136BC, 136BR. The non-reflecting areas 136BL, 136BC, 136BR are made of transparent materials, so that they penetrate the incident light without reflecting it.

In addition, the non-reflecting areas 136BL,136BC, 136BR are provided at front positions of the symbols which are displayed when the rotations of reels 3L, 3C, 3R are stopped. Additionally, sizes and positions of the non-reflecting areas 136BL, 136BC, 136BR are structured to be matched to the display windows 21L, 21C, 21R (see FIG. 2). Further, in the reflecting film 136, an area except the non-reflecting areas 136BL, 136BC, 136BR is the reflecting area 136A which reflects the light introduced to the light guide plate 135 toward the front.

The fluorescent lamps 137a, 137b are arranged along upper and lower ends of the light guide plate 135 and supported at their both ends by the lamp holders 139a, 139b, 139g, 139h. The fluorescent lamps 137a, 137b generate the light to be introduced into the light guide-plate 135.

The fluorescent lamps 138a, 138b are arranged at upper and lower parts of the rear of the reflecting film 136. The lights generated from the fluorescent lamps 138a, 138b are reflected at the surfaces of the reels 3L, 3C, 3R and incident on the non-reflecting area 136BL, 136BC, 136BR. The incident lights pass through the non-reflecting area 136BL, 136BC, 136BR and illuminate the liquid crystal panel 134.

Hereinafter, functions of the LED lamps and the fluorescent lamps 137a, 137b, 138a, 138b are described.

First, it is described a function of each lamp when the liquid crystals of the display windows 21L, 21C, 21R are not driven (i.e., voltage is not applied to parts corresponding to the display windows 21L, 21C, 21R of the liquid crystal panel 134).

Some of the lights emitted from the fluorescent lamps 138a, 138b are reflected by the reel sheet. In addition, some of the lights emitted from the LED lamps mounted at the LED receiving circuit board penetrate the reel sheet. Since these lights penetrate the non-reflecting areas 136BL, 136BC, 136BR, and the light guide plate 135 and the liquid crystal panel 134 which constitute the liquid crystal display device 131, the player can see the symbols arranged on the reels.

In addition, the lights emitted from the fluorescent lamps 137a, 137b and introduced toward the light guide plate 135 pass through the liquid crystal panel 134 and are incident to the player's eyes. In other words, the areas of the liquid crystal panel 134 corresponding to the window frame areas 22L, 22C, 22R and the effect display area 23 are illuminated by the fluorescent lamps 137a, 137b.

Next, it is described a function of each lamp when the liquid crystals of the display windows 21L, 21C, 21R are driven (i.e., voltage is applied to parts corresponding to the display windows 21L, 21C, 21R of the liquid crystal panel 134).

Some of the lights emitted from the fluorescent lamps 138a, 138b are reflected by the reel sheet. In addition, some of the lights emitted from the LED lamps penetrate the reel sheet. Since some of these lights are reflected or absorbed in the liquid crystal driven area of the areas of the liquid crystal panel 134, the player can see an image and the like displayed on the display windows 21L, 21C, 21R for an effect.

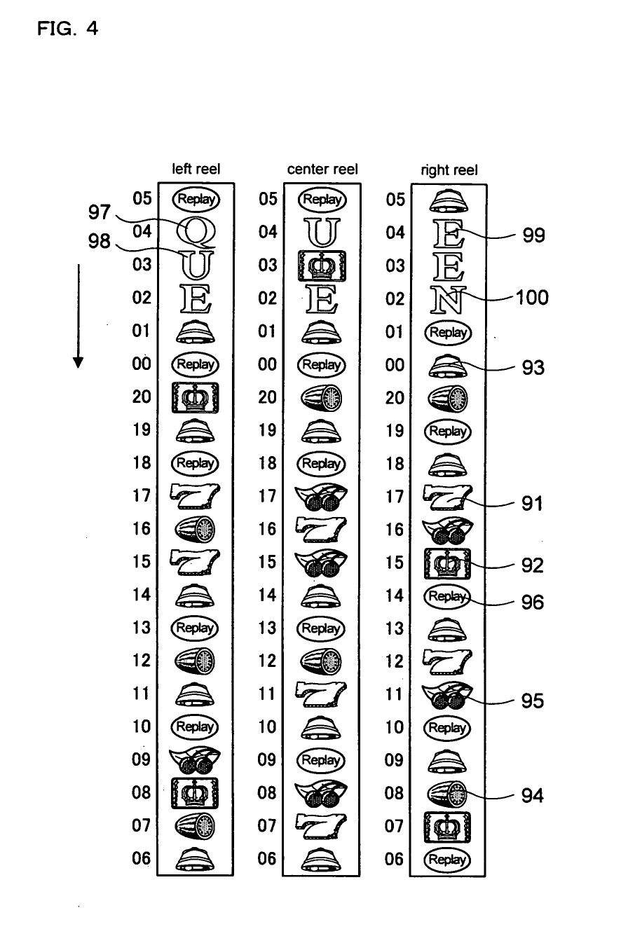

FIG. 4 shows symbol rows displayed on the reels 3L, 3C, 3R, in each of which 21 symbols are arranged. Each of the symbols is given with code numbers of ┌00┘˜┌20┘, and stored (memorized) as a symbol arrangement table in a ROM 32 which will be described later. The symbol row consisting of ┌Blue 7 (symbol 91)┘, ┌Crown (symbol 92)┘, ┌Bell (symbol 93)┘, ┌Watermelon (symbol 94)┘, ┌Cherry (symbol 95)┘, ┌Replay (symbol 96)┘, ┌Q (symbol 97)┘, ┌U (symbol 98)┘, ┌E (symbol 99)┘, and ┌N (symbol 100)┘ is displayed on each of the reels 3L, 3C, 3R. Each of the reels 3L, 3C, 3R is rotated so that the symbol rows are moved in an arrow direction of FIG. 4.

In one embodiment, MB1, MB2, Cherry, Bell, Watermelon, Small Win of Chance, Small Win of 10 pieces, RT, Replay and losing are formed as an internal winning combination. MB1 and MB2 are generically referred to as ┌MB (Middle Bonus)┘. In addition, Cherry, Bell, Watermelon, Small Win of Chance, Small Win of 10 pieces, and RT are generically referred to as ┌Small Win┘.

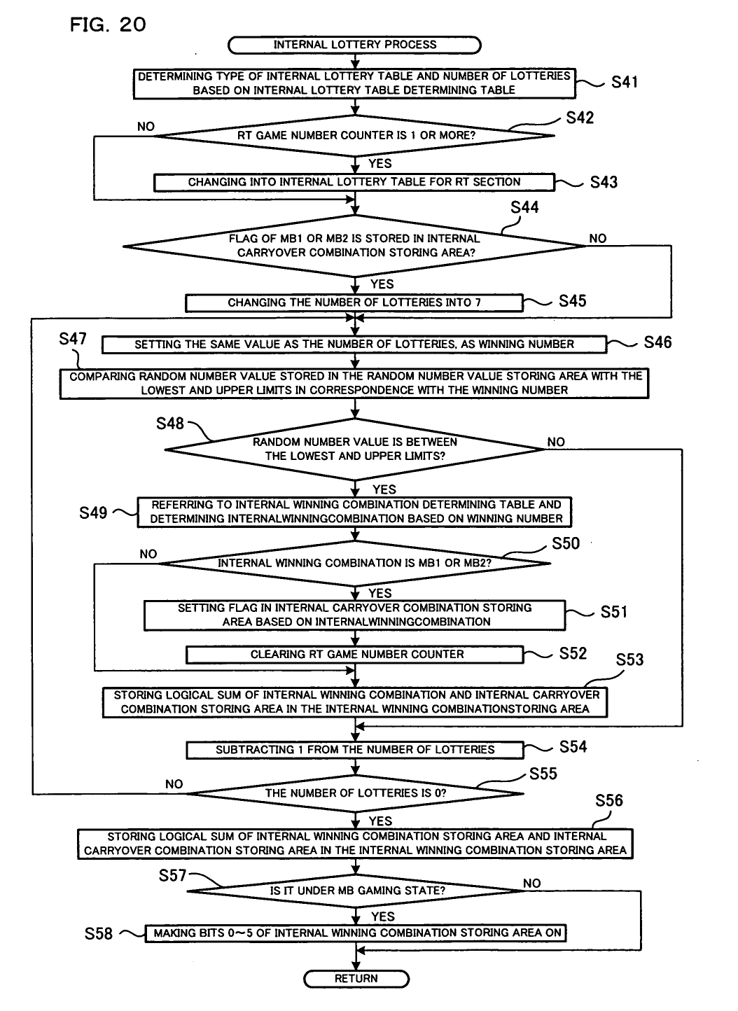

In one embodiment, the gaming state basically includes a normal gaming state and a middle bonus gaming state (referred to as ┌MB gaming state┘) in which a bonus game, i.e., MB operates. The gaming state is discriminated in accordance with a type of an internal winning combination which may be determined in an internal lottery process (see FIG. 20) for determining an internal winning combination, a probability that an internal winning combination will be determined in the internal lottery process, a maximum number of sliding symbols and whether a bonus game has operated.

The normal gaming state consists of a base section having no internal carryover combination, a carryover section having an internal carryover combination, and a replay time section (hereinafter, referred to as ┌RT section┘) in which a probability that replay will be determined as an internal winning combination is higher than in the base section and the carryover section. In the carryover section, MB is not determined as an internal winning combination. In the base and RT sections, MB may be determined as an internal winning combination.

The internal carryover combination is information for discriminating a corresponding combination of symbols, in case that it is allowed a combination of symbols corresponding to an internal winning combination determined in the internal lottery process (see FIG. 20) to be displayed along the activated line over one or plural games. In addition, a section of the normal gaming state except the RT section is referred to as ┌non-RT section┘.

In the MB gaming state, the maximum number of sliding symbols of the left reel 3L is ┌1┘, and the maximum number of sliding symbols of the other reels is ┌4┘. In addition, in the gaming state except the MB gaming state, the maximum number of sliding symbols is ┌4┘ for all the reels 3L, 3C, 3R. The number of sliding symbols is a moving amount of a symbol after the corresponding stop button is pushed. In addition, in the MB gaming state, irrespective of a type of an internal winning combination determined by a lottery, it is allowed a combination of symbols corresponding to Cherry, Bell, Watermelon, Small Win of Chance, Small Win of 10 pieces and RT to be displayed along the activated line.

In the MB gaming state and RT section, with regard to a unit game value used to play a game (for example, 1 piece of medal consumed to play a one game), an expected value of a game value to be awarded to a player is relatively higher than in the normal gaming state (i.e., the extent of advantage is relatively higher). However, the expected value in the RT section is relatively lower than the expected value in the MB gaming state.

The MB gaming state operates, on condition that a combination of symbols corresponding to MB1 or MB2 (i.e., ┌U-Crown-U┘ or ┌Blue 7-Blue 7-Blue 7┘) is displayed along the activated line. On condition that the number of medals paid out in the MB gaming state is greater than a predetermined number (i.e., 253 pieces), the MB gaming state is over and the gaming state is shifted to the normal gaming state.

The carryover section operates, on condition that MB1 or MB2 is determined as an internal winning combination in the internal winning lottery process (see FIG. 20). On condition that a combination of symbols corresponding to MB1 or MB2 is displayed along the activated line, the carryover section is over and the MB gaming state operates. In addition, in case that a combination of symbols corresponding to RT in the carryover section (i.e., ┌Replay-Replay-E┘, ┌Replay-Replay-Blue 7┘ or ┌Replay-Replay-Watermelon┘) is displayed along the activated line, the carryover section is not over and the RT section operates. In other words, the carryover section and the RT section operate at the same time.

The RT section is classified into a RT1 and a RT2 in accordance with operating conditions. Specifically, the RT1 section operates on condition that the MB gaming state is over, which has operated on condition that a combination of symbols corresponding to MB1 (i.e., ┌U-Crown-U┘) has been displayed along the activated line. In addition, the RT2 section operates on condition that a combination of symbols corresponding to RT in the RT1 and non-RT sections is displayed along the activated line. In addition, in case that the MB gaming state is over, which has operated on condition that a combination of symbols corresponding to MB2 (i.e., ┌Blue 7-Blue 7-Blue 7┘) has been displayed along the activated line, the RT1 section does not operate.

The RT1 and RT2 sections are basically over on condition that the predetermined number of games (i.e., 1000 times) is over, and the gaming state is shifted to the normal gaming state. In addition, the RT1 and RT2 sections are over on condition that MB1 or MB2 is determined as an internal winning combination in the internal lottery process (see FIG. 20), and then the carryover section operates. Accordingly, the RT1 and RT2 sections are basically continued over maximum 1000 times of games.

Herein, in one embodiment, it is such structured that the RT1 section is over on condition that a combination of symbols corresponding to RT in the RT1 section is displayed along the activated line and then the RT2, which is continued over maximum 1000 times of games, operates. Accordingly, in case that a combination of symbols corresponding to RT in the RT1 section is displayed along the activated line, the RT section, including the RT1 and RT2, can be continued over 1000 times of games or more.

In other words, the gaming machine according to the embodiment 1 comprises means for operating the RT1 section which is continued over maximum 1000 games when the MB gaming state is over, and means for operating the RT2 section which is continued over maximum 1000 games when the combination of symbols corresponding to RT is displayed along the activated line. In addition, in case that the RT1 section operates, if the combination of symbols corresponding to RT is displayed along the activated line, the RT2 operates since then, which is continued over 1,000 games (i.e., the number of games is updated).

By doing so, the number of games in which the RT section continues is not fixed, and the player may play the game with the expectations that a combination of symbols corresponding to RT will be displayed along the activated line and the RT section will be continued over 1,000 games or more. Accordingly, it is possible to provide a gaming machine capable of enabling a game, in which the RT section operates, not to be monotonous and keeping up the player's interest in the game in the RT section.

In addition, in case that a combination of symbols corresponding to RT in the RT2 section is displayed along the activated line, the RT2 section does not newly operate. Accordingly, in this case, the RT section is not continued over the number of games larger than 1000 times. By doing so, it is possible to prevent the RT section from being continued beyond necessity and to allow the RT section to be changed more variously.

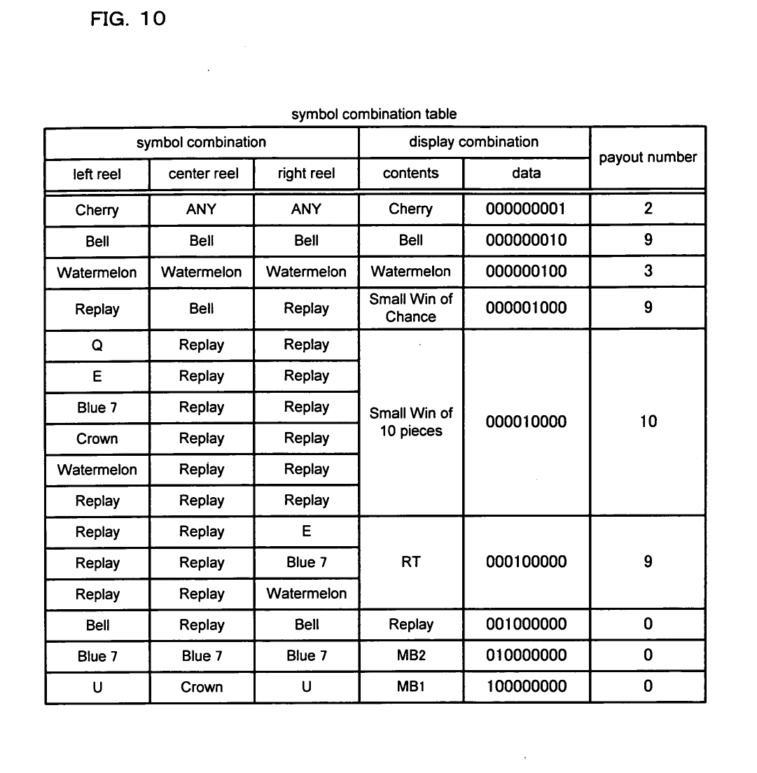

Herein, in one embodiment, it is designed such that the RT section is continued, to the utmost, over the number of games larger than a reciprocal (i.e., about 296.5) of a probability that a bonus will be determined as an internal winning combination (for example, probability that MB1 and MB2, which are defined by an internal lottery table for the normal gaming state (see FIG. 9), will be determined as an internal winning combination). By dosing so, it is possible to sufficiently increase a probability that a bonus will be determined as an internal winning combination in a period during which the RT section operates, and thus to further enhance a joy which may be obtained when a player recognizes that the RT section has operated.

FIG. 5 shows a circuit structure comprising a main control circuit 71 controlling an operation of the gaming machine 1, a peripheral device (i.e., actuator) electrically connected to the main control circuit 71, and a sub-control circuit 72 controlling the liquid crystal display device 131, the speakers 9L, 9R, the LED 101 and the lamp 102 on the basis of control signals transmitted from the main control circuit 71.

The main control circuit 71 comprises a microcomputer 30 arranged on a circuit board as a main constituting element and is further provided with a circuit for sampling random numbers. The microcomputer 30 includes a CPU 31, a ROM 32 and a RAM 33.

The CPU 31 executes a program stored in the ROM 32 to carry out a process regarding a game progress and controls an operation of each actuator in a direct or indirect manner. To the CPU 31 is connected a clock pulse generating circuit 34 for generating a reference clock pulse, a frequency divider 35, a random number generator 36 for generating a random number and a sampling circuit 37 for sampling a random number value from the generated random numbers. In addition, it may be structured such that the CPU 31 generates a random number and samples a random number value. In this case, the random number generator 36 and the sampling circuit 37 may be omitted. However, they may be also held for a preliminary use.

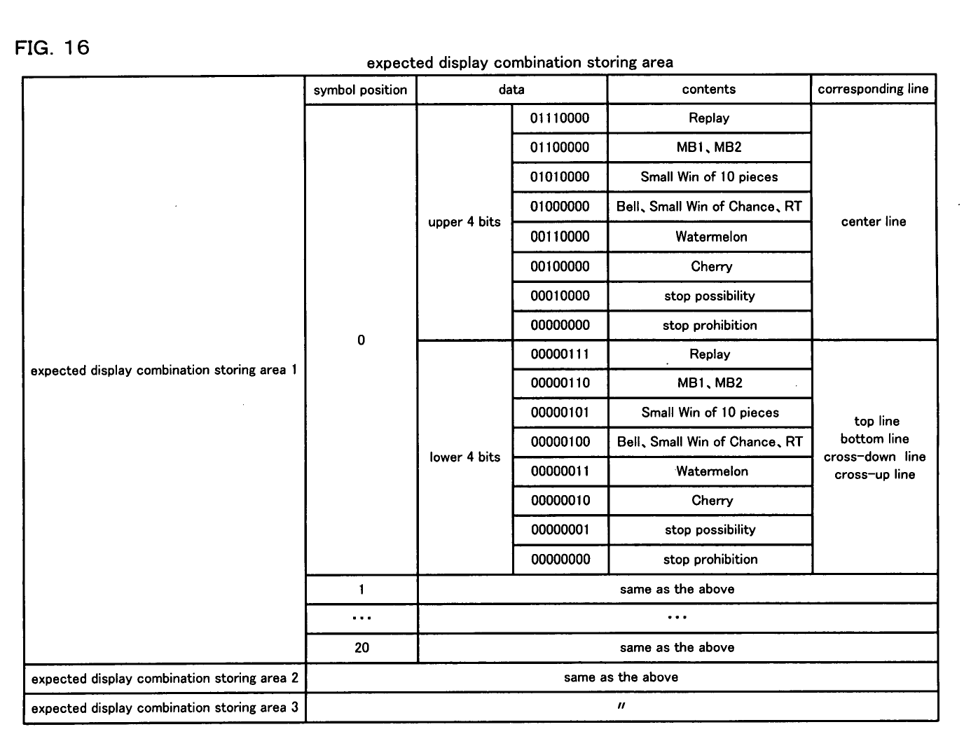

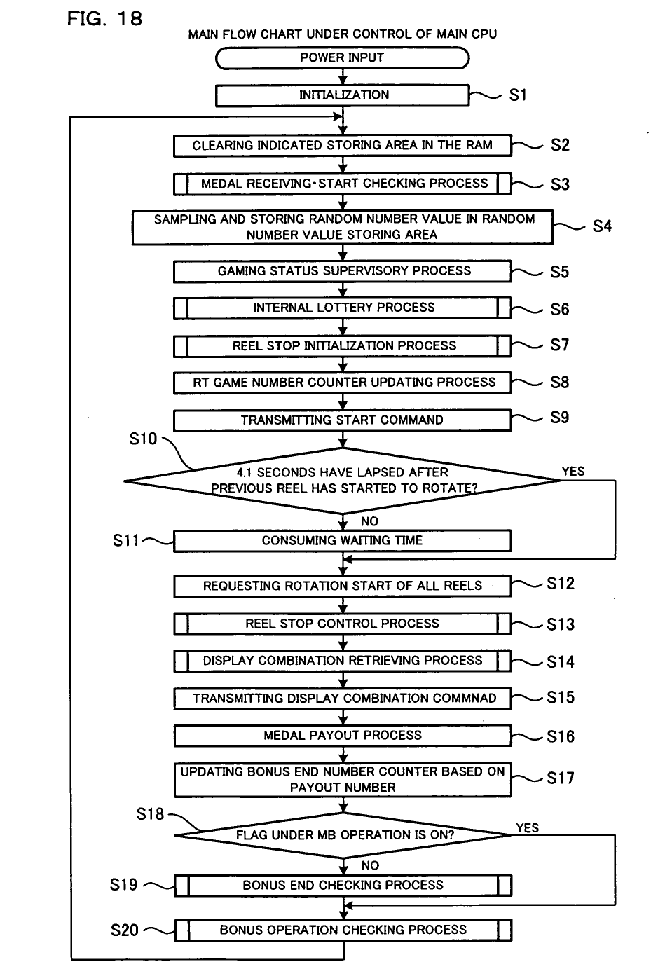

The ROM 32 memorizes a program to be executed by the CPU 31 (for example, see FIGS. 18 to 30) or fixed data. For example, an internal lottery table (see FIG. 9) for determining an internal winning combination on the basis of the sampled random number value, an expected display combination storing area (see FIG. 16) for determining a stop mode of a reel in accordance with the stop operation and the like are stored in the ROM 32. In addition, various control signals for being transmitted to the sub-control circuit 72 are stored in the ROM 32. In addition, a command, information and the like are not transmitted from the sub-control circuit 72 to the main control circuit 71. In other words, it is carried out a one-way communication from the main control circuit 71 to the sub-control circuit 72.

The RAM 33 is used to temporarily memorize the data when the CPU 31 executes a program. For example, information about an internal winning combination, an internal carryover combination, a current gaming state, a timer for a demo which will be described later, and the like are stored in the RAM 33.

In the circuit shown in FIG. 5, main actuators controlled by control signals from the microcomputer 30 include display units such as BET lamps (1-BET lamp 17a, 2-BET lamp 17b, MAX-BET lamp 17c), bonus game information display unit 16, payout display unit 18, credit display unit 19 and the like, a hopper 40 receiving a medal and paying out a predetermined number of medals by a command of a hopper driving circuit 41, and stepping motors 49L, 49C, 49R for rotating the reels 3L, 3C, 3R.

In addition, to the CPU 31 are connected a motor driving circuit 39 outputting a driving pulse to the stepping motors 49L, 49C, 49R to control rotating operations of the stepping motors 49L, 49C, 49R, the hopper driving circuit 41 controlling an operation of the hopper 40, a lamp driving circuit 45 for turning on/off the BET lamps 17a, 17b, 17c and a display unit driving circuit 48 for controlling the display by the display units (i.e., bonus game information display unit 16, payout display unit 18, credit display unit 19 and the like). These driving circuits receive the control signals outputted from the CPU 31 to control the operations of the actuators, respectively.

In addition, as means for generating an input signal transmitted to the microcomputer 30 so that the microcomputer 30 generates a control signal, there are provided a start switch 6S, stop switches 7LS, 7CS, 7RS, a 1-BET switch 11, a 2-BET switch 12, a MAX-BET switch 13, a C/P switch 14, a medal sensor 10S, a reel position detection circuit 50 and a payout completion signal circuit 51.

The start switch 6S detects a manipulation of the start lever 6 and outputs a game start command signal to start a game. The medal sensor 10S detects a medal inserted into the medal insertion slot 10. The stop switches 7LS, 7CS, 7RS generate a stop command signal for stopping the symbol variation in accordance with the operations of the corresponding stop buttons 7L, 7C, 7R.

The reel position detection circuit 50 receives a pulse signal from reel rotating sensors mounted at the reels 3L, 3C, 3R and supplies a signal for detecting a rotating position of each of the reels 3L, 3C, 3R to the CPU 31. The payout completion signal circuit 51 generates a signal for detecting a payout completion of the medal when a value counted by a medal detection unit 40S (i.e., the number of medals paid out from the hopper 40) reaches a predetermined value.

In the circuit of FIG. 5, the random number generator 36 generates random numbers within a predetermined range, and the sampling circuit 37 samples one random number value from the random numbers generated by the random number generator 36 at an appropriate timing after the start lever 6 is manipulated. The random number value sampled is stored in a random number value storing area of the RAM 33 and referred to determine an internal winning combination and the like on the basis of the internal lottery table (see FIG. 9) stored in the ROM 32, for example.

When the driving pulse is outputted by a predetermined number of times (for example, 336 times) to the stepping motors 49L, 49C, 49R, the reels 3L, 3C, 3R make one revolution. The number of driving pulses outputted to each of the stepping motors 49L, 49C, 49R is written in a predetermined area of the RAM 33 as a count value of the driving pulses. In the mean time, a reset pulse is obtained from the reels 3L, 3C, 3R every one revolution. When the reset pulse is inputted to the CPU 31 through the reel position detection circuit 50, the count value of the driving pulses stored in the RAM 33 is updated to ┌0┘. Thereby, the count value of the driving pulses corresponds to a rotating position within a range of one revolution with regard to each of the reels 3L, 3C, 3R.

In addition, in order to match the rotating positions of the reels 3L, 3C, 3R to the symbols arranged on the peripheries of the reels, a symbol table (not shown) is stored in the ROM 32. In this symbol table, on the basis of the rotating positions generated by the reset pulse, code numbers sequentially given every rotation pitch of the respective reels 3L, 3C, 3R are matched to symbol codes representing symbols provided to correspond to each of the code numbers.

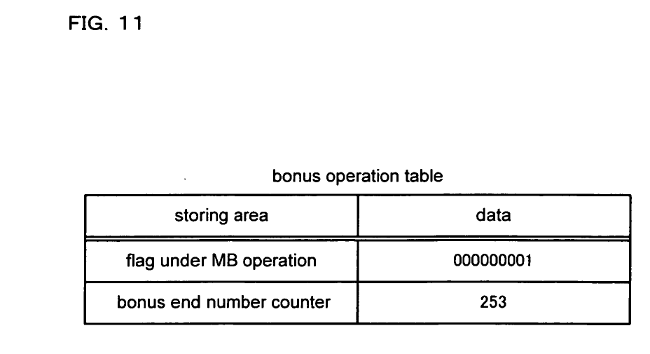

In addition, a symbol combination table (see FIG. 10) is stored in the ROM 32. The symbol combination table is referred when it is carried out a control for stopping the rotations of the left reels 3L, the center reel 3C and the right reel 3R and when it is carried out determinations of a display combination and a payout (for example, payout number of medals) to be awarded to a player after all the reels 3L, 3C, 3R are stopped.

In case that an internal winning combination is determined by the internal lottery process (see FIG. 20) based on the sampling of the random number value, the CPU 31 transmits a signal for performing the control for stopping the rotations of the reels 3L, 3C, 3R to the motor driving circuit 39, on the basis of the input signals transmitted from the stop switches 7LS, 7CS, 7RS and the determined stop table (not shown) at the timing at which the player operates the stop buttons 7C, 7L, 7R.

When a winning is made, the CPU 31 supplies a payout command signal to the hopper driving circuit 41 to pay out a predetermined number of medals from the hopper 40. At this time, the medal detection unit 40S counts the number of medals paid out from the hopper 40, and the medal payout completion signal is inputted to the CPU 31 when the counted value reaches a predetermined number. Thereby, the CPU 31 stops the driving of the hopper 40 through the hopper driving circuit 41 and ends the medal payout process.

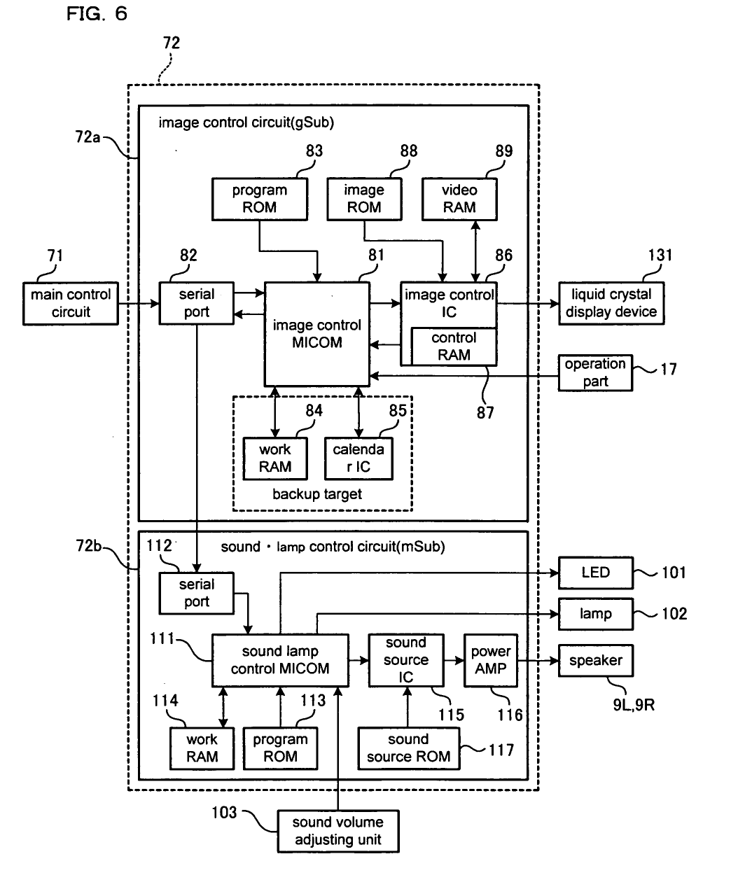

FIG. 6 is a block diagram showing a structure of the sub-control circuit 72. The sub-control circuit 72 comprises an image control circuit (gSub) 72a and a sound•lamp control circuit (mSub) 72b. The image control circuit (gSub) 72a and the sound•lamp control circuit (mSub) 72b are formed on separate circuit boards different from the circuit board constituting the main control circuit 71.

The communication between the main control circuit 71 and the image control circuit (gSub) 72a is carried out in a one-way manner, from the main control circuit 71 to the image control circuit (gSub) 72a. In other words, a control command or information is not transmitted to the main control circuit 71 from the image control circuit (gSub) 72a. In addition, the communication between the image control circuit (gSub) 72a and the sound•lamp control circuit (mSub) 72b is carried out in a one-way manner, from the image control circuit (gSub) 72a to the sound•lamp control circuit (mSub) 72b. That is, a control command or information is not transmitted to the image control circuit (gSub) 72a from the sound•lamp control circuit (mSub) 72b.

The image control circuit (gSub) 72a comprises an image control MICOM 81, a serial port 82, a program ROM 83, a work RAM 84, a calendar IC 85, an image control IC 86, a control RAM 87, an image ROM (character ROM) 88 and a video RAM 89.

The image control MICOM 81 comprises a CPU, an intervention controller and an I/O port (serial port 82 is shown). The CPU provided to the image control MICOM 81 executes various processes in accordance with control programs stored in the program ROM 83, based on the control command transmitted from the main control circuit 71. In addition, the image control circuit (gSub) 72a is not provided with a clock pulse generating circuit, a frequency divider, a random number generator and a sampling circuit. However, it is adapted to carry out a random number sampling in a software manner on an operating program of the image control MICOM 81.

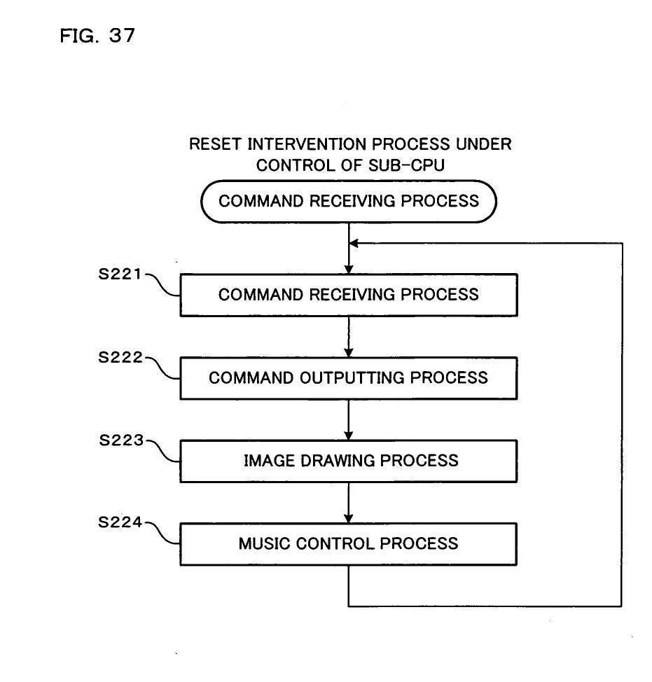

The serial port 82 is a port receiving the control command and the like transmitted from the main control circuit 71. The program ROM 83 memorizes various programs to be executed in the image control MICOM 81 (for example, FIGS. 37 to 41 in a second embodiment which will be described later).

The work RAM 84 is used as means for temporarily memorizing the information used when the image control MICOM 81 executes the control program. Various information is stored in the work RAM 84.

The calendar IC 85 memorizes date data. The image control MICOM 81 is connected with the operating unit 17. In one embodiment, an employee in a game arcade operates the operating unit to set a date. The image control MICOM 81 memorizes the set date information in the calendar IC 85 based on the input signal transmitted from the operating unit 17. The date memorized in the calendar IC 85 is backed up.

In addition, the work RAM 84 and the calendar IC 85 are backup targets. Accordingly, even though the power supplied to the image control MICOM 81 is cutoff, the power is continuously supplied to them, so that the memorized information is not erased.

The image control IC 86 produces and outputs an image corresponding to contents of effect (for example, effect data described later) determined by the image control MICOM 81 to the liquid crystal display device 131.

The control RAM 87 is included in the image control IC 86. The image control MICOM 81 carries out a process of writing or reading the information and the like to and from the control RAM 87. In addition, the control RAM 87 is developed with a register and the like of the image control IC 86. The image control MICOM 81 updates the register and the like of the image control IC 86 at every timing predetermined.

The image control IC 86 is connected with the liquid crystal display device 131, the image ROM 88 and the video RAM 89. In addition, the image ROM 88 may be connected to the image control MICOM 81. In this case, such structure may be effective in processing mass image data such as three dimensional image data, etc. The image ROM 88 stores image data for producing an image and the like. The video RAM 89 serves as temporary memory means when the image control IC 86 produces an image. In addition, the image control IC 86 transmits a signal to the image control MICOM 81 whenever the data transmission of the video RAM 89 to the liquid crystal display device 131 is completed.

In addition, in the image control circuit (gSub) 72a, the image control MICOM 81 carries out the effects of the sound•lamp, too. The image control MICOM 81 determines types and output timing of the sound•lamp based on the contents of effect (for example, effect data described later). The image control MICOM 81 transmits a command to the sound•lamp control circuit (mSub) 72b via the serial port 82 at every timing predetermined. The sound•lamp control circuit (mSub) 72b mainly controls only the output of the sound•lamp in accordance with the command received from the image control circuit (gSub) 72a.

The sound•lamp control circuit (mSub) 72b comprises a sound•lamp control MICOM 111, a serial port 112, a program ROM 113, a work RAM 114, a sound source IC 115, a power AMP 116 and a sound source ROM 117.

The sound•lamp control MICOM 111 comprises a CPU, an intervention controller and an I/O port (serial port is shown). The CPU in the sound•lamp control MICOM 111 executes a process of controlling the output of the sound•lamp in accordance with control programs stored in the program ROM 113, based on the command transmitted from the image control circuit (gSub) 72a.

In addition, the sound•lamp control MICOM 111 is connected with the LED 101 and the LAMP 102. The sound•lamp control MICOM 111 transmits an output signal to the LED 101 and the lamp 102, in accordance with the command transmitted from the image control circuit (gSub) 72a at the timing predetermined. Thereby, the LED 101 and the lamp 102 emit lights with a predetermined mode in correspondence with the effects.

The serial port 112 receives the command and the like transmitted from the image control circuit (gSub) 72a. The program ROM 113 stores the program to be executed in the sound•lamp control MICOM 111 and the like. The work RAM 94 is means for temporarily memorizing the information when the sound•lamp control MICOM 111 executes the program described above.

The sound source IC 115 produces a sound source based on the command transmitted from the image control circuit (gSub) 72a, and outputs the produced sound source to the power AMP 116. The power AMP 116 is an amplifier and connected with the speakers 9L, 9R. The power AMP 116 amplifies the sound source outputted from the sound source IC 115, and outputs the amplified sound source from the speakers 9L, 9R. The sound source ROM 117 stores sound source data for producing the sound source.

To the sound•lamp control MICOM 111 is connected a sound volume adjusting unit 103. The sound volume adjusting unit 103 is such structured that it can be manipulated by an employee in a game arcade, and adjusts the sound volume to be outputted from the speakers 9L, 9R. Based on the input signal transmitted from the sound volume adjusting unit 103, the sound•lamp control MICOM 111 carries out the control for adjusting the sound outputted from the speakers 9L, 9R to the inputted sound volume in accordance with the transmitted input signal.

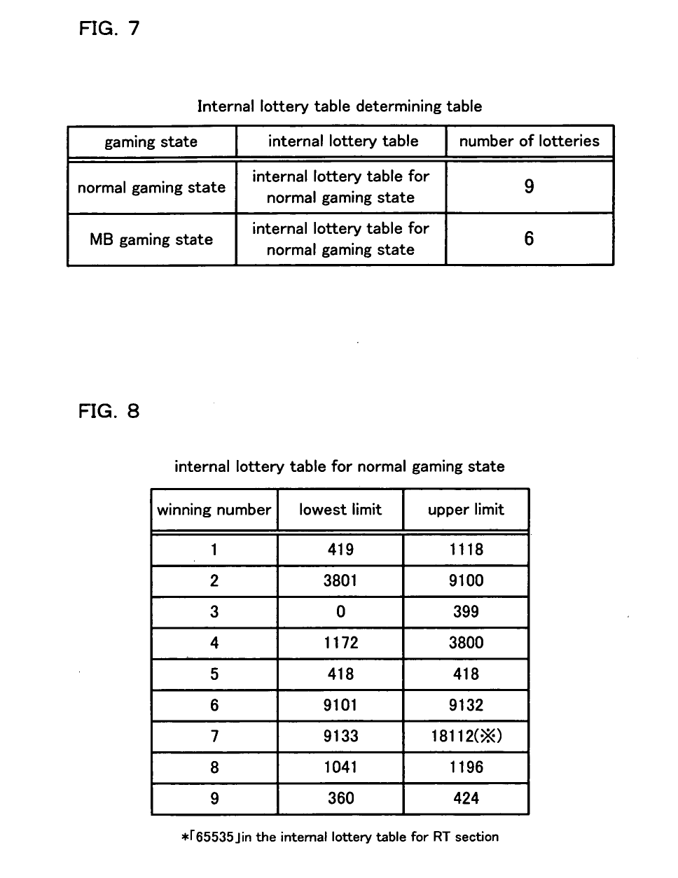

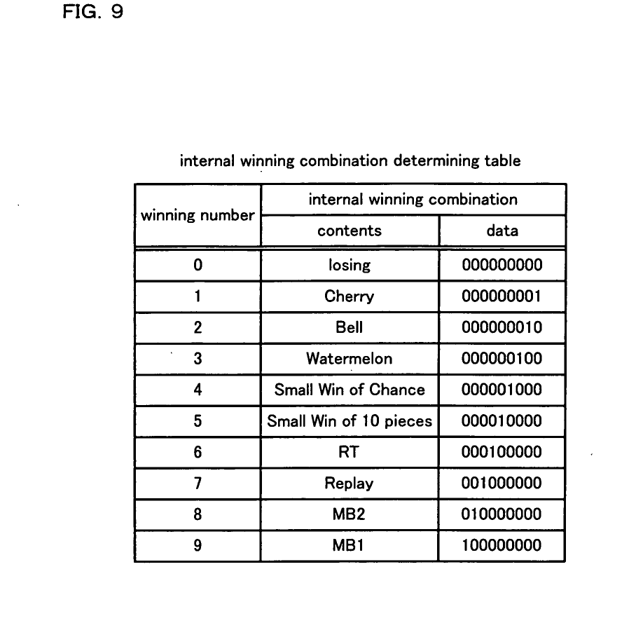

In the followings, it is described an internal lottery table determining table for determining an internal lottery table (see FIG. 8) and the number of lotteries, with reference to FIG. 7.

The internal lottery table determining table includes information about an internal lottery table (see FIG. 8) and the number of lotteries corresponding to the gaming state. In case of the normal gaming state, an internal lottery table for the normal gaming state (see FIG. 8) is selected and ┌9┘ is basically determined as the number of lotteries (see a step S41 of FIG. 20). In the case of the MB gaming state, an internal lottery table for the normal gaming state is selected and ┌6┘ is determined as the number of lotteries. The number of lotteries indicates the number of operations carried out to determine an internal winning combination.

More specifically, the number of lotteries is the number of operations carried out to determine whether the random number value is within a predetermined range (a numerical range expressed by the lowest and upper limits corresponding to a winning number, which will be described with reference to FIG. 8). However, in the case of the carryover section, the number of lotteries determined to be ┌9┘ is updated to ┌7┘ (see a step S45 of FIG. 20).

In the followings, it is described an internal lottery table used in an internal lottery process (see FIG. 20) for determining an internal winning combination, with reference to FIG. 8.

The internal lottery table is provided every gaming state and includes the information about the numerical range expressed by the lowest and upper limits corresponding to a winning number. FIG. 8 shows an internal lottery table for a normal gaming state. In addition, it is omitted an internal lottery table except the internal lottery table for the normal gaming state, such as internal lottery table for a gaming state of a RT section and the like.

In the determination of a winning number based on the internal lottery table, it is determined whether a random number value sampled from the random number of ┌0┘˜┌65535┘ is within a numerical range expressed by the lowest and upper limits corresponding the a winning number, from the same winning number as the number of lotteries determined by the internal lottery table determining table (see FIG. 7) to the winning number ┌0┘, in descending power. When the random number value is within a numerical range expressed by the lowest and upper limits, a corresponding winning number is won (i.e., determined). Based on the winning number determined and the internal winning combination determining table (see FIG. 9), an internal winning combination is determined. In addition, the number of operations, which are carried out to determine whether the random number value is within a numerical range expressed by the lowest and upper limits corresponding to a winning number, is same as the number of lotteries determined in the internal lottery table determining table in FIG. 7.

For example, in case that the random number value sampled in the normal gaming state is ┌4000┘, it is determined whether the sampled random number value is within the numerical range expressed by the lowest and upper limits corresponding to the winning number, from the winning number ┌9┘ to the winning number ┌0┘ in descending power. Then, it is determined that the random number value is within the numerical range (i.e., ┌3801┘˜┌9100┘) expressed by the lowest and upper limits corresponding to the winning number ┌2┘. In addition, it is determined that the random number value is not within the numerical ranges expressed by the lowest and upper limits corresponding to the winning numbers except the winning number ┌2┘. Accordingly, in this case, a winning is made in the winning number ┌2┘, and Bell is determined as an internal winning combination based on the internal winning combination determining table (see FIG. 9).

In addition, in case that the random number value is never within a numerical range expressed by the lowest and upper limits until the winning number becomes ┌0┘, the winning number becomes ┌0┘ (i.e., the internal winning combination is the losing). The losing is meant that the internal winning combination matched to the player's payout is not determined in the internal lottery. In addition, in one embodiment, the losing is not an internal winning combination matched to a game value. Additionally, it may be thought that a combination of symbols corresponding to the losing as an internal winning combination is any combination of symbols different from combinations of symbols corresponding to plural combinations predetermined. However, in one embodiment, it is such structured that a combination of symbols corresponding to the losing is not provided.

In addition, it is determined whether a winning is made, until a winning number becomes ┌0┘, in descending order, and it is set so that the numerical ranges defined by the lowest and upper limits corresponding to each of the internal winning combinations having a winning (i.e., determination) possibility are duplicated. Accordingly, plural internal winning combinations may be determined. An internal winning combination is determined on the basis of the winning number determined and the internal winning combination determining table (see FIG. 9).

For example, in case of the normal gaming state (i.e., game section except the carryover section), when the random number value sampled from the random numbers consisting of a range of ┌0┘˜┌65635┘ is ┌380┘, ┌random number value ® (380)—lowest limit (L) (360)┘ is calculated for the winning number ┌9┘ first of all. The calculation result becomes ┌0┘ or more. Subsequently, ┌random number value ® (380)—upper limit (U) (424)┘ is calculated. This calculation result becomes ┌0┘ or less. Accordingly, since the random number value is within the numerical range expressed by the lowest and upper limits corresponding to the winning number (L≦R≦U), in case that the sampled random number value is ┌380┘, the winning number ┌9┘ is determined. In case that the winning number ┌9┘ is determined, MB1 corresponding to the winning number ┌9┘ becomes an internal winning combination, based on the internal winning combination determining table (see FIG. 9).

Next, ┌random number value ® (380)—lowest limit (L) (1041)┘ is calculated for the winning number ┌8┘. The calculation result becomes ┌0┘ or less. Subsequently, ┌random number value ® (380)—upper limit (U) (1194)┘ is calculated. This calculation result becomes ┌0┘ or less. Accordingly, since the random number value is not within the numerical range expressed by the lowest and upper limits corresponding to the winning number, in case that the sampled random number value is ┌380┘, the winning number ┌8┘ is not determined.

Like this, the calculations of ┌random number value ® (380)—lowest limit (L)┘ and ┌random number value ® (380)—upper limit (U)┘ are repeated in descending power until the winning number becomes ┌0┘ so as to determine whether a winning is determined in each of the winning numbers ┌7┘˜┌1┘ or not. In case that the sampled random number value is ┌380┘ the losing is determined in the winning numbers ┌7┘˜┌4┘, ┌2┘ and ┌1┘. However, regarding the winning number ┌3┘, since the lowest limit is ┌0┘ and the upper limit is ┌399┘, a winning is determined. Therefore, in case that the random number value sampled is ┌380┘, the winning is determined in the winning numbers ┌3┘ and ┌9┘, so that both Watermelon and MB1 are determined as an internal winning combination on the basis of the internal winning combination determining table (see FIG. 9).

Herein, in the carryover section, since the number of lotteries is updated to ┌7┘ (see a step S45 of FIG. 20), there are no situations where the winning number ┌8┘ or ┌9┘ is determined. Accordingly, in the carryover section, there are no situations where MB1 or MB2 is determined as an internal winning combination on the basis of the internal winning combination determining table (see FIG. 9). In addition, in the RT section, since the upper limit corresponding to the winning number ┌7┘ is updated to ┌65535┘, a probability that Replay will be determined as an internal winning combination is relatively higher than in the base section and the carryover section. Specifically, in the RT section, a probability that Replay will be determined as an internal winning combination is ┌56403/65535┘. In the non-RT section, a probability that Replay will be determined as an internal winning combination is ┌8980/65535┘.

In the followings, it is described an internal winning combination determining table for determining an internal winning combination on the basis of the wining number, with reference to FIG. 9.

The internal winning combination determining table includes information about a winning number and an internal winning combination corresponding to the winning number. The information about the internal winning combination (i.e., flag) is information about a binary number of 9 digits and provided to correspond to each internal winning combination so as to discriminate the internal winning combinations.

In case that the winning number is ┌0┘, the losing is determined as the internal winning combination (i.e., ┌000000000┘). In case that the winning number is ┌1┘, Cherry is determined as the internal winning combination (i.e., ┌000000001┘). In case that the winning number is ┌2┘, Bell is determined as the internal winning combination (i.e., ┌000000010┘).

In case that the winning number is ┌3┘, Watermelon is determined as the internal winning combination (i.e., ┌000000100┘). In case that the winning number is ┌4┘, Small Win of Chance is determined as the internal winning combination (i.e., ┌000001000┘). In case that the winning number is ┌5┘, Small Win of 10 pieces is determined as the internal winning combination (i.e., ┌000010000┘). In case that the winning number is ┌6┘, RT is determined as the internal winning combination (i.e., ┌000100000┘).

In case that the winning number is ┌7┘, Replay is determined as the internal winning combination (i.e., ┌001000000┘). In case that the winning number is ┌8┘, MB2 is determined as the internal winning combination (i.e., ┌010000000┘). In case that the winning number is ┌9┘, MB1 is determined as the internal winning combination (i.e., ┌100000000┘).

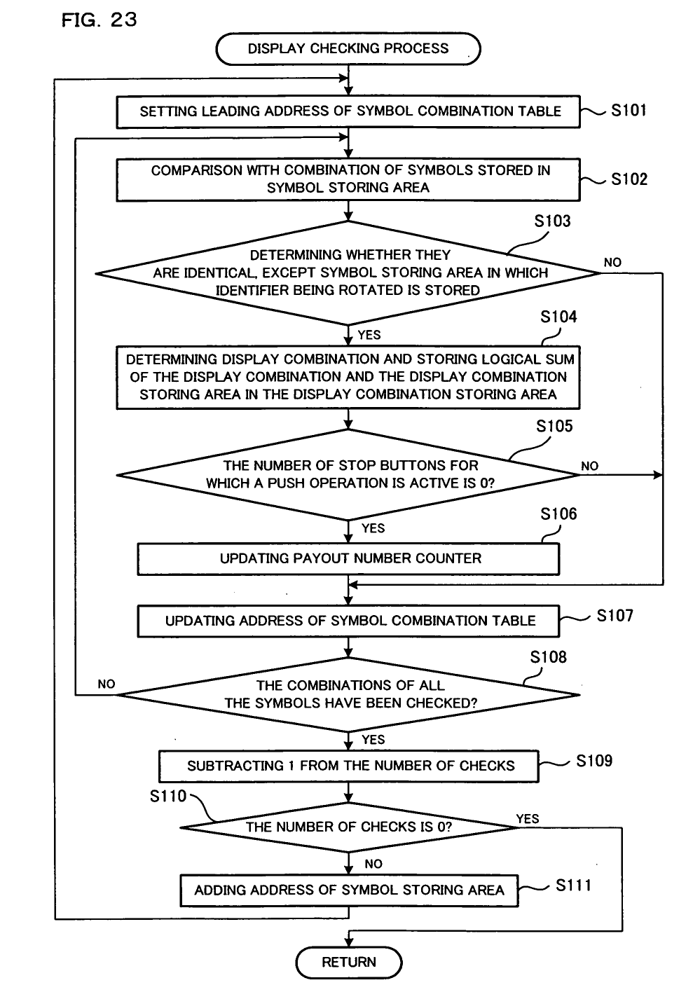

In the followings, it is described a symbol combination table used to determine a display combination and a payout number corresponding to the determined display combination in a display checking process (see FIG. 23), with reference to FIG. 10.

The symbol combination table includes information about a display combination which is an identifier of a combination of symbols stopped on each of three symbol display area connected by a one activated line, and a payout number corresponding to the display combination. The display combination is information (i.e., data) for discriminating a combination of symbols displayed along the activated line. The display combination is provided to correspond to a combination of symbols predetermined and a payout to be awarded to a player (for example, payout of medal, and operation of a gaming state).

When a combination of symbols ┌Cherry-ANY-ANY┘ is displayed along the activated line, Cherry (i.e., ┌000000001┘) becomes a display combination and two medals are paid out. ┌ANY┘ indicates any symbol. When a combination of symbols ┌Bell-Bell-Bell┘ is displayed along the activated line, Bell (i.e., ┌000000010┘) becomes a display combination and nine medals are paid out.

When a combination of symbols ┌Watermelon-Watermelon-Watermelon┘ is displayed along the activated line, Watermelon (i.e., ┌000000100┘) becomes a display combination and three medals are paid out. When a combination of symbols ┌Replay-Bell-Replay┘ is displayed along the activated line, Small Win of Chance (i.e., ┌000001000┘) becomes a display combination and nine medals are paid out.

When a combination of symbols ┌Q-Replay-Replay┘, ┌E-Replay-Replay┘, ┌Blue 7-Replay-Replay┘, ┌Crown-Replay-Replay┘, ┌Watermelon-Replay-Replay┘ or ┌Replay-Replay-Replay┘ is displayed along the activated line, Small Win of 10 pieces (i.e., ┌000010000┘) becomes a display combination and ten medals are paid out.

When a combination of symbols ┌Replay-Replay-E┘, ┌Replay-Replay-Blue 7┘, or ┌Replay-Replay-Watermelon┘ is displayed along the activated line, RT (i.e., ┌000100000)┘ becomes a display combination and 9 medals are paid out. When a combination of symbols ┌Bell-Replay-Bell┘ is displayed along the activated line, Replay (i.e., ┌001000000┘) becomes a display combination and a medal is automatically inserted. In other words, in a game next to the game in which Replay has been determined as a display combination, the insertion number automatically becomes ┌3┘ and a player can perform the start operation without the insertion operation.

When a combination of symbols ┌Blue 7-Blue 7-Blue 7┘ is displayed along the activated line, MB2 (i.e., ┌010000000┘) becomes a display combination and the MB gaming state operates. When a combination of symbols ┌U-Crown-U┘is displayed along the activated line, MB1 (i.e., ┌100000000┘) becomes a display combination and the MB gaming state operates.

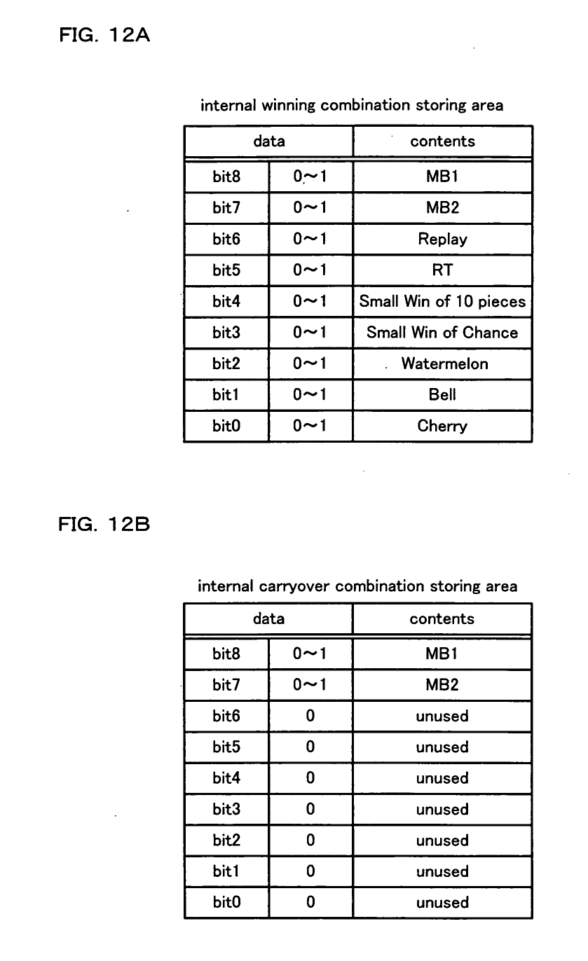

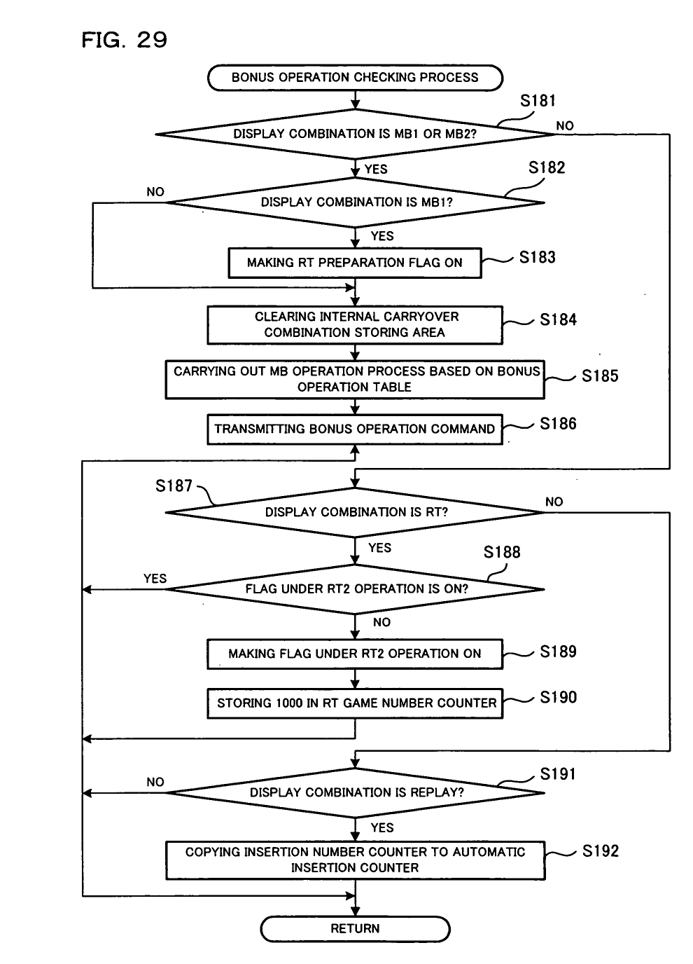

In the followings, it is described a bonus operation table which is referred in a MB operation process (see step S185 of FIG. 29), with reference to FIG. 11.

The bonus operation table includes information about a flag under operation and a value set in a bonus end number counter. The flag under operation is information for discriminating a gaming state being operating (i.e., current gaming state) and the like and includes a flag under MB operation for discriminating whether the MB gaming state operates or not, a flag under RT1 operation for discriminating whether the RT1 section operates or not and a flag under RT2 operation for discriminating whether the RT2 section operates or not.

In case that the MB gaming state operates, the flag under MB operation is ON, and in case that the MB gaming state does not operates, the flag under MB operation is OFF. In addition, in case that the RT1 section operates, the flag under RT1 operation is ON, and in case that the RT1 section does not operate, the flag under RT1 operation is OFF. In addition, in case that the RT2 section operates, the flag under RT2 operation is ON, and in case that the RT2 section does not operates, the flag under RT2 operation is OFF.

The bonus end number counter is a counter for counting the number of medals paid out to the player, from after the flag under MB operation is ON until it becomes OFF.

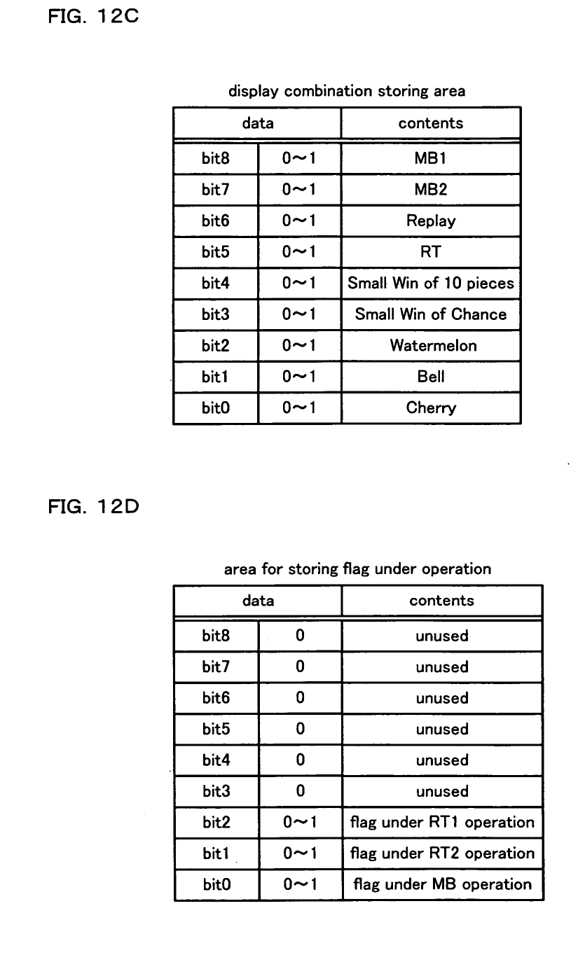

The bonus operation table is includes ┌000000001┘ representing that the flag under MB operation is ON, as data of the flag under operation. When the data is stored in an area for storing a flag under operation (see FIG. 12D), the flag under the MB operation is ON.

In the followings, it is described an internal winning combination storing area, an internal carryover combination storing area, a display combination storing area and an area for storing a flag under operation (memory area), with reference to FIG. 12.

FIG. 12A shows an internal winning combination storing area for storing information of an internal winning combination. The information of an internal winning combination is stored (memorized) in an internal winning combination storing area consisting of 9 bits. In the internal winning combination storing area, the bit 0 is a storing area corresponding to Cherry. The bit 1 is a storing area corresponding to Bell. The bit 2 is a storing area corresponding to Watermelon. The bit 3 is a storing area corresponding to Small Win of Chance.

The bit 4 is a storing area corresponding to Small Win of 10 pieces. The bit 5 is a storing area corresponding to RT. The bit 6 is a storing area corresponding to Replay. The bit 7 is a storing area corresponding to MB2. The bit 8 is a storing area corresponding to MB1.

In the internal winning combination storing area, a bit corresponding to an internal winning combination becomes ┌1┘. For example, when ┌000000010┘ is stored in the internal winning combination storing area (when the bit 1 is ┌1┘), the internal winning combination is Bell. In addition, in the MB gaming state, ┌000111111┘ is stored in the internal winning combination storing area. In other words, the bits ┌0┘˜┌5┘ of the internal winning combination storing area become ┌1┘. Accordingly, in the MB gaming state, all internal winning combinations except MB1, MB2 and Replay are determined at the same time.

FIG. 12B shows an internal carryover combination storing area for storing information of an internal carryover combination. The information of an internal carryover combination is stored in an internal carryover combination storing area consisting of 9 bits. In the internal carryover combination storing area, the bit 7 is a storing area corresponding to MB2. The bit 8 is a storing area corresponding to MB1. The bits 0, 1, 2, 3, 4, 5, and 6 are unused storing areas.

For example, in case that there is an internal carryover combination (i.e., carryover section), ┌1┘ is stored in the bit 7 or 8 corresponding to MB2 or MB1 of the internal carryover combination storing area (i.e., ┌010000000┘ or ┌100000000┘ is stored in the internal carryover combination storing area┘. In addition, in case that there is no internal carryover combination (i.e., there is no carryover section), ┌0┘ is stored in the bit 7 or 8 corresponding to MB2 or MB1 of the internal carryover combination storing area (i.e., ┌000000000┘ is stored in the internal carryover combination storing area).

FIG. 12C shows a display combination storing area for storing information of a display combination. The information of a display combination is stored in a display combination storing area consisting of 9 bits. In the display combination storing area, the bit 0 is a storing area corresponding to Cherry. The bit 1 is a storing area corresponding to Bell. The bit 2 is a storing area corresponding to Watermelon. The bit 3 is a storing area corresponding to Small Win of Chance.

The bit 4 is a storing area corresponding to Small Win of 10 pieces. The bit 5 is a storing area corresponding to RT. The bit 6 is a storing area corresponding to Replay. The bit 7 is a storing area corresponding to MB2. The bit 8 is a storing area corresponding to MB1.

FIG. 12D shows an area for storing a flag under operation. The flag under operation is stored in an area for storing a flag under operation, which consists of 9 bits. In the area for storing a flag under operation, the bit 0 is a storing area corresponding to a flag under MB operation. The bit 1 is a storing area corresponding to a flag under RT2 operation. The bit 2 is a storing area corresponding to a flag under RT1 operation. The bits 3, 4, 5, 6 and 7 are unused storing areas.

Herein, in case that ┌1┘ is stored in the bit 0 corresponding to the flag under MB operation of the area for storing a flag under operation (i.e., ┌000000001┘ is stored in the area for storing a flag under operations , the flag under MB operation is ON. In case that ┌1┘ is stored in the bit 1 corresponding to the flag under RT2 operation of the area for storing a flag under operation (i.e., ┌000000010┘ is stored in the area for storing a flag under operation┘, the flag under RT2 operation is ON. In case that ┌1┘ is stored in the bit 2 corresponding to the flag under RT1 operation of the area for storing a flag under operation (i.e., ┌000000100┘ is stored in the area for storing a flag under operation), the flag under RT1 operation is ON.

In this embodiment, for convenience sake of explanations, a word length (bits of data which can be processed at the same time) of the MICOM consisting of the CPU 31, the ROM 32 and the RAM 33 is 9 bits. However, in a standard pachi-slot, a MICOM having a word length of 8 bits is applied. In such pachi-slot, for example, the internal winning combination storing area of the RAM 33 is divided into an internal winning combination storing area 1 and an internal winning combination storing area 2, each of which consisting of 8 bits. Accordingly, the data of 9 bits is divided and stored in the plural internal winning combination storing areas so that the data can be processed.

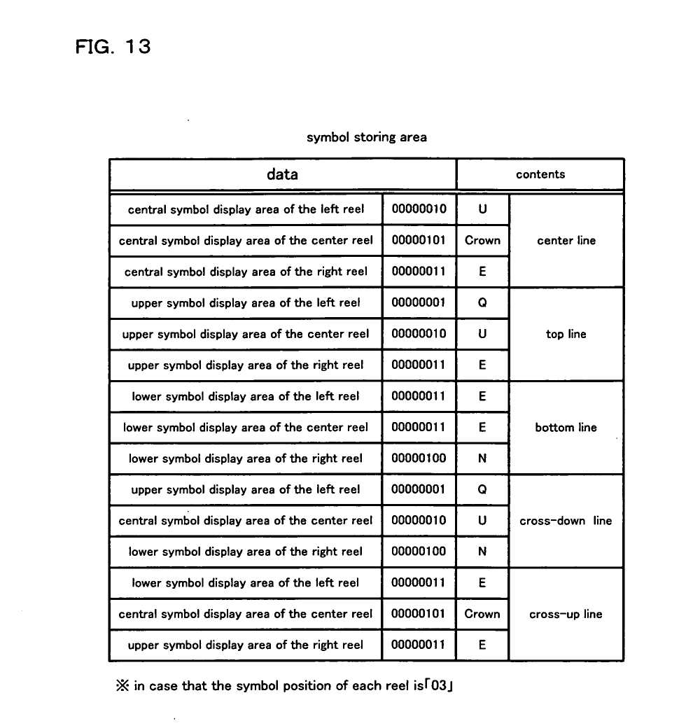

In the followings, a symbol storing area is described with reference to FIG. 13.

FIG. 13 shows data which is stored in the symbol storing area when the symbol position of each of the reels 3L, 3C, 3R is ┌03┘. The symbol position is a code number corresponding to a symbol located on the center line 8c.

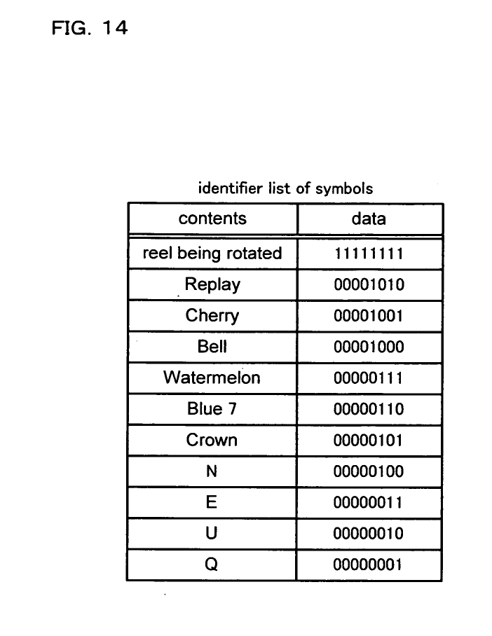

In the symbol storing areas, with regard to areas corresponding to each of the display lines 8a to 8e, an identifier (i.e., data) corresponding to a type of a symbol located on the corresponding symbol display area is stored in an area corresponding to each of the symbol display areas connected by the corresponding display line. The identifier is information for discriminating a type of a symbol and provided to correspond to each of the types of symbols, which will be described with reference to FIG. 14.

Herein, in case that the symbol position of each of the reels 3L, 3C, 3R is ┌03┘ (i.e., the symbol corresponding to the code number 03 of the respective reels 3L, 3C, 3R is located on the center line 8c), the symbols ┌U┘, ┌Crown┘ and ┌E┘ are located at the central symbol display area of the left reel 3L, the central symbol display area of the center reel 3C and the central symbol display area of the right reel 3R, respectively.

In this case, in the area corresponding to the center line 8c of the symbol storing area, ┌000000010┘ which is an identifier representing the symbol ┌U┘, ┌000000101┘ which is an identifier representing the symbol ┌Crown┘, and ┌000000011┘ which is an identifier representing the symbol ┌E┘ are stored in the central symbol display area of the left reel 3L, the central symbol display area of the center reel 3C and the central symbol display area of the right reel 3R, respectively.

In addition, in case that the symbol position of each of the reels 3L, 3C, 3R is 03, as shown in FIG. 13, even for the display lines except the center line 8c, in the symbol storing areas, an identifier corresponding to a type of a symbol located on the corresponding symbol display area is stored in an area corresponding to each of the symbol display areas connected by the corresponding display line at the area corresponding to the corresponding display line.

In addition, identifiers corresponding to types of symbols actually located in each symbol display area are stored in the symbol display area. Further, in case that the reels are being rotated, on the assumption that the rotation of the corresponding reel is stopped at any one symbol position, in this case, identifiers corresponding to types of symbols located in each symbol display area of the corresponding reel are stored in the symbol storing areas.

In the followings, it is described a correspondence between identifiers (i.e., data) stored in the symbol storing areas and types of symbols, with reference to FIG. 14 showing an identifier list of symbols.

In case that there is a reel being rotated, in the symbol storing areas, identifier ┌11111111┘ is stored in an area corresponding to the symbol display area corresponding to the corresponding reel. An identifier corresponding to the symbol ┌Replay┘ is ┌00001010┘. An identifier corresponding to the symbol ┌Cherry┘ is ┌00001001┘. An identifier corresponding to the symbol ┌Bell┘ is ┌00001000┘. An identifier corresponding to the symbol ┌Watermelon┘ is ┌00000111┘. An identifier corresponding to the symbol ┌Blue 7┘ is ┌00000110┘.

An identifier corresponding to the symbol ┌Crown┘ is ┌00000101┘. An identifier corresponding to the symbol ┌N┘ is ┌00000100┘. An identifier corresponding to the symbol ┌E┘ is ┌00000011┘. An identifier corresponding to the symbol ┌U┘ is ┌00000010┘. An identifier corresponding to the symbol ┌Q┘ is ┌00000001┘.

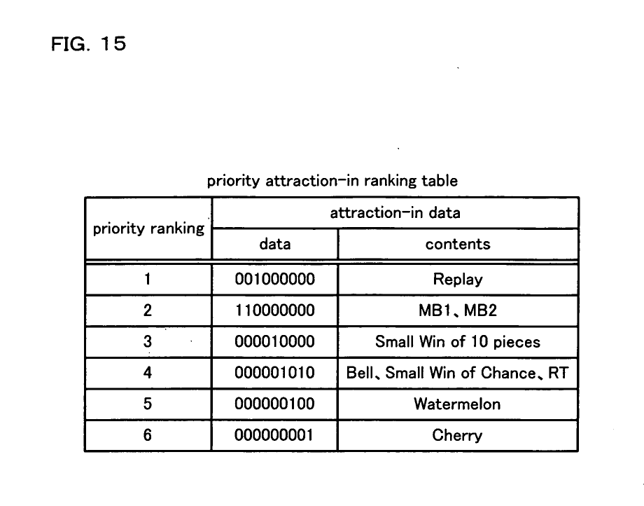

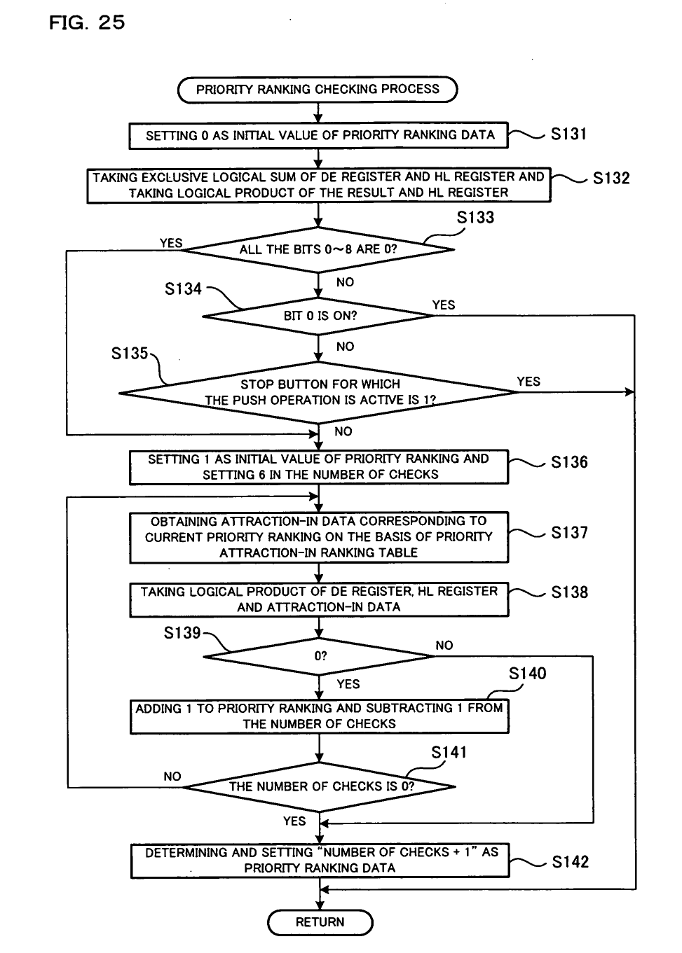

In the followings, it is described a priority attraction-in ranking table which is referred so as to determine priority ranking data in a priority ranking checking process (see FIG. 25), which data will be described later, with reference to FIG. 15.

The priority attraction-in ranking table includes information about a priority attraction-in ranking of a combination of symbols corresponding to an internal winning combination and attraction-in data corresponding to the corresponding priority ranking. Basically, the ┌attraction-in┘ is meant by a control for stopping the rotation of reel (i.e., a reel corresponding to a stop button which has been pushed) so that symbols (hereinafter, referred to as ┌attraction-in target symbol┘) constituting a combination of symbols corresponding to an internal winning combination within a range of the maximum number of sliding symbols are displayed in the symbols display areas (hereinafter, referred to as ┌active symbol display area┘) connected by the activated line.

The priority ranking data is basically information for discriminating priority ranking of the attraction-in. The attraction-in data is information for discriminating internal winning combinations corresponding to the priority rankings of the attraction-in, and provided to correspond to each of the priority rankings of the attraction-in.

The attraction-in data (i.e., ┌001000000┘) corresponding to the priority ranking ┌1┘ corresponds to Replay. The attraction-in data (i.e., ┌110000000┘) corresponding to the priority ranking ┌2┘ corresponds to MB1 and MB2. The attraction-in data (i.e., ┌000010000┘) corresponding to the priority ranking ┌3┘ corresponds to Small Win of 10 pieces.

The attraction-in data (i.e., ┌000000100┘) corresponding to the priority ranking ┌4┘ corresponds to Bell, Small Win of Chance and RT. The attraction-in data (i.e., ┌000000100┘) corresponding to the priority ranking ┌5┘ corresponds to Watermelon. The attraction-in data (i.e., ┌000000001┘) corresponding to the priority ranking ┌6┘ corresponds to Cherry.

In addition, in case of second and third stop operations, the ┌attraction-in┘ is meant as follows: in case that a symbol constituting a combination of symbols corresponding to an internal winning combination is displayed in the active symbol display area together with the attraction-in target symbol corresponding to a stop operation of this time, the attraction-in target symbol is displayed in an active symbol display area connected by the activated line connecting the active symbol display areas.

Replay has the highest priority attraction-in ranking. MB has a priority ranking higher than the other internal winning combinations except Replay. Accordingly, in case that MB is carried over, when Replay has been determined as an internal winning combination, a combination of symbols corresponding to Replay is preferentially displayed along the activated line. On the other hand, in case that MB is carried over, when an internal winning combination except Replay has been determined, a combination of symbols corresponding to MB (i.e., MB1 and MB2) is preferentially displayed along the activated line.

In addition, Small Win of 10 pieces has a priority ranking higher than Bell, Small Win of Chance and RT. In addition, Bell, Small Win of Chance and RT have priority rankings higher than Watermelon. Further, Watermelon has a priority ranking higher than Cherry.

Herein, in the MB gaming state, it is allowed combinations of symbols corresponding to Cherry, Bell, Watermelon, Small Win of Chance, Small Win of 10 pieces and RT to be displayed along the activated line, irrespective of a type of an internal winning combination determined by the lottery, and the maximum number of sliding symbols corresponding to the left reel 3L is ┌1┘. Accordingly, in the MB gaming state, it becomes relatively more the cases where a combination of symbols to be displayed along the activated line is determined on the basis of only the timing at which the player carries out the stop operation, as compared to the other gaming states.

Accordingly, in the MB gaming state, an expert on the stop operation can display a combination of symbols desired along the activated line in a relatively high probability, as compared to a beginner who has an insufficient ability in the stop operation. Therefore, in the MB gaming state, the expert carries out the stop operation with the aim of displaying the combination of symbols corresponding to RT along the activated line, so that the expert can operate the RT section with relatively higher frequency, as compared to the beginner. As a result, there may occur a great difference between payouts to be awarded to the expert and the beginner.

With regard to this, in one embodiment, it is structured in such a way that the priority attraction-in ranking of RT (i.e., priority ranking ┌4┘) is lower than that of Small Win of 10 pieces (i.e., priority ranking ┌3┘) by the priority attraction-in ranking table. In other words, in the MB gaming state in which it is allowed the combinations of symbols corresponding to all Small Win including RT to be displayed along the activated line (i.e., flags of all Small Win become ON), irrespective of the random number value sampled, it is carried out a stop control for preferentially attracting-in another Small Win (i.e., Small Win of 10 pieces) different from RT.

As a result, in the MB gaming state, it is possible to prevent the combination of symbols corresponding to RT from being displayed along the activated line. Accordingly, it is possible to prevent a great difference between the payouts to be awarded to the players from occurring.

Herein, it is described an order for determining priority ranking data on the basis of the priority attraction-in ranking table. First, it is determined whether all bits, which constitute data of a logical product of attraction-in data corresponding to a priority ranking, data of the internal winning combination storing area and data of the display combination storing area, are ┌0┘ or not, in ascending power from the priority ranking ┌1┘. Whenever this determination is carried out, ┌1┘ is subtracted from the number of checks having an initial value set to be ┌6┘.

When it is determined that all the bits constituting the data of the logical product are not ┌0┘, a value having added ┌1┘ to the current number of checks is determined as priority ranking data. The number of checks is the maximum remaining number of the operations of determining whether all bits, which constitute data of a logical product of attraction-in data corresponding to a priority ranking, data of the internal winning combination storing area and data of the display combination storing area, are ┌0┘ or not.

In case that any one of the bits, which constitute data of a logical product of attraction-in data corresponding to a priority ranking, data of the internal winning combination storing area and data of the display combination storing area, is not ┌0┘, there is a bit of ┌1┘ commonly to the three data. In other words, it is possible to determine whether any one of the display combinations corresponding to the data of the display combination storing areas is included in an internal winning combination corresponding to the data of the internal winning combination storing areas and an internal winning combination corresponding to the attraction-in data.

In addition, in case that it is never determined that all the bits constituting the data of the logical product are not ┌0┘ until the number of checks becomes ┌0┘, a value having added ┌1┘ to the number of checks ┌0┘ (i.e., ┌1┘) is determined as the priority ranking data. In addition, in case that a determination result in a step S134 or S135, which will be described later in FIG. 25, is YES and thus it is never carried out the operation of determining whether all the bits constituting the data of the logical product are ┌0┘ or not, ┌0┘ is determined as the priority ranking data.

For example, in case that the data of the internal winning combination is ┌000010000┘ and the data of the display combination storing area is ┌000110000┘, it is first calculated a logical product of the attraction-in data ┌001000000┘ corresponding to the priority ranking ┌1┘, the data of the internal winning combination storing area and the data of the display combination storing area. The calculation result is ┌000000000┘, and ┌1┘ is subtracted from the number of checks having an initial value set to be ┌6┘. Accordingly, the number of checks becomes ┌5┘.

Next, it is calculated a logical product of the attraction-in data ┌110000000┘ corresponding to the priority ranking ┌2┘, the data of the internal winning combination storing area and the data of the display combination storing area. Since the calculation result is ┌000000000┘, ┌1┘ is subtracted from the number of checks. Accordingly, the number of checks becomes ┌4┘.

Subsequently, it is calculated a logical product of the attraction-in data ┌000010000┘ corresponding to the priority ranking ┌3┘, the data of the internal winning combination storing area and the data of the display combination storing area. Since all the bits are not ┌0┘ in the calculation result ┌000010000┘, a value having added ┌1┘ to the current number of checks ┌4┘, i.e., ┌5┘ (i.e., ┌00000101┘, which is a binary number of 8 bits) is determined as the priority ranking data. By doing so, the priority ranking data determined is stored in the upper 4 bits of expected display combination data, which will be described later.

In addition, the determination of the priority ranking data is also carried out for data of an internal winning combination storing area for stop and data of a pseudo display combination storing area, which will be described later, as well as the data of the internal winning combination storing area and the data of the display combination storing area. In this case, the priority ranking data determined is stored in the lower 4 bits of the expected display combination data, which will be described later.

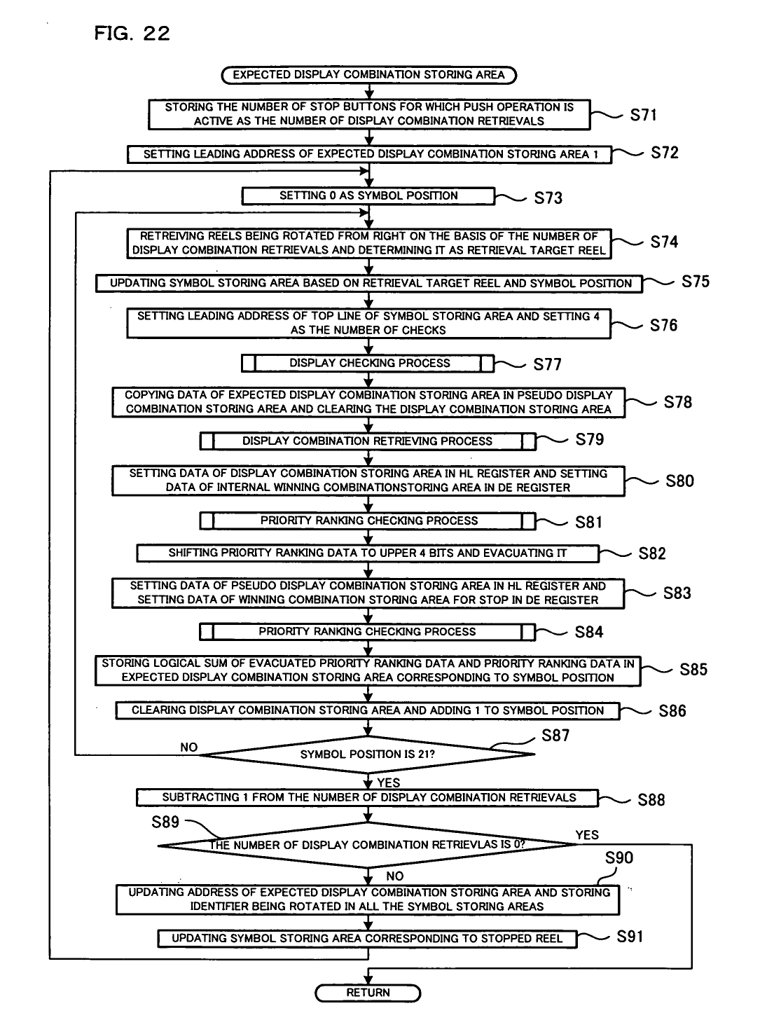

Additionally, as specifically described below with reference to FIG. 22, the data of the internal winning combination storing area and the internal winning combination storing area for stop is set in a DE register and the data of the display combination storing area and the pseudo display combination storing area which will be described later is set in a HL register. The above calculation of the logical product is carried out with reference to the data set in these registers. Herein, the DE register and the HL register are memory areas provided in the CPU 31.

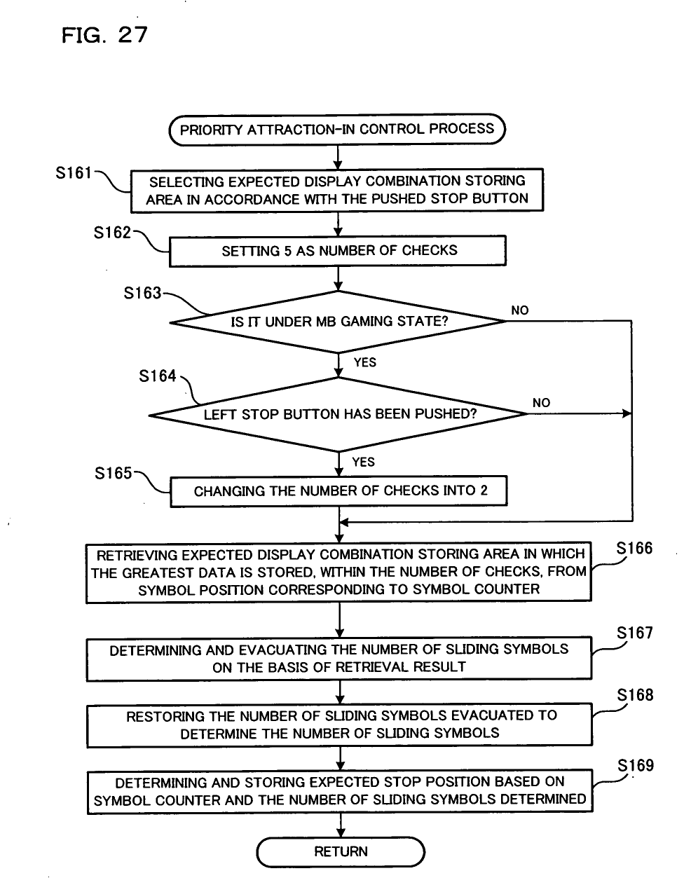

In the followings, it is described an expected display combination storing area which is referred when a process of determining the number of sliding symbols is carried out in a priority attraction-in control process (see FIG. 27), with reference to FIG. 16.

Herein, in one embodiment, before it is carried out a control for stopping the rotations of the reels 3L, 3C, 3R, it is carried out an expectation of a display combination which may be determined after the rotation of each of the reels 3L, 3C, 3R is stopped. Specifically, in an expected display combination storing process (see FIG. 22), on the assumption that with regard to each of symbol positions of the respective reels 3L, 3C, 3R, the rotations of the reels 3L, 3C, 3R are stopped at the corresponding symbol positions, it is determined (i.e., expected) a display combination corresponding to a combination of symbols to be displayed along each of the display lines 8a to 8e. The information about the display combination determined for each of the symbol display areas of the respective reels 3L, 3C, 3R is stored in an expected display combination storing area.

The expected display combination storing area consists of an expected display combination storing area 1, an expected display combination storing area 2 and an expected display combination storing area 3. The expected display combination storing area 1 corresponds to a reel located at the most left among the reels 3L, 3C, 3R being rotated. The expected display combination storing area 2 corresponds to a reel located at the second position from the left among the reels 3L, 3C, 3R being rotated. The expected display combination storing area 3 corresponds to a reel located at the third position from the left among the reels 3L, 3C, 3R being rotated.

In case that the rotations of the reels 3L, 3C, 3R are stopped at each of the symbol positions of the reels 3L, 3C, 3R corresponding to the corresponding expected display combination storing areas, each of the expected display combination storing areas stores information (i.e., data) of the display combination corresponding to a combination of symbols which may be displayed along each of the display lines 8a to 8e. This information is referred to as ┌expected display combination data┘. The expected display combination data consists of data of upper 4 bits and lower 4 bits.

The upper 4 bits of the expected combination data, in case that the rotations of the reels 3L, 3C, 3R are stopped at the symbol positions corresponding to the expected display combination data, stores the information representing a display combination corresponding to a combination of symbols which may be displayed along the center line 8c. The lower 4 bits of the expected combination data, in case that the rotations of the reels 3L, 3C, 3R are stopped at the symbol positions corresponding to the expected display combination data, stores the information representing a display combination (hereinafter, referred to as ┌pseudo display combination┘) corresponding to a combination of symbols which may be displayed along the display lines except the center line 8c (i.e., cross-up line 8a, top line 8b, bottom line 8d and cross-down line 8e).

Specifically, in case that a display combination corresponding to a combination of symbols which may be displayed along the center line 8c is Replay, ┌0111┘ is stored in the upper 4 bits of the expected display combination data. In case that a display combination corresponding to a combination of symbols which may be displayed along the center line 8c is MB1 or MB2, ┌0110┘ is stored in the upper 4 bits of the expected display combination data. In addition, in case that a display combination corresponding to a combination of symbols which may be displayed along the center line 8c is Small Win of 10 pieces, ┌0101 is stored in the upper 4 bits of the expected display combination data.

In addition, in case that a display combination corresponding to a combination of symbols which may be displayed along the center line 8c is Bell, Small Win of Chance or RT, ┌0100┘ is stored in the upper 4 bits of the expected display combination data. Additionally, in case that a display combination corresponding to a combination of symbols which may be displayed along the center line 8c is Watermelon, ┌0011┘ is stored in the upper 4 bits of the expected display combination data. In addition, in case that a display combination corresponding to a combination of symbols which may be displayed along the center line 8c is Cherry, ┌0010┘ is stored in the upper 4 bits of the expected display combination data.

In addition, in case that a display combination corresponding to a combination of symbols which may be displayed along the center line 8c is not matched to a payout to be awarded to a player (i.e., the display combination is the losing), ┌0001┘ is stored in the upper 4 bits of the expected display combination data. The data ┌0001┘ indicates that it is allowed the rotations of the reels 3L, 3C, 3R to be stopped at the symbol position corresponding to the data (i.e., stop possibility).

In addition, in case that a combination of symbols which may be displayed along the center line 8c is contradictory to a combination of symbols corresponding to an internal winning combination (for example, the internal winning combination is the losing, and a display combination corresponding to a combination of symbols which may be displayed along the center line 8c is Cherry), ┌0000┘ is stored in the upper 4 bits of the expected display combination data. The data ┌0000┘ indicates that it is prohibited the rotations of the reels 3L, 3C, 3R from being stopped at the symbol position corresponding to the data (i.e., stop prohibition).

Herein, the data to be stored in the upper 4 bits of the expected display combination data corresponds to the priority ranking of the attraction-in (i.e., priority ranking of the attraction-in defined in a priority attraction-in ranking table (see FIG. 15) as well as the display combination corresponding to the combination of symbols which may be displayed along the center line 8c. Specifically, the greater the data to be stored in the upper 4 bits of the expected display combination data, the higher the priority ranking of the attraction-in corresponding to the data. For example, the data, which is stored in the upper 4 bits of the expected display combination data, correspondingly to Replay having the highest priority ranking (i.e., priority ranking is ┌1┘), is ┌0110┘, and higher than any other data to be stored in the upper 4 bits.

In addition, a corresponding relationship of a display combination corresponding to a combination of symbols, which may be displayed along the display lines except the center line 8c, and data, which is stored in the lower 4 bits of the expected display combination data correspondingly to the corresponding display combination, is as shown in FIG. 16. In addition, for convenience sake of explanations, the expected display combination data are classified into the upper 4 bits and the lower 4 bits, as shown in FIG. 16. However, in fact, the expected display combination data of 8 bits consisting of upper 4 bits and lower 4 bits is stored in the expected display combination storing area.

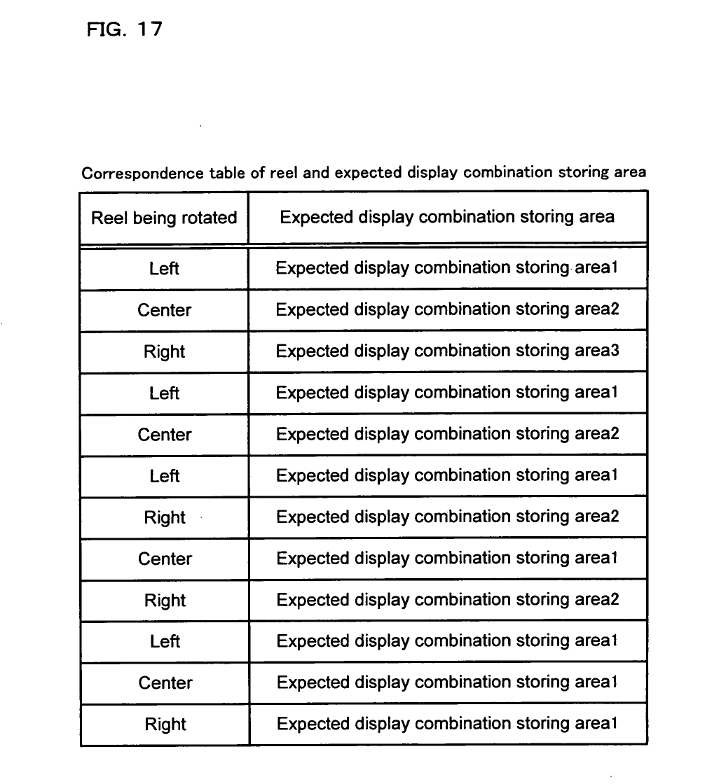

In the followings, it is described a corresponding relationship of the respective reels 3L, 3C, 3R being rotated and the expected display combination storing areas, with reference to FIG. 17 showing a correspondence table of a reel and an expected display combination storing area.

In case that the left reel 3L, the center reel 3C and the right reel 3R are being rotated, the left reel 3L corresponds to an expected display combination storing area 1, the center reel 3C corresponds to an expected display combination storing area 2 and the right reel 3R corresponds to an expected display combination storing area 3. In case that the left reel 3L and the center reel 3C only are being rotated, the left reel 3L corresponds to an expected display combination storing area 1 and the center reel 3C corresponds to an expected display combination storing area 2. In case that the left reel 3L and the right reel 3R only are being rotated, the left reel 3L corresponds to an expected display combination storing area 1 and the right reel 3R corresponds to an expected display combination storing area 2.

In case that the center reel 3C and the right reel 3R only are being rotated, the center reel 3C corresponds to an expected display combination storing area 1 and the right reel 3R corresponds to an expected display combination storing area 2. In case that the left reel 3L only is being rotated, the left reel 3L corresponds to an expected display combination storing area 1. In case that the center reel 3C only is being rotated, the center reel 3C corresponds to an expected display combination storing area 1. In case that the right reel 3R only is being rotated, the right reel 3R corresponds to an expected display combination storing area 1.

In the followings, a control operation of the main control circuit 71 is described with reference to FIGS. 18 to 30.

First, a main flow chart under control of a main CPU (i.e., main control circuit 71) is described with reference to FIG. 18.

The CPU 31 carries out an initializing process (step S1). Specifically, the CPU initializes memory contents of the RAM 33. Subsequently, the CPU erases (i.e., clears) an indicated storing area (for example, information of the internal winning combination storing area) of the RAM 33 when a game is over (step S2), and proceeds to a step S3. More specifically, the CPU erases the data of a predetermined area of the RAM 33 used for a previous game.

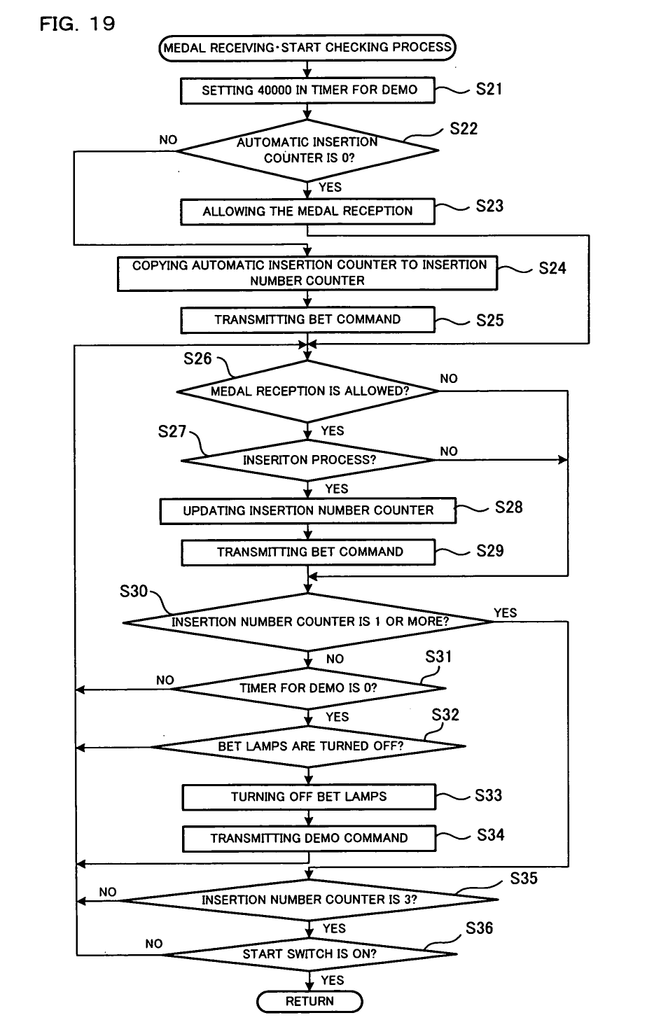

In the step S3, the CPU carries out a medal receiving•start-checking process, which will be described with reference to FIG. 19, and then proceeds to a step S4. In this process, the CPU updates the insertion number and transmits a demo command, which will be described later, on the basis of the inputs from the start switch 6S, the medal sensor 10S or the BET switches 11 to 13. In the step S4, the CPU samples and stores a random number value in the random number value storing area, and proceeds to a step S5. The random number value sampled in this process is used for an internal lottery process (see FIG. 20).

In the step S5, the CPU carries out a gaming status supervisory process and proceeds to a step S6. In the gaming status supervisory process, if the flag under MB operation is ON, the CPU stores an identifier (information) representing the MB gaming state in a predetermined storing area of the RAM 33. In addition, if the flag under MB operation is OFF, the CPU stores an identifier representing the normal gaming state in a predetermined storing area of the RAM 33.

Herein, the identifier representing the MB gaming state is cleared through the process in the step S2 every game. If the flag under MB operation is ON, the identifier representing the MB gaming state is stored in the predetermined storing area of the RMA 33 through the gaming state supervisory process, without fail. Accordingly, the MB gaming state is equivalent to a period during which the identifier representing the MB gaming state is stored in the predetermined storing area of the RAM 33 every game (i.e., a period during which the flag under MB operation is ON).

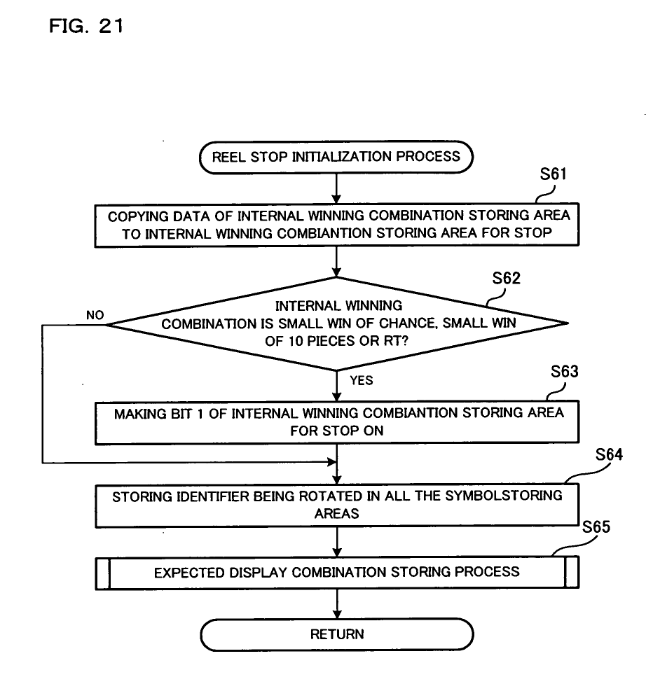

In the step S6, the CPU carries out an internal lottery process, which will be described with reference to FIG. 20 and proceeds to a step S7. In the step S7, the CPU performs a reel stop initialization process, which will be described with reference to FIG. 21 and proceeds to a step S8.

In the step S8, the CPU updates a carries out a RT game number counter update process and proceeds to a step S9. Specifically, the CPU determines whether a value of the RT game number counter is ┌0┘ or not. If it is determined that a value of the RT game number counter is not ┌0┘, the CPU subtracts ┌1┘ from the value of the RT game number counter. In addition, the CPU determines whether the value of the RT game number counter as a result of the subtraction becomes ┌0┘ or not. If it is determined that a value of the RT game number counter is ┌0┘, the CPU updates the flag under RT1 operation and the flag under RT2 operation to OFF (i.e., clear).

The RT game number counter is information for discriminating the remaining number of games in the RT section. In addition, it can be said that the remaining number of games in the RT section which can be discriminated by the RT game number counter is equivalent to the number of games which have been played in the RT section (i.e., the remaining number of games in the RT section is same as a value obtained by subtracting the number of games which have been played in the RT section from ┌1000┘).

In the step S9, the CPU transmits a start command to the sub-control circuit 72 and proceeds to a step S10. The start command includes information of gaming state, internal winning combination and the like and is transmitted to the sub-control circuit 72. In the step S10, the CPU determines whether 4.1 seconds have lapsed after the previous reel has started to rotate. If a result of the determination is YES, the CPU proceeds to a step S12, otherwise proceeds to a step S11.

In the step S11, the CPU consumes a game start waiting time (i.e., waits) and then proceeds to a step S12. Specifically, the CPU annuls an input in accordance with a game start operation by a player during a period from after the previous game has started until a predetermined time (for example, 4.1 seconds) has lapsed. In the step S12, the CPU requests that all the reels start to rotate, and proceeds to a step S13. Specifically, the CPU updates all of three active stop button flags corresponding to each of the stop buttons 7L, 7C, 7R to ON.

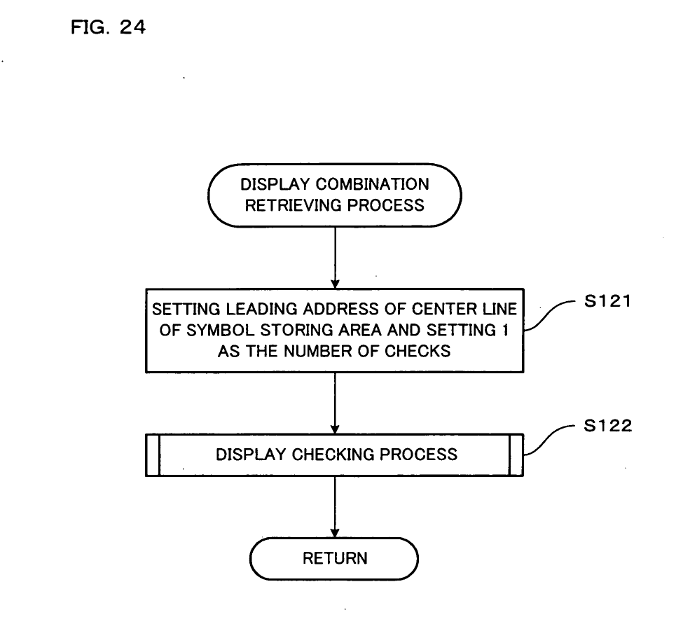

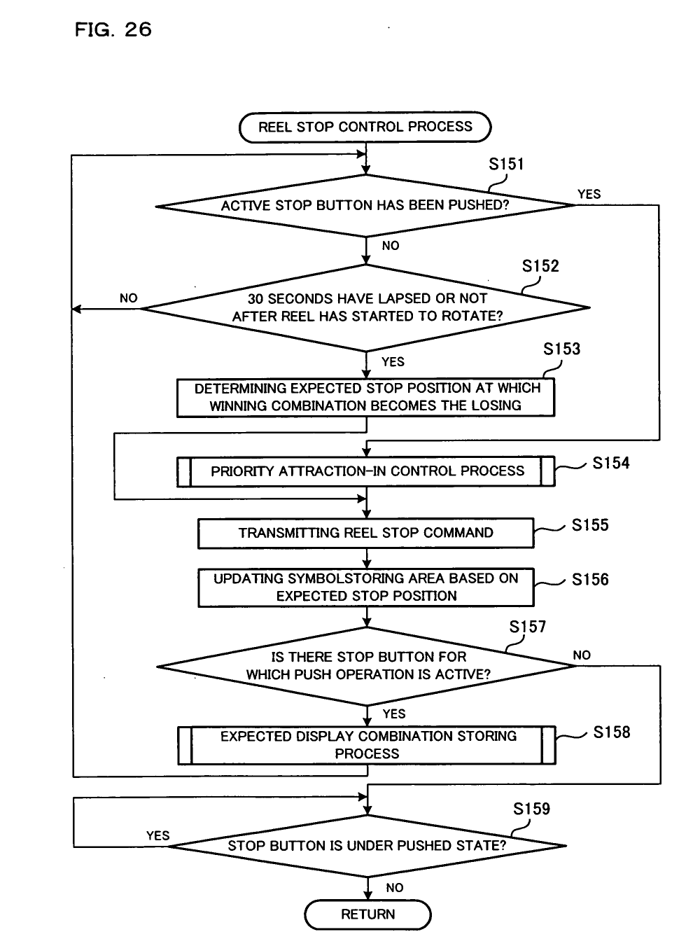

In the step S13, the CPU carries out a reel stop control process which will be described with reference to FIG. 26 and then proceeds to a step S14. In the step S14, the CPU performs a display combination retrieving process which will be described with reference to FIG. 24 and then proceeds to a step S15. Specifically, the CPU determines a display combination and a payout number based on the combination of symbols displayed in the display windows 21L, 21C, 21R and the symbol combination table (see FIG. 10). In the step S15, the CPU transmits a display combination command to the sub-control circuit 72 and proceeds to a step S16. The display combination command includes the information of the display combination determined in the step S14.

In the step S16, the CPU carries out a medal payout process of paying out medals equal to the value of the payout number counter and proceeds to a step S17. In the step S17, the CPU updates the bonus end number counter based on the payout number and proceeds to a step S18. Specifically, when the bonus end number counter is 1 or more, the CPU subtracts the number equal to the number of medals paid out in the step S16 from the counter. In the step S18, the CPU determines whether the flag under MB operation is ON or not. If a result of the determination is YES, the CPU proceeds to a step S19, otherwise, proceeds to a step S20.

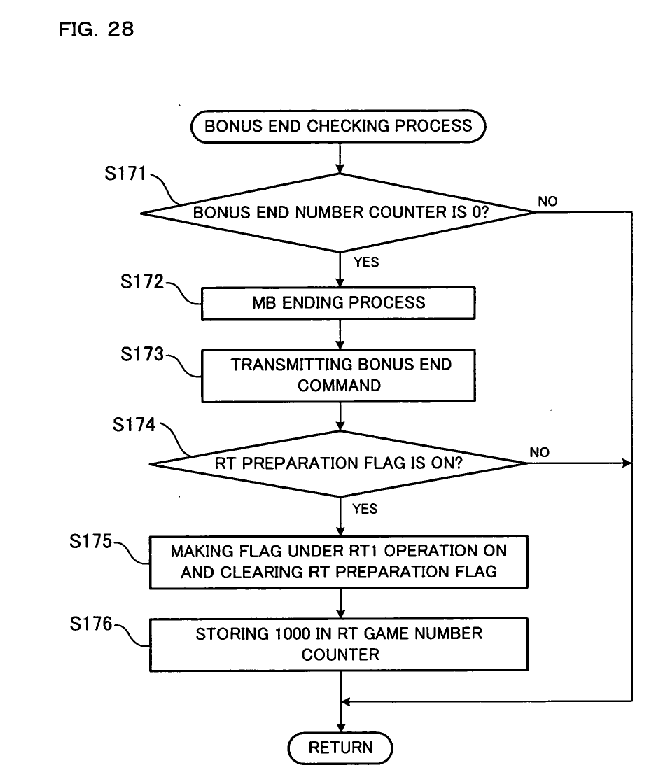

In the step S19, the CPU carries out a bonus end checking process which will be described with reference to FIG. 28 and proceeds to a step S20. In the step S20, the CPU carries out a bonus operation checking process which will be described with reference to FIG. 29 and proceeds to the step S2.

In the followings, it is described a medal receiving•start checking process for detecting an insertion operation and a start operation by a player, with reference to FIG. 19.

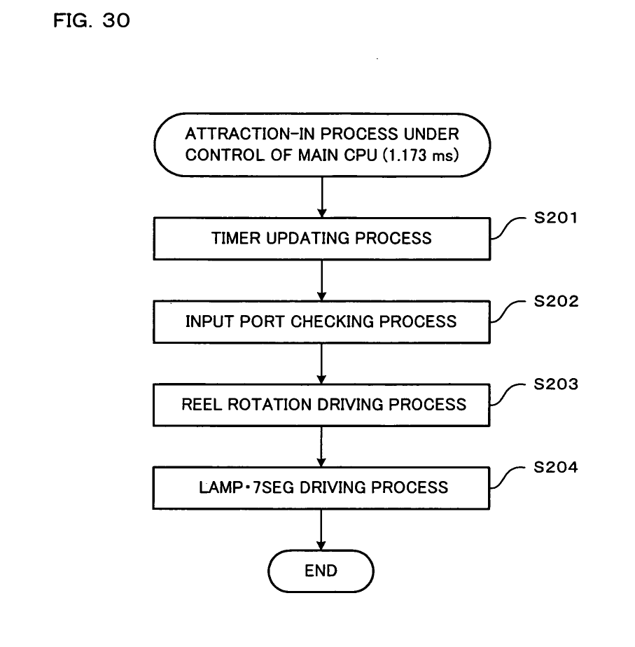

First, the CPU 31 sets ┌40000┘ as an initial value in a timer for demo stored in the RAM 33 and proceeds to a step S22 (step S21). Because the value set in the timer for demo is subtracted by 1 every 1.1173 ms in an intervention process under control of the main CPU (see FIG. 30), it becomes ┌0┘ after about 45 seconds since the initial value is set in the timer. In the step S22, the CPU determines whether an automatic insertion counter is ┌0┘. If a result of the determination is YES, the CPU proceeds to a step S23, otherwise proceeds to a step S24. The automatic insertion counter is a counter for counting the number of medals which are automatically inserted, when the display combination is Replay.

In the step S23, the CPU allows the medal reception and proceeds to a step S26. In the step S23, since the display combination in the previous game is not Replay, the value of the automatic insertion counter is 0. Accordingly, the CPU allows an addition of an insertion number counter, thereby allowing a medal to be inserted. The insertion number counter is a counter for counting an insertion number.

In the step S24, the CPU copies the automatic insertion counter to the insertion number counter and proceeds to a step S25. In the step S24, specifically, the combination of symbols corresponding to Replay in the previous game is displayed along the activated line, so that the value of the automatic insertion counter becomes another value except ┌0┘ (i.e., ┌3┘). Accordingly, the CPU updates the value of the insertion number counter to a value same (i.e., ┌3┘) as that of the automatic insertion counter. In the step S25, the CPU transmits a BET command to the sub-control circuit 72 and proceeds to a step S26. The BET command includes information about the value (i.e., insertion number) of the insertion number counter updated in the step S24.

In the step S26, the CPU determines whether the medal reception is allowed. If a result of the determination is YES, the CPU proceeds to a step S27, otherwise proceeds to a step S30. Specifically, if the medal reception has been allowed through the process in the step S23, i.e., if an addition of the insertion number counter has been allowed, a result of the determination becomes YES. In addition, if the CPU has not passed through the process in the step S23 and thus an addition of the insertion number counter has not been allowed, a result of the determination becomes NO.

In the step S27, the CPU determines whether it is under insertion process. If a result of the determination is YES, the CPU proceeds to a step S28, otherwise proceeds to a step S30. Specifically, the CPU checks whether there is an input from the medal sensor 10S. If it is determined that there is an input from the medal sensor 10S, a result of the determination in the step S27 becomes YES. In addition, the CPU checks whether there is an input from the BET switches 11 to 13. If it is determined that there is an input from the BET switches 11 to 13, it is calculated a value to be added to the insertion number counter and a result of the determination in the step S27 becomes YES. In addition, if it is determined that there is no input from the medal sensor 10S or any one of the BET switches 11 to 13, a result of the determination becomes NO.

In the step S28, the CPU updates the insertion number counter and proceeds to a step S29. Specifically, if it is determined that there has been an input from the medal sensor 10S in the step S27, ┌1┘ is added to the insertion number counter. In addition, it is determined that there has been an input from the BET switches 11 to 13 in the step S27, the value calculated in the step S27 is added to the insertion number. In addition, in case that the value of the insertion number counter is ┌3┘, a credit counter is added instead of the insertion number counter. The credit counter is a counter for counting the number of medals credited.

In the step S29, the CPU transmits the BET command to the sub-control circuit 72 and proceeds to a step S30. The BET command includes information about the value (i.e., insertion number) of the insertion number counter updated in the step S28. In the step S30, the CPU determines whether the insertion number counter is ┌1┘ or more, i.e., whether the insertion number is ┌1┘ or more. If a result of the determination is YES, the CPU proceeds to a step S35, otherwise proceeds to a step S31.

In the step S31, the CPU determines whether the timer for demo is ┌0┘ or not. In other words, it determines whether a state that an operation by the player (for example, insertion operation, etc.) is not carried out (hereinafter, referred to as ┌non-gaming state┘) has been continued for a predetermined time (about 45 seconds). If a result of the determination is YES, the CPU proceeds to a step S32, otherwise proceeds to the step S26. In the step S32, the CPU determines whether the BET lamps 17a to 17c indicating the insertion number are turned off or not. If a result of the determination is YES, the CPU proceeds to the step S26, otherwise proceeds to a step S33. In the step S33, the CPU turns off the BET lamps and proceeds to a step S34.

In one embodiment, basically, the BET lamps 17a to 17c are always turned on. However, in case that the CPU transmits a demo command in a process of step S34 which will be described later, the BET lamps 17a to 17c are turned off. Accordingly, in case that the non-gaming state has been continued after the CPU has transmitted the demo command once, a result of the determination in the step S32 is YES, and the CPU does not pass through the step S34 and will never transmit the demo command. By doing so, even though the non-gaming state has been continued after the CPU has once transmitted the demo command, the transmission of the demo command is not repeated.

In the step S34, the CPU transmits the demo command to the sub-control circuit 72 and proceeds to the step S26. The demo command is transmitted, so that a demonstration image (i.e., demo image) notifying a player that the gaming machine is under waiting state is displayed. In the step S35, the CPU determines whether a value of the insertion number counter is ┌3┘ or not. If it is determined that the value of the insertion number counter is ┌3┘ in the step S35, i.e., if the value reaches the insertion number ┌3┘ required to play a one game, a result of the determination becomes YES. If the value of the insertion number counter is another value except ┌3┘, a result of the determination becomes NO.

In the step S36, the CPU determines whether the start switch is ON or not. Specifically, it determines whether the start switch is ON, i.e., whether there has been an input from the start switch 6S in accordance with the operation of the start lever 6. If a result of the determination is YES, the CPU proceeds to the step S4 of FIG. 18, otherwise proceeds to the step S26.

In the followings, it is described an internal lottery process for determining an internal winning combination based on the gaming state and the like, with reference to FIG. 20.

First, the CPU 31 determines a type of an internal lottery table and the number of lotteries in accordance with the gaming state, based on the internal lottery table determining table (FIG. 7) (step S41) and proceeds to a step S42. In the step S42, the CPU determines whether the RT game number counter is ┌1┘ or more. If a result of the determination is YES, the CPU proceeds to a step S43, otherwise proceeds to a step S44. In the step S43, the CPU changes the internal lottery table into an internal lottery table (not shown) for the RT section because it is under RT section, and proceeds to a step S44.

In the step S44, the CPU determines whether the flag of MB1 or MB2 is stored in the internal carryover combination storing area, i.e., whether ┌1┘ is stored in the bit 8 (ninth bit) or bit 7 (eighth bit) corresponding to MB1 or MB2 of the internal carryover combination storing area (i.e., whether there is an internal carryover combination or not). If a result of the determination is YES, the CPU proceeds to a step S45, otherwise proceeds to a step S46. Herein, in case of the carryover section, the result of the determination in the step S44 becomes YES. In the step S45, the CPU changes the number of lotteries into ┌7┘, and proceeds to the step S46. In the step S46, the CPU sets a value same as the number of lotteries, as a winning number, and proceeds to a step S47.

In the step S47, the CPU compares the random number value stored in the random number value storing area with the upper and lowest limits related to the winning number, and proceeds to a step S48. Specifically, the CPU refers to the internal lottery table determined in the step S41 to obtain the lowest limit (L) based on the number of lotteries and the insertion number, and subtracts the lowest limit (L) from the random number value ® stored in the random number value storing area of the RAM 33 (i.e., R-L). In addition, the CPU refers to the internal lottery table determined in the step S41 to obtain the upper limit (U) based on the number of lotteries, and subtracts the upper limit (U) from the random number value ® stored in the random number value storing area of the RAM 33 (i.e., R-U).

In the step S48, the CPU determines whether the random number value is between the lowest limit and the upper limit. Specifically, it determines whether the value (R-L) obtained in the step S47 is positive or not, and whether the value (R-U) obtained in the step S47 is negative or not. If a result of the determination is YES, the CPU proceeds to a step S49, otherwise proceeds to a step S54. In the step S49, the CPU refers to the internal winning combination determining table to specify an internal winning combination based on the winning number and proceeds to a step S50.

In the step S50, the CPU determines whether the internal winning combination determined in the step S49 is MB1 or MB2. If a result of the determination is YES, the CPU proceeds to a step S51, otherwise proceeds to a step S53. In the step S51, the CPU stores the flag in the internal carryover combination storing area based on the internal winning combination and proceeds to a step S52. Herein, in the determination, in case that MB1 is included in the internal winning combination, the CPU stores ┌100000000┘ in the internal carryover combination storing area. In case that MB2 is included in the internal winning combination, the CPU stores ┌010000000┘ in the internal carryover combination storing area.

In the step S52, since MB1 or MB2 has been determined as the internal winning combination, the CPU updates (clears) the value of the RT game number counter to ┌0┘ and proceeds to a step S53. In the step S53, the CPU stores a logical sum of an internal winning combination corresponding to the internal winning combination determined in the step S49 and the internal carryover combination storing area in the internal winning combination storing area, and proceeds to a step S54. In the step S54, the CPU subtracts 1 from the number of lotteries and proceeds to a step S55.

In the step S55, the CPU determines whether the number of lotteries is ┌0┘ or not. If a result of the determination is YES, the CPU proceeds to a step S56, otherwise proceeds to the step S46. Herein, in case that the number of operations of determining whether the random number value ® is included within a range defined by the upper limit (U) and the lowest limit (L) is 9 times in the normal gaming state and 7 times in the internal winning state (i.e., carryover section), the result of the determination becomes YES. On the other hand, in case that the number of determinations is under 9 times in the normal gaming state and under 7 times in the internal winning state (i.e., carryover section), the result of the determination becomes NO.

In the step S56, the CPU stores a logical sum of information representing the internal winning combination and the internal carryover combination storing area in the internal winning combination storing area, and proceeds to a step S57. Herein, in case that the internal winning combination is the losing, the CPU does not carry out the process in the step S53. Accordingly, even though there is an internal carryover combination, the bit corresponding to the internal carryover combination of the internal winning combination storing area becomes not ┌1┘ by the process in the step S53. Therefore, in the step S53, in consideration of the case that the internal winning combination is the losing when there is an internal carryover combination, the CPU stores a logical sum of information representing the internal winning combination and the internal carryover combination storing area in the internal winning combination storing area.

In the step S57, the CPU determines whether it is under MB gaming state, i.e., whether the flag under MB operation is ON or not. If a result of the determination is YES, the CPU proceeds to a step S58, otherwise proceeds to the step S7 in FIG. 18. In the step S57, since it is under MB gaming state, the CPU makes all the bits 0˜5 of the internal winning combination storing area ON (i.e., stores ┌000011111┘ in the internal winning combination storing area), and proceed to the step S7 in FIG. 18.

In the followings, it is described a reel stop initialization process for carrying out the first setting with regard to a process for stopping the rotations of the reels 3L, 3C, 3R, with reference to FIG. 21.

First, the CPU 31 copies the data of the internal winning combination storing area to the internal winning combination storing area for stop (step S61), and proceeds to a step S62. Specifically, the CPU stores the data, which has been stored in the internal winning combination storing area through the internal lottery process (see FIG. 20), in the internal winning combination storing area for stop. The internal winning combination storing area for stop is a memory area of 9 bits provided in the RAM 33 and has the same data structure as the internal winning combination storing area.

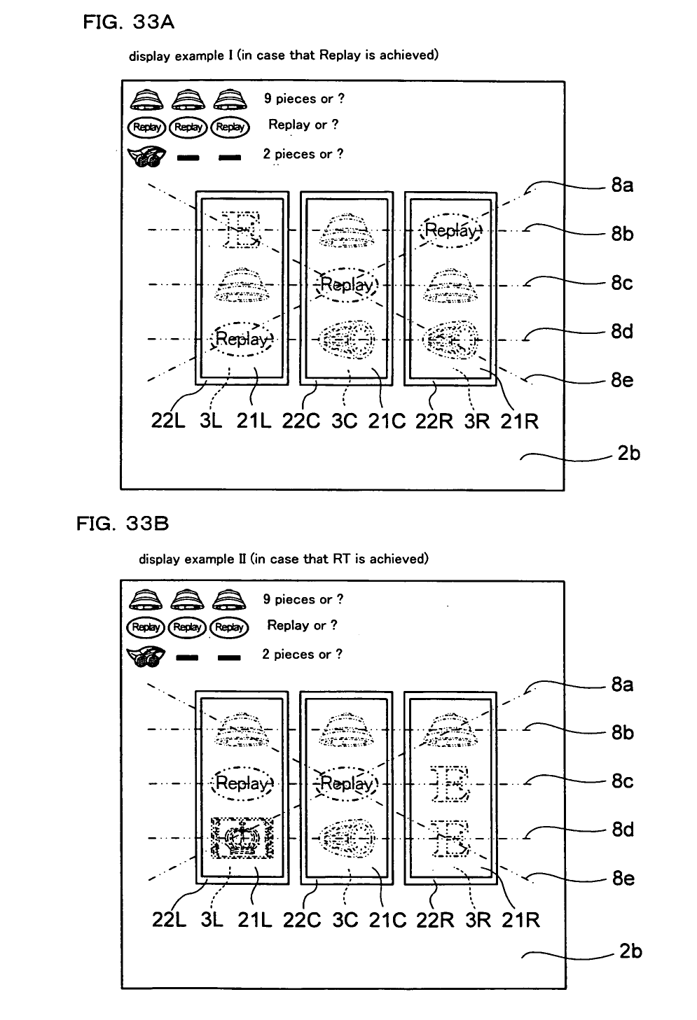

In the step S62, the CPU determines whether the internal winning combination is Small Win of Chance, Small Win of 10 pieces or RT, i.e., whether the bit 3, 4 or 5 of the internal winning combination storing area is ┌1┘ or not. If a result of the determination is YES, the CPU proceeds to a step S63, otherwise proceeds to a step S64. In the step S63, the CPU makes the bit 1 of the internal winning combination storing area for stop ON, and proceeds to the step S64. Specifically, the CPU stores ┌1┘ in the bit 1 corresponding to Bell of the internal winning combination storing area for stop. Herein, by storing ┌1┘ in the bit 1 corresponding to Bell of the internal winning combination storing area for stop, it is possible to achieve the stop mode shown in FIG. 33A (which will be specifically described later).

In the step S64, the CPU stores the identifier being rotated in all the symbol storing areas and proceeds to a step S65. Specifically, the CPU updates all the identifiers stored in the symbol storing areas to ┌11111111┘. In the step S65, the CPU carries out an expected display combination storing process which will be described with reference to FIG. 22, and proceeds to the step S8 in FIG. 18.

In the followings, with reference to FIG. 22, it is described an expected display combination storing process for expecting a display combination corresponding to a combination of symbols, with regard to each symbol position of the respective reels 3L, 3C, 3R, before carrying out a control for stopping the rotations of the reels 3L, 3C, 3R, wherein the reels 3L, 3C, 3R are stopped at the corresponding symbol positions and thus the above symbols are displayed.

First, the CPU 31 stores the number of stop buttons for which the push operation is active, as the number of display combination retrievals, and proceeds to a step S72 (step S71). Specifically, the CPU stores the information representing the number of the stop buttons 7L, 7C, 7R corresponding to the reels 3L, 3C, 3R being rotated in the RAM 33 as the number of display combination retrievals. In addition, in case that the expected display combination storing process has been carried out in the reel stop initialization process (see FIG. 21), since the reels 3L, 3C, 3R has not started to rotate yet, the number of the stop buttons 7L, 7C, 7R corresponding to the reels 3L, 3C, 3R being rotated is ┌0┘. In this case, ┌3┘ is pseudo-stored in the RAM 33 as the number of display combination retrievals.

In the step S72, the CPU sets a leading address of the display combination storing area 1, and proceeds to a step S73. In the step S73, the CPU sets ┌0┘ as a symbol position in a predetermined memory area of the CPU 31, and proceeds to a step S74. In the step S74, based on the number of display combination retrievals, the CPU retrieves the reels being rotated from the right side to determine a retrieval target reel, and proceeds to a step S75.

Specifically, the CPU retrieves the reels being rotated from the right side as the number of display combination retrievals and determines the reel, which has been retrieved last, as the retrieval target reel. In other words, the reel which is located nearer at the left side among the reels 3L, 3C, 3R being rotated is determined as the retrieval target reel. For example, in case that the number of display combination retrievals is 3, the reel retrieval is carried out in order of the right reel 3R, the center reel 3C and the left reel 3L, and the left reel 3L is determined as the retrieval target reel.

In the step S75, based on the retrieval target reel and the symbol position, the CPU updates the symbol storing area and proceeds to a step S76. Specifically, on the assumption that the retrieval target reel has been stopped at the current symbol position, with regard to each of the symbol display areas corresponding to the retrieval target reel, the CPU stores identifiers corresponding to types of the symbols located in the corresponding symbol display area in the symbol storing area.

In the step S76, the CPU sets a leading address of the top line of the symbol storing area, sets ┌4┘ as the number of checks, and proceeds to a step S77. In a display checking process (see FIG. 23), the number of checks is the remaining number of operations of carrying out a process in a step S102 of FIG. 23 which will be described later. In the step S77, the CPU carries out a display checking process which will be described with reference to FIG. 23, and proceeds to a step S78.

In the step S78, the CPU copies the data of the display combination storing area to the pseudo display combination storing area, clears the display combination storing area and proceeds to a step S79. Specifically, the CPU stores the data, which has been stored in the display combination storing area through the process in the step S77, in the pseudo display combination storing area and stores ┌0┘ in all the bits of the display combination storing area. The pseudo display combination storing area is a memory area of 9 bits provided in the RAM 33 and has the same data structure as the display combination storing area.

In the step S79, the CPU carries out a display combination retrieving process which will be described with reference to FIG. 24, and proceeds to a step S80. In the step S80, the CPU sets the data of the display combination storing area in the HL register, sets the data of the internal winning combination storing area in the DE register, and proceeds to a step S81. Specifically, the CPU sets the data, which has been stored in the display combination storing area in a display combination retrieving process (see FIG. 24), in the HL register, and sets the data of the internal winning combination storing area, which has been stored in the internal lottery process (see FIG. 20), in the DE register.

In the step S81, the CPU carries out a priority ranking checking process which will be described with reference to FIG. 25, and proceeds to a step S82. In the step S82, the CPU shits and evacuates the priority ranking data to the upper 4 bits, and proceeds to a step S83. Specifically, the CPU repeats 4 times a process of doubling a value of the priority ranking data set in the step S81. Accordingly, the value of the priority ranking data becomes 16 times as compared to the value before the process in the step S81 is carried out, and the bit pattern of the priority ranking data expressed by the binary number is shifted as the upper 4 bits.

In the step S83, the CPU sets the data of the pseudo display combination storing area in the HL register, sets the data of the internal winning combination storing area for stop in the DE register, and proceeds to a step S84. Specifically, the CPU sets the data, which has been stored in the pseudo display combination storing area in the step S78, in the HL register, and sets the data, which has been stored in the internal winning combination storing area for stop in a reel stop initialization process (see FIG. 21), in the DE register.

In the step S84, the CPU carries put a priority ranking checking process which will be described with reference to FIG. 25, and proceeds to a step S85. In the step S85, the CPU stores a logical sum of the evacuated priority ranking data and the priority ranking data in the expected display combination storing area corresponding to the symbol position, and proceeds to a step S86. Specifically, the CPU stores the data of the logical sum of the priority ranking data shifted as the upper 4 bits in the step S83 and the priority ranking data determined in the step S84 in an area of the expected display combination storing areas corresponding to current symbol position, as expected display combination data.

In the step S86, the CPU clears the display combination storing area, adds ┌1┘ to the value of the symbol position set in the predetermined memory area of the CPU 31, and proceeds to a step S87. In the step S87, the CPU determines whether the value of the symbol position is ┌21┘ or not. If a result of the determination is YES, the CPU proceeds to a step S88, otherwise proceeds to the step S74. In the step S88, the CPU subtracts ┌1┘ from the number of display combination retrievals stored in the RAM 33, and proceeds to a step S89.

In the step S89, the CPU determines whether the number of display combination retrievals is ┌0┘ or not. When a result of the determination is YES, if the expected display combination storing process has been carried out as the process in the step S65 of FIG. 21, the CPU proceeds to the step S8 in FIG. 18, and if the expected display combination storing process has been carried out as a process in a step S158 of FIG. 26 which will be described later, the CPU proceeds to a step S151 in FIG. 26. When a result of the determination is NO, the CPU proceeds to a step S90.

In the step S90, the CPU updates the address of the expected display combination storing area, stores identifiers being rotated in all the symbol storing areas, and proceeds to a step S91. Specifically, in case that the address of the expected display combination storing area 1 has been set, the CPU sets a leading address of the expected display combination storing area 2. In case that the address of the expected display combination storing area 2 has been set, the CPU sets an address of the expected display combination storing area 3. Next, the CPU updates all the identifiers stored in the symbol storing areas to ┌11111111┘.

In the step S91, the CPU updates the symbol storing area corresponding to the reel being stopped and proceeds to the step S73. Specifically, with regard to each of the symbol display areas corresponding to the reel being stopped, the CPU stores an identifier corresponding to a type of the symbol located in the corresponding symbol display area in the symbol storing area.

In the followings, it is described a display checking process for expecting or determining a display combination on the basis of a symbol storing area and a symbol combination table, with reference to FIG. 23.

First, the CPU 31 sets a leading address of the symbol combination table stored in the RAM 33 (step S101) and proceeds to a step S102. The address of the symbol combination table, which has been set in the step S101, is updated in a step S107, which will be described later. A process in the step S107 is repeated, so that the process in the step S102 is carried out for information about all combinations of symbols stored in the symbol combination table.

In the step S102, the CPU carries out a comparison with a combination of symbols stored in the symbol storing area, and proceeds to a step S103. Specifically, the CPU compares information about a combination of symbols, which are stored in an area corresponding to the display line corresponding to the current number of checks among the symbol storing areas, with information about a combination of symbols, which are stored in an area corresponding to the current address of the symbol combination table.

Herein, when the display checking process is carried out as the process in the step S77 in FIG. 22, if the number of checks is ┌4┘, the display line corresponding to the corresponding value is the top line 8b. In addition, in case that the number of checks is ┌3┘, the display line corresponding to the corresponding value is the bottom line 8d. In addition, in case that the number of checks is ┌2┘, the display line corresponding to the corresponding value is the cross-down line 8e. In addition, in case that the number of checks is ┌1┘, the display line corresponding to the corresponding value is the cross-up line 8a.

In the mean time, in case that ┌4┘ has been set as the number of checks in the step S76 of FIG. 22, the number of checks is subtracted by ┌1┘ in a step S109 which will be described later. The step S109 is repeated, so that the process in the step S102 is carried out for all the display lines except the center line 8c. In addition, when the display checking process is carried out as the process in a step S122 which will be described later, if the number of checks is ┌1┘, the display line corresponding to the corresponding value is the center line 8c.

In the step S103, the CPU determines whether they are identical, except the symbol storing area in which the identifier being rotated is stored. Specifically, the CPU determines whether the information about the combination information of three symbols in the symbol storing area, which has been compared in the step S102, is identical to the information of a combination of symbols stored in the symbol combination table, except the information of the identifier being rotated (i.e., ┌11111111┘). If a result of the determination is YES, the CPU proceeds to a step S104, otherwise proceeds to a step S107.

In the step S104, the CPU determines a display combination, stores a logical sum of the display combination determined and the display combination storing area in the display combination storing area, and proceeds to a step S105. Specifically, based on the information of the combination of three symbols in the symbol storing area, which have been compared in the process of the step S103, the CPU determines a display combination corresponding to the corresponding combination of the symbols, and stores a logical sum of the information (i.e., data) of the corresponding display combination and the display combination storing area in the display combination storing area.

Herein, in case that the display checking process has been carried out in the display combination retrieving process of the step S14 in FIG. 18 (i.e., in case that it is called after all the reels 3L, 3C, 3R have been stopped), a payout corresponding to the display combination determined in the step S105 is awarded to a player. For example, in order to pay out the number of medals corresponding to the display combination determined in the step S105, a process of a step S106 is carried out, which will be described.

In addition, in case that the display combination checking process has been carried out in the expected display combination storing process (see FIG. 22) (i.e., in case that there are the reels 3L, 3C, 3R being rotated), the display combination determined in the step S105 is expected as a display combination which may be determined after the rotations of the reels 3L, 3C, 3R are stopped.

In the step S105, the CPU determines whether the number of stop buttons for which a push operation is active is ┌0┘ or not, i.e., whether the number of display combination retrievals is ┌0┘ or not. In case that the display checking process has been carried out as the process of the step S14 in FIG. 18 (i.e., in case that it has been carried out after the rotations of all the reels 3L, 3C, 3R have been stopped), since the number of stop buttons for which the push operation is active is ┌0┘, a result of the determination becomes YES and the CPU proceeds to a step S106. In case that the process in the step S105 is called in another process except the process in the step S14 of FIG. 18, a result of the determination becomes NO and the CPU proceeds to a step S107.

In the step S106, the CPU updates the payout number counter and proceeds to a step S107. Specifically, the CPU stores a value of the payout number corresponding to the display combination determined in the step S104 based on the symbol combination table (see FIG. 9) in the payout number counter. The payout number counter is information for discriminating the number of medals to be paid out through the medal payout process in the step S16 of FIG. 18.

In. the step S107, the CPU updates the address of the symbol combination table and proceeds to a step S108. In the step S108, the CPU determines whether the combinations of all the symbols have been checked, i.e., whether the process in the step S102 has been carried out for the combinations of all the symbols stored in the symbol combination table. If a result of the determination is YES, the CPU proceeds to a step S109, otherwise proceeds to the step S102.

In the step S109, the CPU subtracts 1 from the number of checks and proceeds to a step S110. In the step S110, the CPU determines whether the number of checks is ┌0┘ or not. If a result of the determination is YES, the CPU proceeds to the step S78 in FIG. 22, the step S80 in FIG. 22 or the step S15 in FIG. 18. If a result of the determination is NO, the CPU proceeds to a step S111. In the step S111, the CPU adds the address of the symbol storing area and proceeds to the step S101.

In the followings, it is described a display combination retrieving process for expecting or determining a display combination for the activated line (i.e., center line 8c), with reference to FIG. 24.

First, the CPU 31 sets a leading address of an area corresponding to the center line 8c , among the symbol storing areas, sets 1 as the number of checks (step S121) and proceeds to a step S122. In the step S122, the CPU carries out the display checking process (see FIG. 23). In case that the display checking process has been carried out as the process in the step S79 of FIG. 22, the CPU proceeds to the step S80 in FIG. 22. In case that the display checking process has been carried out as the process in the step S14 of FIG. 18, the CPU proceeds to the step S15 in FIG. 18.

In the step S121, since the CPU proceeds to a display checking process in a step S122 after setting the leading address of the center line 8c , the process in the step S102 of FIG. 23 is also carried out for the center line 8c.

In addition, after the rotations of all the reels 3L, 3C, 3R are stopped, the display combination retrieving process is carried out as the process in the step S14 of FIG. 18. In this case, in the display combination retrieving process, it is determined a display combination corresponding to the combination of symbols displayed along the center line 8c. In addition, before the rotations of the reels 3L, 3C, 3R are stopped, the display combination retrieving process is carried out as the process in the step S79 of FIG. 22. In this case, in the display combination retrieving process, it is expected a display combination which may be displayed after the rotations of the respective reels 3L, 3C, 3R are stopped.

In the followings, it is described a priority ranking checking process for determining a priority ranking table, with reference to FIG. 25.

Herein, in case that the priority ranking data is determined in the priority ranking checking process carried out as the process in the step S81 of FIG. 22, the corresponding priority ranking data represents a display combination corresponding to the combination of symbols which may be displayed along the center line 8c. In addition, in case that the priority ranking data is determined in the priority ranking checking process carried out as the process in the step S84 of FIG. 22, the corresponding priority ranking data represents a display combination (i.e., pseudo display combination) corresponding to the combination of symbols which may be displayed along the display lines except the center line 8c.

First, the CPU 31 sets ┌0┘ as an initial value of the priority ranking data (step S131) and proceeds to a step S132. In the step S132, the CPU takes a logical product of data, which is obtained by taking an exclusive logical sum of the DE register and the HL register, and the HL register.

Herein, in case that there is a bit of ┌1┘ in the data obtained by taking the logical product of the data, which is obtained by taking an exclusive logical sum of the DE register and the HL register, and the HL register, it can be determined that there is a bit which is ┌0┘ in the DE register but ┌1┘ in the HL register (i.e., a bit which is ┌1┘ in the HL register only).

Specifically, for example, in case that ┌000110000┘ is stored in the HL register and ┌000000010┘ is stored in the DE register, it is obtained ┌000110010┘ by taking an exclusive logical sum of the DE register and the HL register. Next, it is obtained ┌000110000┘ by taking a logical product of the data ┌000110010┘ and the HL register. Accordingly, it can be determined that there are bits which are ┌1┘ in the HL register only (i.e., bit 4 and bit 5).

In addition, in case that the priority ranking checking process has been carried out as the process in the step S81 of FIG. 22, the data of the display combination storing area is set in the HL register and the data of the internal winning combination storing area is set in the DE register in the process of the step S80 in FIG. 22, in advance. In this case, when there is a bit of ┌1┘ in the data obtained by the process in the step S132, it can be determined that there is a bit of ┌1┘ in the display combination storing area only. In other words, it can be determined whether there is a display combination which is not included in the internal winning combination (i.e., whether there is a display combination which is not allowed by the internal winning combination).

In addition, in case that the priority ranking checking process has been called from the step S84 in FIG. 22, the data of the pseudo display combination storing area is set in the HL register and the data of the internal winning combination storing area for stop is set in the DE register in the process of the step S83 in FIG. 22, in advance. In this case, when there is a bit of ┌1┘ in the data obtained by the process in the step S132, it can be determined that there is a bit of ┌1┘ in the pseudo display combination storing area only. Accordingly, it can be determined whether there is a pseudo display combination which is not included in the internal winning combination for stop (i.e., whether there is a pseudo display combination which is not allowed by the internal winning combination for stop). Herein, the internal winning combination for stop is an internal winning combination corresponding to the data stored in the internal winning combination storing area for stop.

In the step S133, the CPU determines whether all the bits 0˜8 of the data obtained by the process in the step S132 are ┌0┘ or not. If a result of the determination is YES, the CPU proceeds to a step S136. If a result of the determination is NO (i.e., there is a display combination (or pseudo display combination) which is not allowed by the internal winning combination (or internal winning combination for stop)), the CPU proceeds to a step S134. In the step S134, the CPU determines whether the bit 0 of the data obtained by the process in the step S132 is ON (i.e., ┌1┘) or not. If a result of the determination is YES, the CPU proceeds to the step S82 or S85 in FIG. 22, otherwise proceeds to a step S135.

Herein, in case that the bit 0 of the data obtained by the process in the step S132 is ON, since the bit 0 corresponds to Cherry, the display combination (or pseudo display combination) which is not allowed by the internal winning combination (or internal winning combination for stop) is Cherry. In this case, in order to prevent the combination of symbols corresponding to Cherry which is not allowed by the internal winning combination from being displayed, the result of the determination in the step S134 is adapted to be YES.

In the step S135, the CPU determines whether the stop button for which the push operation is active is 1 or not, i.e., whether it is after the second stop operation or not. When a result of the determination is YES, the CPU proceeds to the step S82 or S85 in FIG. 22, otherwise proceeds to the step S136.

Herein, in the step S135, the result of the determination is adapted to be YES in case that there is the display combination (or pseudo display combination) which is not allowed by the internal winning combination (or internal winning combination for stop) and the number of stop buttons for which the push operation is active is 1. By doing so, a combination of symbols, which correspond to the display combination (or pseudo display combination) which is not allowed by the internal winning combination (or internal winning combination for stop), is not displayed along the activated line (or display line).

In the step S136, the CPU sets 1 as an initial value of the priority ranking when the priority attraction-in ranking table (see FIG. 15) is referred to, sets ┌6┘ in the number of checks and proceeds to a step S137. The number of checks is the maximum remaining number of operations of carrying out a process in a step S138 which will be described later.

In the step S137, the CPU obtains the attraction-in data corresponding to the current priority ranking on the basis of the priority attraction-in ranking table, and proceeds to the step S138. In the step S138, the CPU takes a logical product of the DE register, the HL register and the attraction-in data obtained in the step S137, and proceeds to a step S139. In the step S139, the CPU determines whether all the bits constituting the data, which is obtained by taking the logical product of the DE register, the HL register and the attraction-in data in the step S138, are ┌0┘ or not. When a result of the determination is YES, the CPU proceeds to a step S140, otherwise proceeds to a step S142.

In the step S140, the CPU adds ┌1┘ to the priority ranking, subtracts 1 from the number of checks and proceeds to a step S141. In the step S141, the CPU determines whether the number of checks is ┌0┘ or not. When a result of the determination is YES, the CPU proceeds to the step S142, otherwise proceeds to the step S137. In the step S142, the CPU sets the value having added 1 to the number of checks as the priority ranking data, and proceeds to the step S82 or S85 in FIG. 22.

Herein, in case that the result of the determination in the step S134 or S135 is YES and thus the process in the step S138 has never carried out, the initial value (i.e., ┌0┘) of the priority ranking data set in the step S131 is determined as the priority ranking data. In this case, the data of the upper 4 bits or lower 4 bits of the expected display combination data, which will be obtained in the step S85 of FIG. 22 later, becomes ┌0000┘ representing the stop prohibition.

In addition, in case that the result of determination in the step S139 has never been YES after the process in the step S136, the number of checks becomes ┌0┘, and a value having added ┌1┘ to the number of checks ┌0┘ (i.e., ┌1┘) is determined as the priority ranking data in the step S142. In this case, the data of the upper 4 bits or lower 4 bits of the expected display combination data, which will be obtained in the step S85 of FIG. 22 later, becomes ┌0001┘ representing the stop possibility.

In the followings, it is described a reel stop control process for stopping the rotations of the reels 3L, 3C, 3R on the basis of the internal winning combination or timing of the stop operation by the player, with reference to FIG. 26.

First, the CPU 31 determines whether an active stop button has been pushed, i.e., whether the stop buttons 7L, 7C, 7R corresponding to the reels 3L, 3C, 3R being rotated have been pushed or not (step S151). Specifically, in the step S151, the CPU determines whether active stop button flags corresponding to the pushed stop buttons 7L, 7C, 7R are ON. If a result of the determination is YES, the CPU updates the active stop button flags corresponding to the pushed stop buttons 7L, 7C, 7R to OFF and proceeds to a step S154, otherwise proceeds to a step S152.

Herein, the active stop button flag is information for discriminating whether the reels 3L, 3C, 3R corresponding to the pushed stop buttons 7L, 7C, 7R are being rotated or not. Three flags are provided to correspond to each of the stop buttons 7L, 7C, 7R. In case that the reels 3L, 3C, 3R corresponding to the pushed stop buttons 7L, 7C, 7R are being rotated, the active stop button flags corresponding to the corresponding stop buttons 7L, 7C, 7R are ON. In case that the reels 3L, 3C, 3R corresponding to the pushed stop buttons 7L, 7C, 7R are not being rotated, the active stop button flags corresponding to the corresponding stop buttons 7L, 7C, 7R are OFF.

In the step S152, the CPU determines whether 30 seconds have lapsed or not after the reel has started to rotate, so as to carry out an automatic stop of the reel. The automatic stop is meant that the gaming machine automatically (i.e., internally) stops the symbol variation when a predetermined time (for example, 30 seconds) has lapsed, with the stop buttons 7L, 7C, 7R being not pushed (i.e., with the stop command being not detected), from after it was detected an operation of the start lever 6 (i.e., the process in the step S36 of FIG. 19 was carried out). When a result of the determination is YES, the CPU proceeds to a step S153, otherwise proceeds to the step S151.

In the step S153, the CPU determines an expected stop position at which the winning combination becomes the losing, and proceeds to a step S155. The expected stop position is a code number of a symbol displayed at the position of the center line 8c when the reel, which was subject to the stop operation, is stopped. In the step S153, in case of carrying out the automatic stop, even though there are Small Win, MB, Replay and the like determined as an internal winning combination, in order to ensure fairness in the game, the CPU determines an expected stop position at which a combination of symbols corresponding to the internal winning combination is not displayed along the activated line (i.e., the CPU carries out a winning avoiding process).

In the step S154, the CPU carries out a priority attraction-in control process, which will be described with reference to FIG. 27, and proceeds to a step S155. In the step S155, the CPU transmits a reel stop command and proceeds to a step S156. The reel stop command includes information about an expected stop position determined in a priority attraction-in control process (see FIG. 27), the number of sliding symbols, the type of the stop control, the types of the stop buttons 7L. 7C, 7R for which the push operation has been carried out, and the like.

In the step S156, the CPU updates the symbol storing area based on the expected stop position and proceeds to a step S157. Specifically, on the assumption that the rotation of the reel is stopped at the expected stop position determined in the step S153 or a step S169 in FIG. 27, in this case, the CPU stores identifiers corresponding to types of symbols located at each of the symbol display areas of the corresponding reel in the symbol storing areas. The symbol storing area is a memory area for storing an identifier for discriminating types of symbols stopped at each of the symbol stop positions when the reel for which the stop operation has been carried out is stopped.

In the step S157, the CPU determines whether there is a stop button for which the push operation is active. Specifically, the CPU determines whether any one of the three active stop button flags is ON or not. In case that there are the reels 3L, 3C, 3R being rotated and any one of the three active stop button flags is ON, a result of the determination becomes YES and the CPU proceeds to a step S158. In case that all the reels 3L, 3C, 3R are stopped and all the three active stop button flags are OFF, a result of the determination becomes NO and the CPU proceeds to a step S159.

In the step S158, the CPU carries out the expected display combination storing process (see FIG. 22) and proceeds to the step S151. Herein, the expected display combination storing process includes a case carried out as the process in the step S158 and a case carried out as the process in the step S65 of the reel stop initialization process (see FIG. 21). In case that the expected display combination storing process is carried out as the process in the step S65 of the reel stop initialization process (see FIG. 21), before the reels 3L, 3C, 3R start to rotate after the start operation has been carried out, with regard to each of the symbols positions of the respective reels 3L, 3C, 3R, it is carried out an expectation of a display combination corresponding to a combination of symbols displayed after the rotation of the reel is stopped at the corresponding symbol position, in the expected display combination storing process.

In addition, in case that the expected display combination storing process is carried out as the process in the step S158, after the reels 3L, 3C, 3R has started to rotate and then the stop operation has been carried out, and before the rotation of the reel corresponding to the stop button for which the stop operation has been carried out is stopped, with regard to each of the symbols positions of the respective reels being rotated, it is carried out an expectation of a display combination corresponding to a combination of symbols stopped after the rotation of the reel is stopped at the corresponding symbol position, in the expected display combination storing process.

In the step S159, the CPU determines whether the stop button has been under pushed state. Specifically, it determines whether the stop command signal has been detected from the stop button for which the third stop operation has been carried out, among the stop buttons 7L, 7C, 7R. When a result of the determination is YES, the CPU proceeds to the step S159, otherwise proceeds to the step S14 in FIG. 18. Herein, while the stop button for which the third stop operation has been carried out is being pushed, it is continued such state that the process in the step S159 is repeated and the CPU does not proceed to a process next to the step S159. In addition, in this case, the command of the third stop operation is repetitively transmitted to the sub-control circuit 72. Accordingly, the command of the third stop operation is repetitively transmitted while it is continuously carried out the push operation of the stop button in the third stop operation.

In the followings, it is described a priority attraction-in control process for determining an expected stop position based on a type of an internal winning combination, a gaming state and the like, with reference to FIG. 27.

First, the CPU 31 selects an expected display combination storing area in accordance with the pushed stop button (step S161) and proceeds to a step S162. Specifically, the CPU selects an expected display combination storing area corresponding to a reel corresponding to the pushed stop button. In the step S162, the CPU sets 5 as the number of checks and proceeds to a step S163. In the priority attraction-in control process, the number of checks is meant by the number of operations of retrieving the expected display combination storing area in a step S166.

In the step S163, the CPU determines whether it is under MB gaming state, i.e., whether the flag under MB operation is ON or not. When a result of the determination is YES, the CPU proceeds to a step S164, otherwise proceeds to a step S166. In the step S164, the CPU determines whether the left stop button 7L has been pushed. Specifically, it determines whether a stop command signal has been transmitted from the stop button 7L. When a result of the determination is YES, the CPU proceeds to a step S165, otherwise proceeds to the step S166.

In the step S166, the CPU retrieves the greatest data (i.e., expected display combination data) of the expected display combination storing areas, within the number of checks, from an area corresponding to the symbol position corresponding to a symbol counter. The symbol counter is a counter for discriminating the symbol position. The symbol counter includes information of code numbers corresponding to the symbols located at the center line 8c, among the symbols displayed on the reels.

In the step S167, the CPU determines and evacuates the number of sliding symbols on the basis of the retrieval result, and proceeds to a step S168. Specifically, the CPU determines a difference between a value of a symbol position corresponding to the highest expected display combination data among the expected display combination data retrieved in the process of the step S166 and a value stored in the symbol counter, as the number of sliding symbols, and evacuates the number of sliding symbols determined. In the step S168, the CPU restores the number of sliding symbols evacuated in the step S167 to determine the number of sliding symbols, and proceeds to a step S169.

Herein, in the step S167, in consideration that the plural greatest expected display combination data is retrieved within the retrieval range of the expected display combination storing areas, the number of sliding symbols determined is once evacuated. In case that the plural greatest expected display combination data is retrieved, the CPU determines the number of sliding symbols for each of the plural expected display combination data and once evacuates the corresponding number of sliding symbols determined. In the step S168, the CPU determines the smallest number of sliding symbols of the plural numbers of sliding symbols evacuated.

In the step S169, based on the symbol counter and the number of sliding symbols determined in the step S168, the CPU determines and stores an expected stop position and proceeds to the step S155 in FIG. 26. Specifically, the CPU determines a symbol position obtained when the reel is rotated as the number of sliding symbols determined in the step S168, as the expected stop position.

In the followings, it is described a bonus end checking process for ending a MB gaming state when it is satisfied an end condition of the MB gaming state, with reference to FIG. 28.

First, the CPU 31 determines whether the bonus end number counter is ┌0┘ or not (step S171). When a result of the determination is YES, the CPU proceeds to a step S172, otherwise proceeds to the step S20 in FIG. 18. In the step S172, the CPU carries out a MB ending process and proceeds to a step S173. Specifically, the CPU stores ┌0┘ in the bit 0 which is a storing area corresponding to the flag under MB operation of the areas for storing a flag under operation (FIG. 12D), and clears the bonus end number counter.

In the step S173, the CPU transmits a bonus end command to the sub-control circuit 72 and proceeds to a step S174. In the step S174, the CPU determines whether a RT preparation flag is ON or not. When a result of the determination is YES, the CPU proceeds to a step S175, otherwise proceeds to the step S20 in FIG. 18. The RT preparation flag is information for discriminating whether the RT1 section has been allowed to operate or not. In case that the RT1 section has been allowed to operate, the RT preparation flag is ON. In case that the RT1 section has not been allowed to operate, the RT preparation flag is OFF.

In the step S175, the CPU makes the flag under RT1 operation ON, clears the RT preparation flag (i.e., updates the RT preparation flag to OFF), and proceeds to a step S176. In the step S176, the CPU stores ┌1000┘ in the RT game number counter, and proceeds to the step S20 in FIG. 18.

In the followings, it is described a bonus operation checking process for operating a MB gaming state and a RT section based on types of the display combination s determined, with reference to FIG. 29.

First, the CPU 31 determines whether the display combination is MB1 or MB2 (step S181). When a result of the determination is YES, the CPU proceeds to a step S182, otherwise proceeds to a step S187. In the step S182, the CPU determines whether the display combination is MB1 or not. When a result of the determination is YES, the CPU proceeds to a step S183, otherwise proceeds to a step S184. In the step S183, the CPU updates the RT preparation flag to ON and proceeds to the step S184.

In the step S184, the CPU clears the internal carryover combination storing area and proceeds to a step S185. In the step S185, the CPU carries out the MB operation process based on the bonus operation table (see FIG. 11) and proceeds to a step S186. For example, in case that the display combination is MB1, the CPU refers to the bonus operation table (see FIG. 11) to update the flag under MB operation corresponding to MB to ON, and sets the bonus end number counter. In the step S186, the CPU transmits a bonus operation command to the sub-control circuit 72, and proceeds to the step S2 in FIG. 18.

In the step S187, the CPU determines whether the display combination is RT or not. When a result of the determination is YES, the CPU proceeds to a step S188, otherwise proceeds to a step S191. In the step S188, the CPU determines whether the flag under RT2 operation is ON or not. When a result of the determination is YES, the CPU proceeds to the step S2 in FIG. 18, otherwise proceeds to a step S189. In the step S189, the CPU updates the flag under RT2 operation to ON and proceeds to a step S190. In the step S190, the CPU stores ┌1000┘ in the RT game number counter, and proceeds to the step S2 in FIG. 18.

Herein, only when the display combination is RT (i.e., a result of the determination in the step S187 is YES) and the flag under RT2 operation is not ON (i.e., a result of the determination in the step S188 is NO), the flag under RT2 operation is ON in the step S189 and ┌1000┘ is stored in the RT game number counter in the step S190.

In other words, in case that the display combination becomes RT when the RT2 section does not operate, the RT2 section operates and ┌1000┘ is stored in the RT game number counter. Since the RT game number counter is subtracted every game and the RT2 section is over when the value of the RT game number counter becomes ┌0┘, the RT2 section is continued over maximum 1,000 games.

In the mean time, in case that the display combination becomes RT when the RT2 section operates (i.e., when the value of the RT game number counter is not ┌0┘), since the result of the determination in the step S188 becomes YES, the RT game number counter is not updated to ┌1000┘ when the RT2 section operates. Accordingly, the RT2 section is not continued over 1,000 games.

In the step S191, the CPU determines whether the display combination is Replay or not. When a result of the determination is YES, the CPU proceeds to a step S192, otherwise proceeds to the step S2 in FIG. 18. In the step S192, since the combination of symbols corresponding to Replay has been displayed, the CPU copies the insertion number counter to the automatic insertion counter (i.e., it stores a value, which is same as the value stored in the insertion number counter, in the automatic insertion counter), and proceeds to the step S2 in FIG. 18. By the process in the step S192, a value same as the value stored in the automatic insertion counter is set in the insertion number counter, in the process of the step S24 in FIG. 19 in a next game.

In the followings, it is described an intervention process under control of the main CPU for repetitively performing a predetermined process carried out every predetermined time by the main CPU (CPU (31)), with reference to FIG. 30. The intervention process is repetitively carried out every 1.1173 ms.

First, the CPU 31 carries out a timer update process for subtracting ┌1┘ from the value set in the timer for demo (step S201), and proceeds to a step S202. In the step S202, the CPU checks an input port and proceeds to a step S203. Specifically, the CPU checks whether there is an input from the start switch 6S by the operation of the start lever 6. In the step S203, the CPU carries out a reel rotation driving process and proceeds to a step S204. Specifically, the CPU sets information representing a control target reel as a reel identifier, and controls the driving of the reel.

In the step S204, the CPU carries out a lamp-•7SEG driving process and ends the periodical intervention process. Specifically, the CPU turns on the BET lamps 17a to 17c based on the insertion number. In addition, the CPU displays the number of medals credited (i.e., stacked), the payout number of medals and the like on the credit display unit 19.

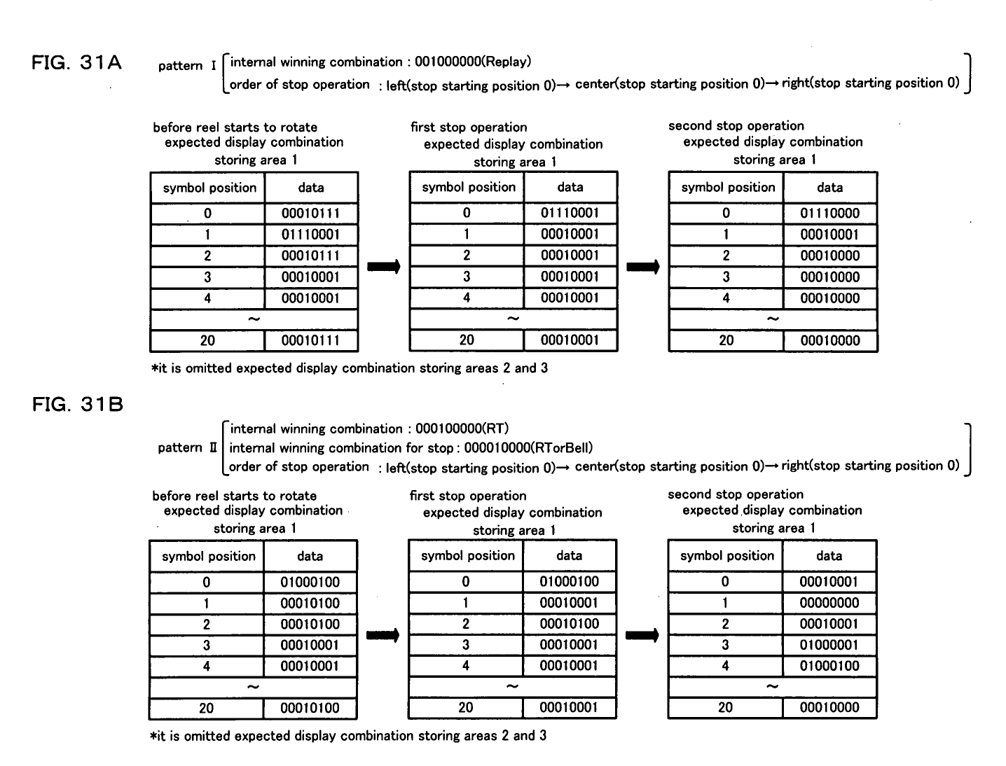

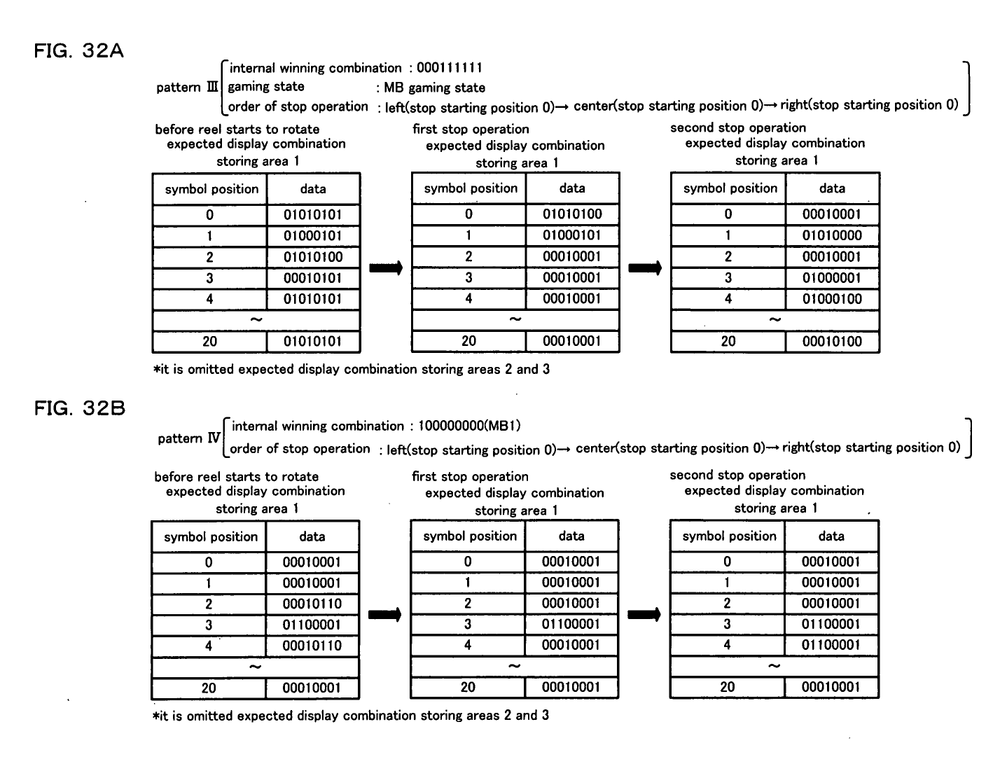

In the followings, it is described an order of storing data (i.e., expected display combination data) in the expected display combination storing area based on the internal winning combination, the stop operation and the like, and an order until an expected stop position is determined on the basis of the data stored in the expected display combination storing area, with reference to FIGS. 31 and 32. In addition, it is not shown the data, which is stored in the expected display combination storing areas 1 and 3.

FIG. 31A shows a pattern I of data (i.e., expected display combination data) stored in the expected display combination storing area 1, in case the push operation of the left stop button 7L as the first stop operation is carried out at the stop starting position ┌0┘, the push operation of the central stop button 7C as the second stop operation is carried out at the stop starting position ┌0┘, and the push operation of the right stop button 7R as the third stop operation is carried out at the stop starting position ┌0┘ when an internal winning combination is ┌001000000┘ (i.e., Replay). The stop starting position is a code number of a symbol located at the center line 8c, among the symbols displayed on the reel corresponding to the stop button for which the stop operation has been carried out, when the stop operation has been carried out.

Hereinafter, it is described an order of storing the data shown in, FIG. 31A in the expected display combination storing area, and an order until an expected stop position is determined on the basis of the data stored in the expected display combination storing area.

First, it is described an order of storing the data in the expected display combination storing area before the reel starts to rotate, in the reel stop initialization process (see FIG. 21).

The left reel 3L is determined as a retrieval target reel, and ┌0┘ is set as a symbol position. Based on the type of the retrieval target reel, the symbol position and the symbol arrangement table, a type of a symbol is specified (i.e., Replay), and an identifier corresponding to Replay is stored in an area corresponding to the central symbol display area of the left reel 3L, among the symbol storing areas.

Next, a symbol corresponding to a symbol position (i.e., ┌1┘) having added ┌1┘ to the symbol position ┌0┘ is specified (i.e., Bell) on the basis of the symbol arrangement table, and an identifier corresponding to Bell is stored in an area corresponding to the upper symbol display area of the left reel 3L, among the symbol storing areas. Likewise, a symbol corresponding to a symbol position (in this case, exceptionally ┌20┘) having subtracted ┌1┘ from the symbol position ┌0┘ is specified (i.e., Crown) on the basis of the symbol arrangement table.

Next, a leading address of the symbol combination table is set, and a display combination is determined on the basis of the data, which is stored in an area corresponding to the top line 8b, among the symbol storing areas. In other words, since (the identifier off) ┌Bell-being rotated-being rotated┘ has been stored in the area corresponding to the top line 8b of the symbol storing areas, ┌Bell┘ and ┌Replay┘ are determined as display combination s on the basis of the symbol combination table and ┌001000010┘ is stored in the display combination storing area.

Continuously, display combinations are determined in order of the bottom line 8d, the cross-down line 8e and the cross-up line 8a, and a logical sum of the determined display combination s is once stored in the display combination storing area and then stored in the pseudo display combination storing area (in this case, ┌001010010┘). In addition, the display combination storing areas are cleared.

Next, based on (the identifier of) ┌Replay-being rotated-being rotated┘ stored in the area corresponding to the center line 8c of the symbol storing areas, ┌Small Win of Chance┘, ┌RT┘, and ┌Small Win of 10 pieces┘ are determined as display combinations, and the data corresponding to the corresponding display combinations is stored in the display combination storing area (in this case, ┌000111000┘). Then, it is taken an exclusive logical sum of the display combination storing area (i.e., ┌000111000┘) and the internal winning combination storing area (i.e., ┌001000000┘) and then a logical product of a result thereof and the display combination storing area.

As a result of that, it is determined that all the bits 0˜8 are not ┌0┘. Since the bit 0 is not ON (i.e., a result of the determination in the step S134 is NO) and it is not also after the second stop operation (i.e., a result of the determination in the step S135 of FIG. 25 is NO), it is sequentially taken a logical product of each of the attraction-in data defined every priority ranking in the priority attraction-in ranking table, the display combination storing area and the internal winning combination storing area. In addition, since there is no attraction-in data whose logical product with the display combination storing area and the internal winning combination storing area is not ┌0┘, ┌1┘ is determined as the priority ranking data. The bit pattern of this priority ranking data is shifted to the left (i.e., to the upper) by 4 (i.e., from ┌00000001┘ to ┌00010000┘)and then evacuated.

Next, it is taken an exclusive logical sum of the pseudo display combination storing area (i.e., ┌001010010┘) and the internal winning combination storing area for stop (i.e., ┌001000000┘) and then a logical product of a result thereof and the display combination storing area. As a result of that, it is determined that all the bits 0˜8 are not ┌0┘. Since the bit 0 is not ON (i.e., a result of the determination in the step S134 is NO) and it is not also after the second stop operation (i.e., a result of the determination in the step S135 of FIG. 25 is NO), it is sequentially taken a logical product of each of the attraction-in data defined every priority ranking in the priority attraction-in ranking table, the pseudo display combination storing area and the internal winning combination storing area for stop.

Herein, since the logical product of the attraction-in data having the priority ranking ┌1┘, the pseudo display combination storing area and the internal winning combination storing area for stop is not ┌0┘, ┌1┘ is added to the number of checks ┌6┘ of this time and then the result value is determined as the priority ranking data (i.e., binary number of 8 bits ( ┌00000111┘). Then, it is taken a logical sum (i.e., ┌00010111┘) of the priority ranking determined and the evacuated data, which is then stored in an area corresponding to the symbol position ┌0┘ as the expected display combination storing area 1.

The above processes are carried out for each of all the symbol positions on all the reels. In addition, the expected display combination storing area 1 corresponds to the left reel 3L, the expected display combination storing area 2 corresponds to the center reel 3C and the expected display combination storing area 3 corresponds to the right reel 3R.

In the followings, it is described an order for determining an expected stop position based on the data stored in the expected display combination storing area and an order for storing the data in the expected display combination storing area, in accordance with the first stop operation.

First, since the first stop operation is the push operation of the left stop button 7L, the expected display combination storing area 1 is selected. ┌5┘ is set as the number of checks, and it is retrieved the greatest data within the number of checks from the area of the symbol position corresponding to the symbol counter ┌0┘ in the expected display combination storing area 1. Herein, since the data ┌01110001┘ of the symbol position ┌1┘ is greatest, a difference ┌1┘ between the symbol position ┌1┘ and the symbol position ┌0┘ corresponding to the symbol counter ┌0┘ is determined as the number of sliding symbols, and ┌1┘ is determined as an expected stop position, based on the corresponding number of sliding symbols ┌1┘.

The above process of determining the priority ranking data is carried out for the center reel 3C and the right reel 3R corresponding to the stop buttons for which the push operation is active, and the corresponding priority ranking data is stored in the display combination storing areas corresponding to the reels. In addition, the center reel 3C corresponds to the expected display combination storing area 1 and the right reel 3R corresponds to the expected display combination storing area 2.

In the followings, it is described an order for determining an expected stop position based on the data stored in the expected display combination storing area and an order for storing the data in the expected display combination storing area, in accordance with the second stop operation.

First, since the second stop operation is the push operation of the center stop button 7C, the expected display combination storing area 1 is selected and it is checked the number of sliding symbols. Herein, since the data ┌01110001┘ of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

The priority ranking data is determined for the right reel 3R corresponding to the stop button for which the push operation is active, as described above, and the determined priority ranking data is stored in the expected display combination storing area corresponding to the right reel 3R. In addition, the expected display combination storing area 1 corresponds to the right reel 3R.

In the followings, it is described an order for determining an expected stop position based on the data stored in the expected display combination storing area in accordance with the third stop operation.

Since the third stop operation is the push operation of the right stop button 7R, the expected display combination storing area 1 is selected and it is checked the number of sliding symbols. Herein, since the data ┌01110001┘, of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

Accordingly, ┌1┘, ┌0┘, and ┌0┘ are respectively determined as the expected stop positions corresponding to the left reel 3L, the center reel 3C and the right reel 3R, so that the stop modes of the reels 3L, 3C, 3R are as shown in a display example I of FIG. 33A.

FIG. 31B shows a pattern 11 of data (i.e., expected display combination data) stored in the expected display combination storing area 1, in case the push operation of the left stop button 7L as the first stop operation is carried out at the stop starting position ┌0┘, the push operation of the center stop button 7C as the second stop operation is carried out at the stop starting position ┌0┘, and the push operation of the right stop button 7R as the third stop operation is carried out at the stop starting position ┌0┘ when an internal winning combination is ┌000100000┘ (i.e., RT) and the internal winning combination for stop is ┌000100010┘ (i.e., RT and Bell).

Hereinafter, it is described an order of storing the data shown in FIG. 31 B in the expected display combination storing area, and an order until an expected stop position is determined on the basis of the data stored in the expected display combination storing area.

First, as described above, in the reel stop initialization process, it is carried out the process of determining the priority ranking data for each of the symbol positions of all the reels 3L, 3C, 3R on the basis of the internal winning combination, and the determined data is stored in the expected display combination storing areas 1˜3.

In the followings, it is described an order for determining an expected stop position based on the data stored in the expected display combination storing area and an order for storing the data in the expected display combination storing area, in accordance with the first stop operation.

First, since the first stop operation is the push operation of the left stop button 7L, the expected display combination storing area 1 is selected. ┌5┘, is set as the number of checks, and it is retrieved the greatest data within the number of checks from the area of the symbol position corresponding to the symbol counter ┌0┘ in the expected display combination storing area 1. Herein, since the data ┌01000001┘ of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

The above process of determining the priority ranking data is carried out for the center reel 3C and the right reel 3R corresponding to the stop buttons for which the push operation is active, and the corresponding priority ranking data is stored in the display combination storing areas corresponding to the reels. In addition, the center reel 3C corresponds to the expected display combination storing area 1 and the right reel 3R corresponds to the expected display combination storing area 2.

In the followings, it is described an order for determining an expected stop position based on the data stored in the expected display combination storing area and an order for storing the data in the expected display combination storing area, in accordance with the second stop operation.

First, since the second stop operation is the push operation of the center stop button 7C, the expected display combination storing area 1 is selected and it is checked the number of sliding symbols. Herein, since the data ┌01000001┘ of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

The priority ranking data is determined for the right reel 3R corresponding to the stop button for which the push operation is active, as described above, and the determined priority ranking data is stored in the expected display combination storing area corresponding to the right reel 3R. In addition, the expected display combination storing area 1 corresponds to the right reel 3R.

In the followings, it is described an order for determining an expected stop position based on the data stored in the expected display combination storing area in accordance with the third stop operation.

Since the third stop operation is the push operation of the right stop button 7R, the expected display combination storing area 1 is selected and it is checked the number of sliding symbols. Herein, since the data ┌01000100┘ of the symbol position ┌4┘ is greatest, a difference ┌4┘ between this symbol position ┌4┘ and the symbol position ┌0┘ corresponding to the symbol counter ┌0┘ is determined as the number of sliding symbols, and ┌4┘ is determined as an expected stop position, based on the corresponding number of sliding symbols ┌4┘.

Herein, in one embodiment, in case that the internal winning combination is Small Win of Chance, Small Win of 10 pieces or RT (i.e., a result of the determination in the step S62 of FIG. 21 is YES), ┌1┘ is stored in the bit 1 corresponding to Bell of the internal winning combination storing area, in the step S63 of FIG. 21. Accordingly, it becomes more cases that the data (i.e., ┌0100┘) corresponding to Bell is stored in the lower 4 bits of the expected display combination data.

Thereby, it becomes higher a probability that the combination of symbols corresponding to Small Win of Chance, Small Win of 10 pieces or RT will be displayed along the activated line and the combination of symbols ┌Bell-Bell-Bell┘ will be displayed along the display lines except the activated line. In other words, the probability that the combination of symbols corresponding to Small Win of Chance, Small Win of 10 pieces or RT will be displayed along the activated line and the combination of symbols ┌Bell-Bell-Bell┘ will be displayed along the display lines except the activated line is higher a probability that the probability that the combination of symbols corresponding to Small Win of Chance, Small Win of 10 pieces or RT will be displayed along the activated line and the combination of symbols ┌Bell-Bell-Bell┘ will be not displayed along the display lines except the activated line.

As described above, through the step S63 in FIG. 21, in the expected display combination storing area after the second stop operation shown in FIG. 31B, the data of the lower 4 bits of the expected display combination data corresponding to the symbol position ┌4┘ is adapted to be ┌0100┘ corresponding to Bell. In the mean time, the data of the lower 4 bits of the expected display combination data corresponding to the symbol position ┌3┘ is ┌0001┘ corresponding to ┌stop possibility┘.

Accordingly, all the data of the upper 4 bits of the expected display combination data corresponding to the symbol positions ┌4┘ and ┌3┘ are ┌0100┘ corresponding to RT. The value of the expected display combination data (┌01000100┘) corresponding to the symbol positions ┌4┘ is greater than the value of the expected display combination data (┌01000001┘) corresponding to the symbol positions ┌3┘, and the number of sliding symbols corresponding to the symbol position ┌4┘ is determined.

Accordingly, ┌0┘, ┌0┘, and ┌4┘ are respectively determined as the expected stop positions corresponding to the left reel 3L, the center reel 3C and the right reel 3R, so that the stop modes of the reels 3L, 3C, 3R are as shown in a display example II of FIG. 33B. In other words, the combination of symbols ┌Replay-Replay-E┘ is displayed along the activated line and the combination of symbols ┌Bell-Bell-Bell┘ is displayed along the display line (i.e., top line 8b) except the activated line at the same time.

FIG. 32A shows a pattern III of data (i.e., expected display combination data) stored in the expected display combination storing area 1, in case the push operation of the left stop button 7L as the first stop operation is carried out at the stop starting position ┌0┘, the push operation of the center stop button 7C as the second stop operation is carried out at the stop starting position ┌0┘, and the push operation of the right stop button 7R as the third stop operation is carried out at the stop starting position ┌0┘, when an internal winning combination is ┌000111111┘ (i.e., internal winning combination except MB1, MB2 and Replay) under MB gaming state.

Hereinafter, it is described an order of storing the data shown in FIG. 32A in the expected display combination storing area, and an order until an expected stop position is determined on the basis of the data stored in the expected display combination storing area.

First, as described above, in the reel stop initialization process, it is carried out the process of determining the priority ranking data for each of the symbol positions of all the reels 3L, 3C, 3R on the basis of the internal winning combination, and the determined data is stored in the expected display combination storing areas 1˜3.

In the followings, it is described an order for determining an expected stop position based on the data stored in the expected display combination storing area and an order for storing the data in the expected display combination storing area, in accordance with the first stop operation.

First, since the first stop operation is the push operation of the left stop button 7L, the expected display combination storing area 1 is selected. ┌2┘ is set as the number of checks because it is under MB gaming state, and it is retrieved the greatest data within the number of checks from the area of the symbol position corresponding to the symbol counter ┌0┘ in the expected display combination storing area 1. Herein, since the data ┌01010101┘ of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

The above process of determining the priority ranking data is carried out for the center reel 3C and the right reel 3R corresponding to the stop buttons for which the push operation is active, and the corresponding priority ranking data is stored in the display combination storing areas corresponding to the reels. In addition, the center reel 3C corresponds to the expected display combination storing area 1 and the right reel 3R corresponds to the expected display combination storing area 2.

In the followings, it is described an order for determining an expected stop position based on the data stored in the expected display combination storing area and an order for storing the data in the expected display combination storing area, in accordance with the second stop operation.

First, since the second stop operation is the push operation of the center stop button 7C, the expected display combination storing area 1 is selected and it is checked the number of sliding symbols. Herein, since the data ┌01010100┘ of the symbol position ┌0┘ is greatest, a difference ┌0┘ between this symbol position ┌0┘ and the symbol position ┌0┘ corresponding to the symbol counter ┌0┘ is determined as the number of sliding symbols, and ┌0┘ is determined as an expected stop position, based on the corresponding number of sliding symbols ┌0┘.

The priority ranking data is determined for the right reel 3R corresponding to the stop button for which the push operation is active, as described above, and the determined priority ranking data is stored in the expected display combination storing area corresponding to the right reel 3R. In addition, the expected display combination storing area 1 corresponds to the right reel 3R.

In the followings, it is described an order for determining an expected stop position based on the data stored in the expected display combination storing area in accordance with the third stop operation.

Since the third stop operation is the push operation of the right stop button 7R, the expected display combination storing area 1 is selected and it is checked the number of sliding symbols. Herein, since the data ┌0101001┘ of the symbol position ┌1┘ is greatest, a difference ┌1┘ between this symbol position ┌1┘ and the symbol position ┌0┘ corresponding to the symbol counter ┌0┘ is determined as the number of sliding symbols, and ┌1┘ is determined as an expected stop position, based on the corresponding number of sliding symbols ┌1┘.

Herein, in one embodiment, it is structured in such a way that the priority attraction-in ranking of RT (i.e., priority ranking ┌4┘) is lower than that of Small Win of 10 pieces (i.e., priority ranking ┌3┘) by the priority attraction-in ranking table (FIG. 15). In addition, it is also structured such that in the data stored in the upper 4 bits of the expected display combination data, the data corresponding to Small Win of 10 pieces (i.e., ┌0101┘) is relatively greater than the data corresponding to RT (i.e., ┌0100┘). As a result, the Small Win of 10 pieces is preferentially determined as a display combination over RT.

For example, in the expected display combination storing area 1 before the rotation start of reel and after the second stop operation shown in FIG. 32A, the data of the upper 4 bits of the expected display combination data corresponding to the symbol position ┌0┘ corresponds to Small Win of 10 pieces (i.e., ┌0101┘) and the data of the upper 4 bits of the expected display combination data corresponding to the symbol position ┌1┘ corresponds to RT (i.e., ┌0100┘). Of these data, since the data corresponding to Small Win of 10 pieces is greater than the data corresponding to RT, the symbol position ┌0┘ is determined.

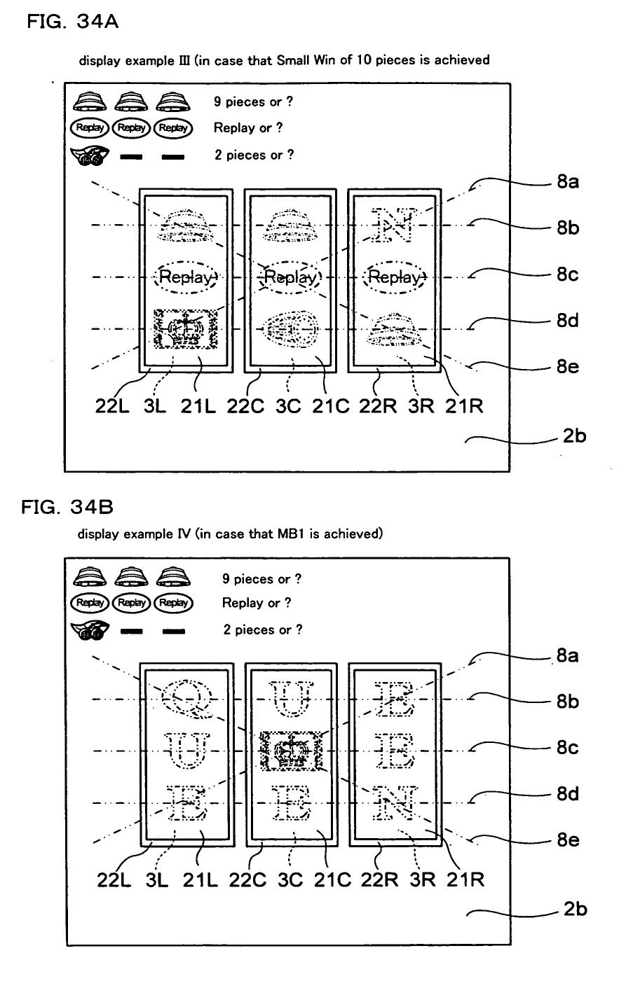

Accordingly, Small Win of 10 pieces is preferentially determined as the display combination over RT, and ┌0┘, ┌0┘, and ┌1┘ are respectively determined as the expected stop positions corresponding to the left reel 3L, the center reel 3C and the right reel 3R, so that the stop modes of the reels 3L, 3C, 3R are as shown in a display example III of FIG. 34A.

FIG. 32B shows a pattern IV of data (i.e., expected display combination data) stored in the expected display combination storing area 1, in case the push operation of the left stop button 7L as the first stop operation is carried out at the stop starting position ┌0┘, the push operation of the center stop button 7C as the second stop operation is carried out at the stop starting position ┌0┘, and the push operation of the right stop button 7R as the third stop operation is carried out at the stop starting position ┌0┘ when an internal winning combination is ┌100000000┘ (i.e., MB1).

Hereinafter, it is described an order of storing the data shown in FIG. 32B in the expected display combination storing area, and an order until an expected stop position is determined on the basis of the data stored in the expected display combination storing area.

First, as described above, in the reel stop initialization process, it is carried out the process of determining the priority ranking data for each of the symbol positions of all the reels 3L, 3C, 3R on the basis of the internal winning combination, and the determined data is stored in the expected display combination storing areas 1˜3.

In the followings, it is described an order for determining an expected stop position based on the data stored in the expected display combination storing area and an order for storing the data in the expected display combination storing area, in accordance with the first stop operation.

First, since the first stop operation is the push operation of the left stop button 7L, the expected display combination storing area 1 is selected. ┌5┘ is set as the number of checks, and it is retrieved the greatest data within the number of checks from the area of the symbol position corresponding to the symbol counter ┌0┘ in the expected display combination storing area 1. Herein, since the data ┌01100001┘ of the symbol position ┌3┘ is greatest, a difference ┌3┘ between this symbol position ┌3┘ and the symbol position ┌0┘ corresponding to the symbol counter ┌0┘ is determined as the number of sliding symbols, and ┌3┘ is determined as an expected stop position, based on the corresponding number of sliding symbols ┌3┘.

The above process of determining the priority ranking data is carried out for the center reel 3C and the right reel 3R corresponding to the stop buttons for which the push operation is active, and the corresponding priority ranking data is stored in the display combination storing areas corresponding to the reels. In addition, the center reel 3C corresponds to the expected display combination storing area 1 and the right reel 3R corresponds to the expected display combination storing area 2.

In the followings, it is described an order for determining an expected stop position based on the data stored in the expected display combination storing area and an order for storing the data in the expected display combination storing area, in accordance with the second stop operation.

First, since the second stop operation is the push operation of the center stop button 7C, the expected display combination storing area 1 is selected and it is checked the number of sliding symbols. Herein, since the data ┌01100001┘ of the symbol position ┌3┘ is greatest, a difference ┌3┘ between this symbol position ┌3┘ and the symbol position ┌0┘ corresponding to the symbol counter ┌0┘ is determined as the number of sliding symbols, and ┌3┘ is determined as an expected stop position, based on the corresponding number of sliding symbols ┌3┘.

The priority ranking data is determined for the right reel 3R corresponding to the stop button for which the push operation is active, as described above, and the determined priority ranking data is stored in the expected display combination storing area corresponding to the right reel 3R. In addition, the expected display combination storing area 1 corresponds to the right reel 3R.

In the followings, it is described an order for determining an expected stop position based on the data stored in the expected display combination storing area in accordance with the third stop operation.

Since the third stop operation is the push operation of the right stop button 7R, the expected display combination storing area 1 is selected and it is checked the number of sliding symbols. Herein, the data ┌01100001┘ of the symbol position ┌3┘ and the data ┌01100001┘ of the symbol position ┌4┘ are greatest. Herein, a difference between this symbol position ┌3┘ and the symbol position ┌0┘ corresponding to the symbol counter ┌0┘ is ┌3┘. In addition, a difference between this symbol position ┌4┘ and the symbol position ┌0┘ corresponding to the symbol counter ┌0┘ is ┌4┘. The smaller difference ┌3┘ of the determined differences ┌4┘ and ┌3┘ is determined as the number of sliding symbols, and ┌3┘ is determined as an expected stop position, based on the corresponding number of sliding symbols ┌3┘.

Accordingly, ┌3┘, ┌3┘, and ┌3┘ are respectively determined as the expected stop positions corresponding to the left reel 3L, the center reel 3C and the right reel 3R, so that the stop modes of the reels 3L, 3C, 3R are as shown in a display example IV of FIG. 34B.

Hereinafter, it is described a display example of the liquid crystal display unit 2b and the display windows 21L, 21C, 21R, with reference to FIGS. 33 and 34.

FIG. 33A shows a display example I. The display example I is an example of a mode in which Replay is achieved (i.e., the combination of symbols corresponding to Replay is displayed along the activated line). Specifically, ┌E┘ is displayed in the upper symbol display area of the left reel 3L, ┌Bell┘ is displayed in the central symbol display area of the left reel 3L, and ┌Replay┘ is displayed in the lower symbol display area of the left reel 3L. ┌Bell┘ is displayed in the upper symbol display area of the center reel 3C, ┌Replay┘ is displayed in the central symbol display area of the center reel 3C, and ┌Watermelon┘ is displayed in the lower symbol display area of the center reel 3C. ┌Replay┘ is displayed in the upper symbol display area of the right reel 3R, ┌Bell┘ is displayed in the central symbol display area of the right reel 3R, and ┌Watermelon┘ is displayed in the lower symbol display area of the right reel 3R.

In other words, the combination of symbols ┌Bell-Replay-Bell┘ is displayed along the center line 8c and the combination of symbols ┌Replay-Replay-Replay┘ is displayed along the cross-up line 8a at the same time.

FIG. 33B shows a display example 11. The display example 11 is an example of a mode in which RT is achieved (i.e., the combination of symbols corresponding to RT is displayed along the activated line). Specifically, ┌Bell┘ is displayed in the upper symbol display area of the left reel 3L, ┌Replay┘ is displayed in the central symbol display area of the left reel 3L, and ┌Crown┘ is displayed in the lower symbol display area of the left reel 3L. ┌Bell┘ is displayed in the upper symbol display area of the center reel 3C, ┌Replay┘ is displayed in the central symbol display area of the center reel 3C, and ┌Watermelon┘ is displayed in the lower symbol display area of the center reel 3C. ┌Bell┘ is displayed in the upper symbol display area of the right reel 3R, ┌E┘ is displayed in the central symbol display area of the right reel 3R, and ┌E┘ is displayed in the lower symbol display area of the right reel 3R.

In other words, the combination of symbols ┌Replay-Replay-E┘ is displayed along the activated line and the combination of symbols ┌Bell-Bell-Bell┘ is displayed along the top line 8b at the same time.

Herein, when the combination of symbols ┌Replay-Replay-E┘ is displayed along the activated line, the RT section operates. The combination of symbols ┌Replay-Replay-E┘ consists of two types of symbols, i.e., ┌Replay┘ and ┌E┘. Accordingly, as compared to the case where a combination of symbols consisting of one type of same symbols is displayed along the activated line, it is more difficult for the player to perceive that the combination of symbols ┌Replay-Replay-E┘ is displayed along the activated line.

Accordingly, even though the combination of symbols ┌Replay-Replay-E┘ has been displayed along the activated line, the RT section may operate without the player's perceiving it. In this case, the combination of symbols relating to the operation of the replay (i.e., ┌Bell-Replay-Bell┘) is displayed along the center line frequently much more, the player can assumably know that the RT section is operating. By doing so, it is possible to give the player a surprise that the RT section has started to operate without the player's knowing it.

In addition, since it becomes more cases that the RT section operates without the player's perceiving the combination of symbols, which is the occasion for the operation of the RT section, it is difficult for the player to perceive whether the RT section is operating or not. Accordingly, it is possible to provide the player with expectations that the RT section may be operating, even though the RT section is not operating.

FIG. 34A shows a display example III. The display example III is an example of a mode in which Small Win of 10 pieces is achieved (i.e., the combination of symbols corresponding to Small Win of 10 pieces is displayed along the activated line). Specifically, ┌Bell┘ is displayed in the upper symbol display area of the left reel 3L, ┌Replay┘ is displayed in the central symbol display area of the left reel 3L, and ┌Crown┘ is displayed in the lower symbol display area of the left reel 3L. ┌Bell┘ is displayed in the upper symbol display area of the center reel 3C, ┌Replay┘ is displayed in the central symbol display area of the center reel 3C, and ┌Watermelon┘ is displayed in the lower symbol display area of the center reel 3C. ┌N┘ is displayed in the upper symbol display area of the right reel 3R, ┌Replay┘ is displayed in the central symbol display area of the right reel 3R, and ┌Bell┘ is displayed in the lower symbol display area of the right reel 3R. In other words, the combination of symbols ┌Replay-Replay-Replay┘ is displayed along the center line 8c.

Herein, in one embodiment, in case that a combination of symbols predetermined is displayed along the display line, a payout to be awarded a player may be different in accordance with a type of the display line at which the combination of symbols predetermined is displayed.

For example, when the combination of symbols ┌Replay-Replay-Replay┘ is displayed along the center line 8c (see FIG. 34A), a display combination is Small Win of 10 pieces and 10 medals are paid out. In addition, when the combination of symbols ┌Replay-Replay-Replay┘ is displayed along the cross-up line 8a, the combination of symbols ┌Bell-Replay-Bell┘ is simultaneously displayed along the center line 8c (see FIG. 33A), a display combination is Replay and a medal is automatically inserted.

In addition, when the combination of symbols ┌Bell-Bell-Bell┘ is displayed along the center line 8c (not shown), a display combination is Bell and 9 medals are paid out. In addition, when the combination of symbols ┌Bell-Bell-Bell┘ is displayed along the top line 8b (see FIG. 33B), the combination of symbols ┌Replay-Replay-E┘ is simultaneously displayed along the center line 8c and the RT section operates.

In addition, when the combination of symbols ┌Cherry-ANY-ANY┘ is displayed along the center line 8c, a display combination is Cherry and 2 medals are paid out. In addition, when the combination of symbols ┌Cherry-ANY-ANY┘ is displayed along the top line 8b, since the symbol ┌Crown┘ is displayed in the central symbol display area of the left reel 3L, there may occur such a case that a combination of symbols ┌Crown-Replay-Replay┘ (corresponding to Small Win of 10 pieces) is displayed along the center line 8c, a display combination is Small Win of 10 pieces and 10 medals are paid out.

In addition, in one embodiment, a combination of symbols predetermined is displayed along the display line except the activated line (for example, center line 8c), so that an image is displayed on the liquid crystal display unit 2b, which includes the information giving a hint as to a payout to be awarded to a player.

Specifically, the information about the combination of symbols ┌Bell-Bell-Bell┘ is displayed and a phrase of ┌9 pieces or ?┘ is displayed at the same time on the upper left side of the liquid crystal display unit 2b. By the displays, the combination of symbols ┌Bell-Bell-Bell┘ is displayed along the activated line (i.e., center line 8c), so that it is clearly informed that 9 medals will be paid out. At the same time, the combination of symbols ┌Bell-Bell-Bell┘ is displayed along the display line except the activated line, so that it is given a hint as to a payout to be awarded to a player (for example, operation of the RT section).

In addition, the information about the combination of symbols ┌Replay-Replay-Replay┘ is displayed and a phrase of ┌Replay or ?┘ is displayed at the same time on the upper left side of the liquid crystal display unit 2b. By the displays, the combination of symbols ┌Replay-Replay-Replay┘ is displayed along the display line except the activated line, so that a payout that a next game will be possible without consuming the medals is clearly informed. At the same time, the combination of symbols ┌Replay-Replay-Replay┘ is displayed along the activated line (for example, center line 8c), so that it is given a hint as to a payout to be awarded to a player (for example, payout of 10 medals).

In addition, the information about the combination of symbols ┌Cherry-ANY-ANY┘ is displayed and a phrase of ┌2 pieces or ?┘ is displayed at the same time on the upper left side of the liquid crystal display unit 2b. By the displays, the combination of symbols ┌Cherry-ANY-ANY┘ is displayed along the activated line (i.e., center line 8c), so that a payout that 2 medals will be paid out is clearly informed. At the same time, the combination of symbols ┌Cherry-ANY-ANY┘ is displayed along the display line except the activated line, so that it is given a hint as to payout to be awarded to a player (for example, payout of 10 medals).

In addition, the information displayed on the upper left side of the liquid crystal display unit 2b is always displayed when a player plays a game (for example, when a so-called demo game is not executed).

FIG. 34B shows a display example IV. The display example IV is an example of a mode in which MB1 is achieved (i.e., the combination of symbols corresponding to MB1 is displayed along the activated line). Specifically, ┌Q┘ is displayed in the upper symbol display area of the left reel 3L, ┌U┘ is displayed in the central symbol display area of the left reel 3L, and ┌E┘ is displayed in the lower symbol display area of the left reel 3L. ┌U┘is displayed in the upper symbol display area of the center reel 3C, ┌Crown┘ is displayed in the central symbol display area of the center reel 3C, and ┌E┘ is displayed in the lower symbol display area of the center reel 3C. ┌E┘ is displayed in the upper symbol display area of the right reel 3R, ┌E┘ is displayed in the central symbol display area of the right reel 3R, and ┌N┘ is displayed in the lower symbol display area of the right reel 3R.

In this case, the combination of symbols, which are displayed in the upper symbol display area of the left reel 3L, the upper symbol display area of the center reel 3C, the upper symbol display area of the right reel 3R, the central symbol display area of the right reel 3R and the lower symbol display area of the right reel 3R, is recognized as a one word of ┌QUEEN┘ by the player. In addition, the same is the case of the combination of symbols which are displayed in the upper symbol display area of the left reel 3L, the central symbol display area of the left reel 3L, the lower symbol display area of the left reel 3L, the lower symbol display area of the center reel 3C and the lower symbol display area of the right reel 3R.

Like this, since the combination of symbols as described above is displayed over the entire symbol display area (i.e., the whole reels), it is possible to provide the player with a more intense new effect. In addition, since the effect can be made using a reel which a player looks at carefully when playing a game, it is possible to reduce an extent that a player's gaze moves when an effect is made, and to decrease a player's burden, as compared to a case in which an effect is carried out with a display device separate from the reel.

In addition, in case that surrounding of the same kind of symbol (for example, surroundings of symbol such as same ┌Blue 7┘) is different, an identity thereof is faded and thus visibility of the symbol may be lost. However, according to an embodiment of the invention, the surrounding of the symbol is not different, so that a decorative effect is provided. In other words, it is possible to enhance the decorative effect without losing the visibility of the symbol.

### Second Embodiment

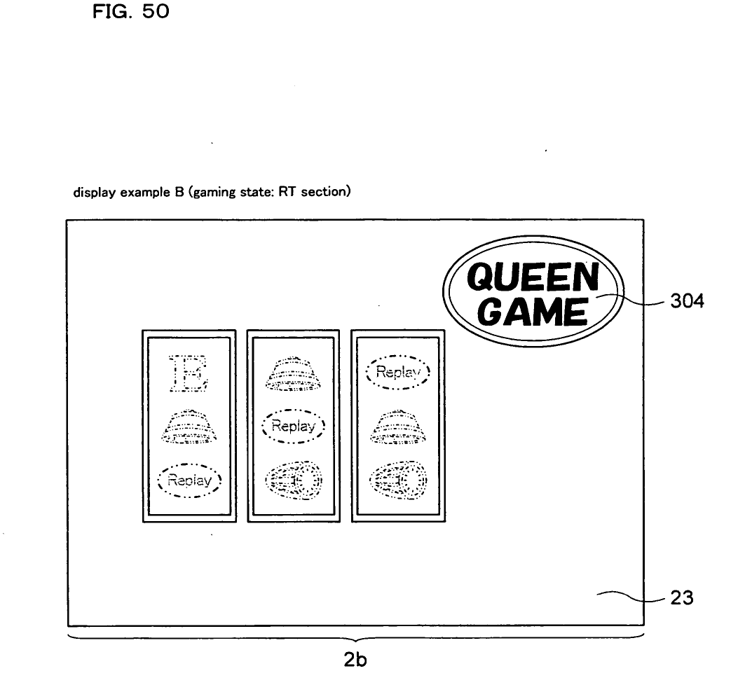

In the second embodiment, it is not displayed the information about the payout to be awarded to the player in correspondence with the combination of symbols displayed along the display lines 8a to 8e, which are displayed when the player plays the game, contrary to the first embodiment. Instead, it is displayed information about a music game which is carried out in a middle bonus game in a right side area of the effect display area 23 (see FIG. 50). Hereinafter, it is described only the differences between the first and second embodiments.

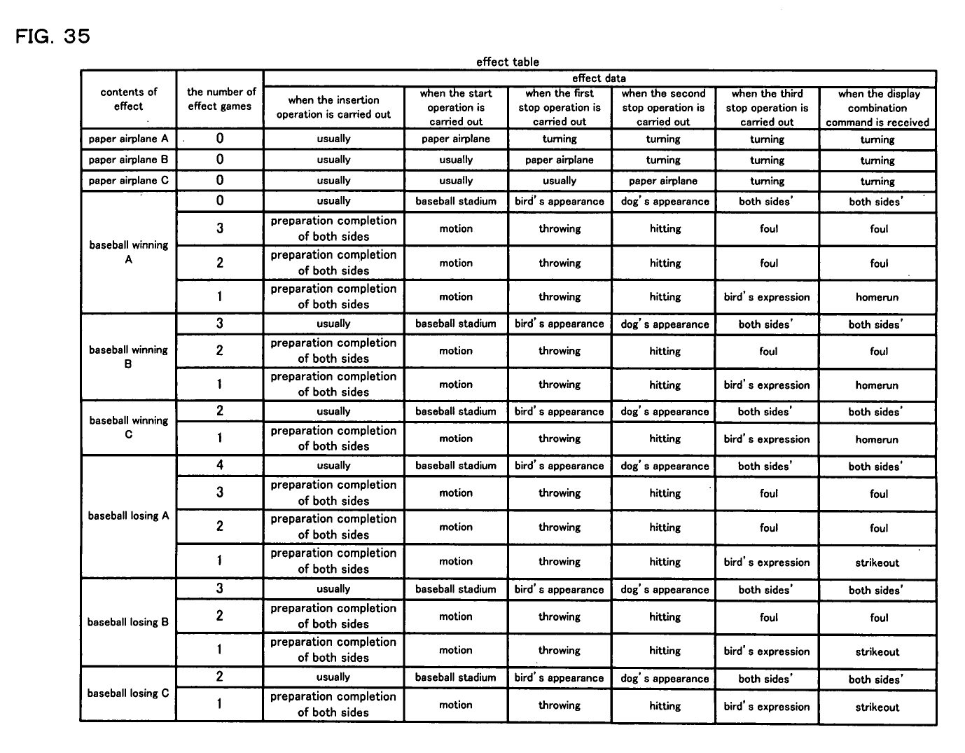

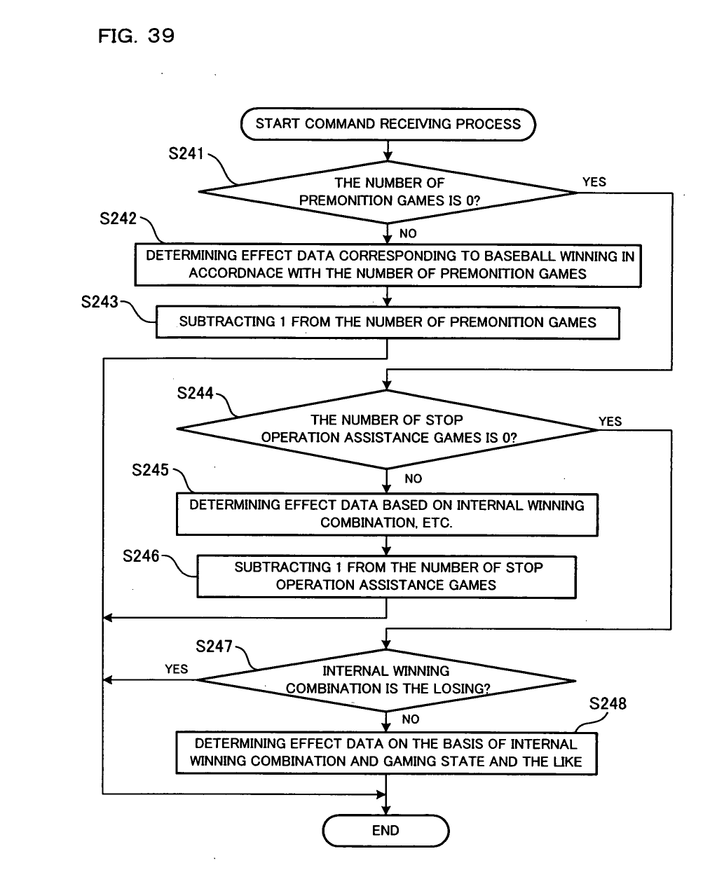

In the followings, it is described an effect table used to select the effect data determined in a start command receiving process (see FIG. 39), with reference to FIG. 35.

The effect table includes information about the contents of effect and the effect data determined every the number of effect games. The number of effect games is information for discriminating the remaining number of games carried out in a continuous effect (i.e., effect which is continuously carried out over plural games). The effect data is information for discriminating an image displayed on the liquid crystal display unit 2b, and is provided to correspond to each of the images, respectively.

The effect data determined by the effect table includes data corresponding to images displayed on the liquid crystal display unit 2b when the insertion operation is carried out, when the start operation is carried out, when the first stop operation is carried out, when the second stop operation is carried out, when the third stop operation is carried out, and when the display combination command is received (i.e., when the sub-control circuit 72 receives the display combination command).

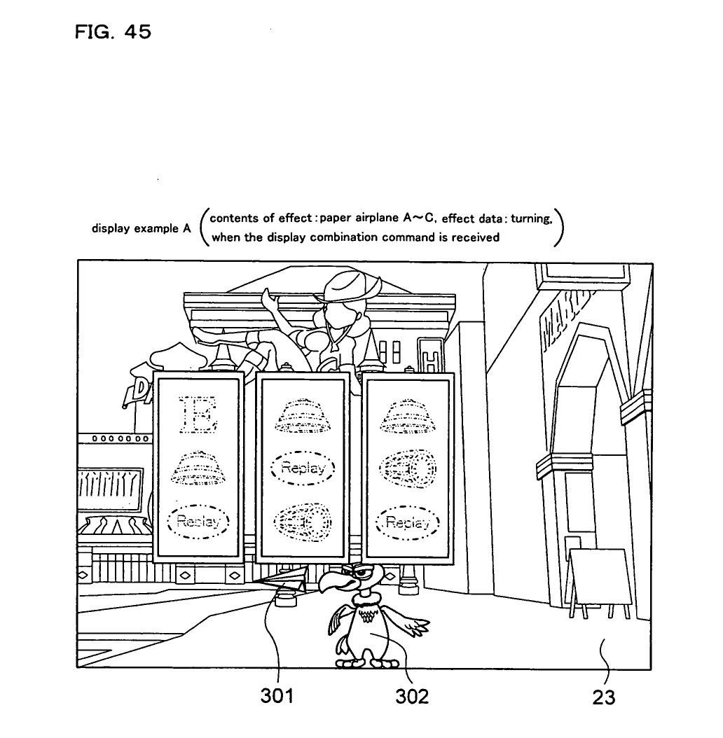

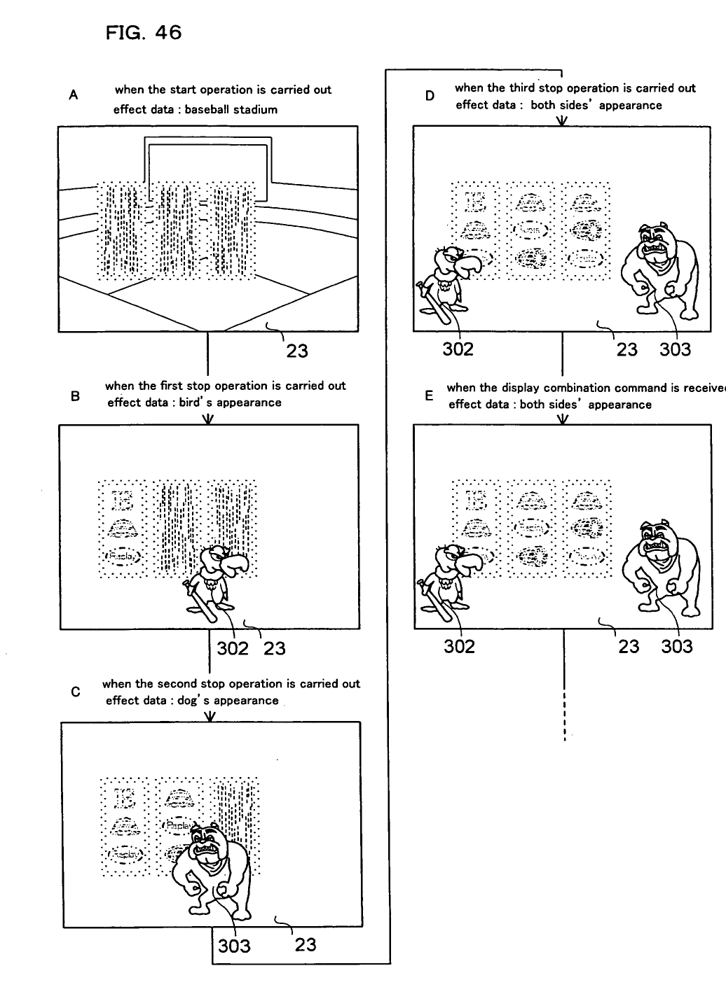

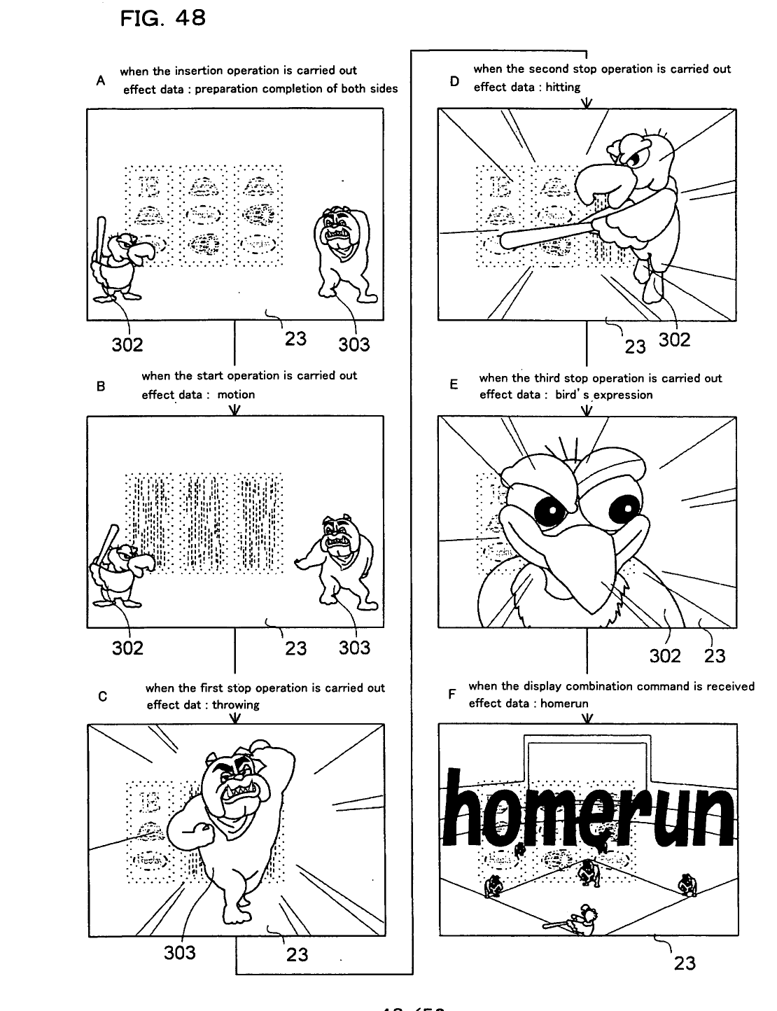

Herein, in one embodiment, the effect (i.e., contents of effect) includes 9 types of effects, i.e., a paper airplane A (see FIG. 45), a paper airplane B (see FIG. 45), a paper airplane C (see FIG. 45), a baseball winning A (see FIGS. 46 to 48), a baseball winning B (see FIGS. 46 to 48), a baseball winning C (see FIGS. 46 and 48), a baseball losing A (see FIGS. 46, 47 and 49), a baseball losing B (see FIGS. 46, 47 and 49) and a baseball losing C (see FIGS. 46, 47 and 49).

The paper airplanes A, B and C are referred to as ┌paper airplane effect┘. The baseball winning A, B and C are referred to as ┌baseball winning effect┘. The baseball losing A, B and C are referred to as ┌baseball losing effect┘.

The paper airplane effect is basically an effect of notifying an internal winning combination, and is carried out in the normal gaming state (except the RT section). The baseball winning effect is started on condition that the combination of symbols corresponding to RT is displayed along the activated line, and is an effect which is carried out over 2˜4 games (i.e., continuous effect). In addition, since the baseball winning effect is carried out only during the operation of the RT section, it is an effect of definitely notifying that the RT section is operating. The baseball winning A, B and C are continuously carried out over four, three and two games, respectively.

In addition, when the baseball winning effect is over, an effect under RT operation is carried out which notifies the player of the operation of the RT section. Accordingly, the baseball winning effect is an effect of a premonition which will be carried out during the RT operation (which is referred to as ┌premonition effect┘).

The baseball losing effect is started in a probability of ┌1/200┘ by a lottery, on condition that it is under normal gaming state (except the RT section and a game in which a perfect notification effect is carried out), and is continuously carried out over 2˜4 games (i.e., continuous effect). Since the baseball losing effect is carried out only when the RT section does not operate, it is an effect of conclusively notifying that the RT section is not operating. The baseball losing A, B and C are continuously carried out over four, three and two games, respectively.

Based on the effect table, in a start command receiving process, the effect data is determined in accordance with the contents of effect and the number of effect games and an image corresponding to the determined effect data is displayed on the liquid crystal display unit 2b at the timing corresponding to the corresponding effect data.

For example, in a first game in which the effect of the baseball winning B is carried out (i.e., first game of the baseball winning B), since the number of effect games is ┌3┘, it is determined the effect data of ┌baseball stadium┘ corresponding to the start operation, ┌bird's appearance┘ corresponding to the first stop operation, ┌dog's appearance┘ corresponding to the second stop operation, ┌both sides' appearance┘ corresponding to the third stop operation and ┌both sides' appearance┘ corresponding to the receiving of the display command. In addition, it is determined the effect data of ┌preparation completion of both sides┘ corresponding to a next game (second game of the baseball winning B).

Thereby, in the first game of the baseball winning B, images corresponding to ┌baseball stadium┘, ┌bird's appearance┘, ┌dog's appearance┘, ┌both sides' appearance┘ and ┌both side's appearance┘ are displayed on the liquid crystal display unit 2b, respectively, when the start operation is carried out, when the first stop operation is carried out, when the second stop operation is carried out, when the third stop operation is carried out, and when the display combination command is received. In addition, in a second game of the baseball winning B, an image corresponding to ┌preparation completion of both sides┘ is displayed on the liquid crystal display unit 2b when the insertion operation is carried out.

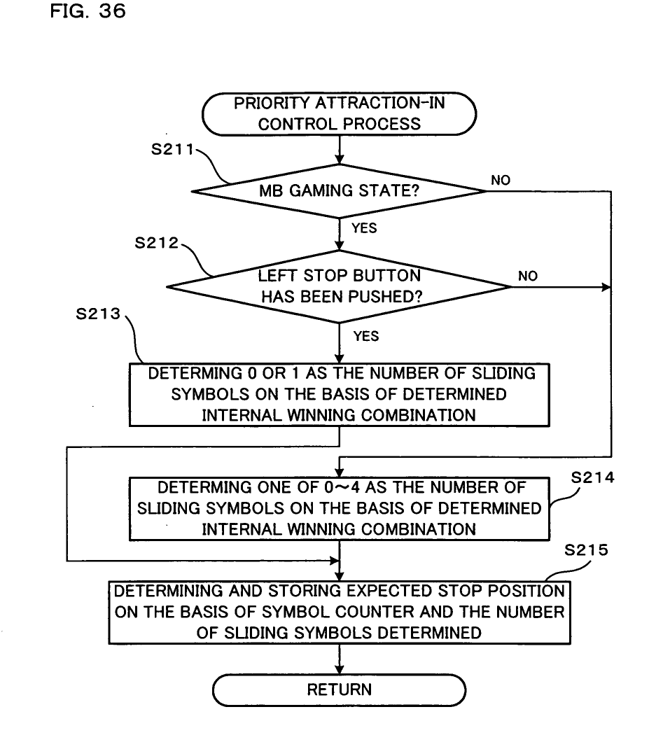

In the followings, with regard to the control operation of the main control circuit 71, it is described a priority attraction-in control process for determining an expected stop position on the basis of a gaming state or a type of an internal winning combination, etc., with reference to FIG. 36. In the priority attraction-in control process of this embodiment, it is determined the number of sliding symbols without retrieving the expected display combination storing areas. In addition, the other flow charts are same as those in the first embodiment.

First, the CPU 31 determines whether it is under MB gaming state, i.e., whether the flag under MB operation is ON or not (step S121). When a result of the determination is YES, the CPU proceeds to a step S212, otherwise proceeds to a step S214. In the step S212, the CPU determines whether the left stop button 7L has been pushed. Specifically, it determines whether a stop command signal has been transmitted from the stop button 7L. When a result of the determination is YES, the CPU proceeds to a step S213, otherwise proceeds to the step S214.

In the step S213, since the left stop button 7L has been pushed in the MB gaming state, the CPU determines ┌0┘ or ┌1┘ as the number of sliding symbols on the basis of the determined internal winning combination, and proceeds to a step S215. In the step S214, the CPU determines one of ┌0┘ to ┌4┘ as the number of sliding symbols on the basis of the determined internal winning combination, and proceeds to a step S215. In the step S215, the CPU determines and stores an expected stop position based on the symbol counter and the number of sliding symbols determined, and proceeds to the step S155 in FIG. 26.

Specifically, the CPU determines an expected stop position based on the value of the symbol counter and the number of sliding symbols determined in the step S213 or S214, and stores the information of the corresponding expected stop position in the RAM 33. The symbol counter is a counter in which the information of the code number of symbol located on the center line 8c of the symbols arranged on the reels is stored.

Herein, in one embodiment, it is carried out a stop control of the reels 3L, 3C, 3R on the basis of a priority attraction-in ranking table (not shown) having the information about a relative priority attraction-in ranking regarding a combination of symbols corresponding to an internal winning combination. Basically, the ┌attraction-in┘ is meant by a control for stopping the reel, which is a stop control target, (i.e., a reel corresponding to a stop button which has been pushed) so that a symbol (hereinafter, referred to as ┌attraction-in target symbol┘) constituting a combination of symbols corresponding to an attraction-in target combination within a range of the maximum number of sliding symbols is displayed in the symbols display area (hereinafter, referred to as ┌active symbol display area┘) connected by the activated line. The attraction-in target combination is an internal winning combination corresponding to a combination of symbols adapted to be arranged along the activated line.

In the mean time, in cases of the second stop operation and the third stop operation, the ┌attraction-in┘ is meant as follows: when a symbol constituting the combination of symbols corresponding to the attraction-in target combination has been displayed in an active symbol display area together with an attraction-in target symbol corresponding to this time stop operation, the attraction-in target symbol is displayed in the active symbol display areas in the display windows 21L, 21C, 21R connected by the activated line which connects the active symbol display area.

Replay has the highest priority attraction-in ranking. MB has a priority ranking higher than the other internal winning combination s except Replay. Accordingly, in case that there is an internal carryover combination, when Replay has been determined as an internal winning combination, a combination of symbols corresponding to Replay is preferentially displayed along the activated line over the combination of symbols corresponding to MB. In the mean time, in case that there is an internal carryover combination, when an internal winning combination except Replay has been determined, a combination of symbols corresponding to MB is preferentially displayed along the activated line over combinations of symbols corresponding to the other internal winning combination s except Replay.

In addition, Small Win of 10 pieces has a priority ranking higher than Bell, Small Win of Chance and RT. In addition, Bell, Small Win of Chance and RT have priority rankings higher than Watermelon. Further, Watermelon has a priority ranking higher than Cherry.

Hereinafter, it is described a control operation of the sub-control circuit 72 with reference to flow charts shown in FIGS. 37 to 43.

In the followings, it is described a RESET-intervention process under control of the sub-CPU for repetitively performing a series of processes under control of the sub-CPU (image control MICOM 81), with reference to FIG. 37.

First, the image control MICOM 81 carries out a command receiving process for receiving a command inputted from the main control circuit 71, the operating unit 17 or the like (step S221), and proceeds to a step S222. In the step S222, it carries out a command outputting process for outputting a command to a circuit except the sound•lamp control circuit (mSub) (72b) and proceeds to a step S223.

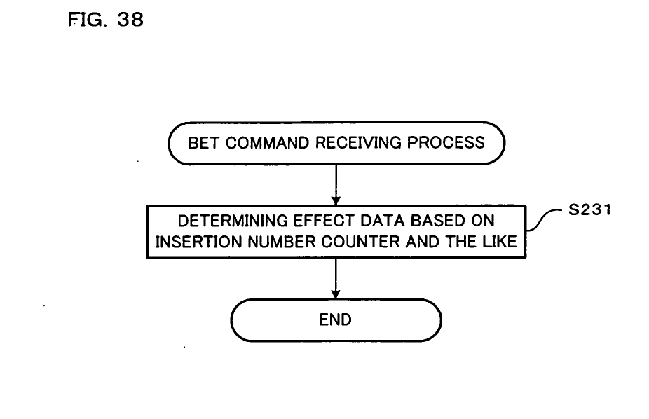

In the step S223, the MICOM carries out an image drawing process and proceeds to a step S224. In the image drawing process, an image is drawn which corresponds to the effect data selected in FIGS. 38 to 41. In addition, in the image drawing process, the image data is written into the control RAM 87 of the image control IC 86 and a frame buffer provided in the video RAM 89. The image data written into the frame buffer is transmitted to the liquid crystal display device 131 and an image corresponding to the corresponding image data is displayed on the liquid crystal display unit 2b (for 1/30s).

In the step S224, the MICOM carries out a music control process and proceeds to the step S221. In the sound control process, the image control MICOM 81 transmits a command to the sound•lamp control circuit (mSub) 72b based on the effect data determined in FIGS. 38 to 40 which will be described later.

Continuously, the sound•lamp control MICOM 111 controls the output of music based on the command transmitted from the image control MICOM 81. Specifically, based on the command transmitted from the image control circuit (gSub) 72a, the sound•lamp control MICOM 111 transmits the sound source data corresponding to the music to be outputted to the sound source IC 115, and outputs the music from the speakers 9L, 9R.

In the followings, it is described a BET command receiving process for carrying out a predetermined process which is carried out with the receiving of the BET command, with reference to FIG. 38. The BET command receiving process is started with the receiving of the BET command from the main control circuit 71.

In a step S231, the image control MICOM determines the effect data based on the insertion number counter and the like, and ends the BET command receiving process. By the process in the step S231, an image corresponding to the insertion number counter is displayed on the liquid crystal display unit 2b.

In the followings, it is described a start command receiving process for carrying out a predetermined process which is carried out with the receiving of the start command, with reference to FIG. 39. The start command receiving process is started with the receiving of the start command from the main control circuit 71.

First, the image control MICOM 81 determines whether the number of premonition games is ┌0┘ or not (step S241). If a result of the determination is YES, it proceeds to a step S244, otherwise proceeds to a step S242. The number of premonition games (i.e., the number of effect games) is information for discriminating the remaining number of games in which the baseball winning effect (i.e., premonition effect) is carried out.

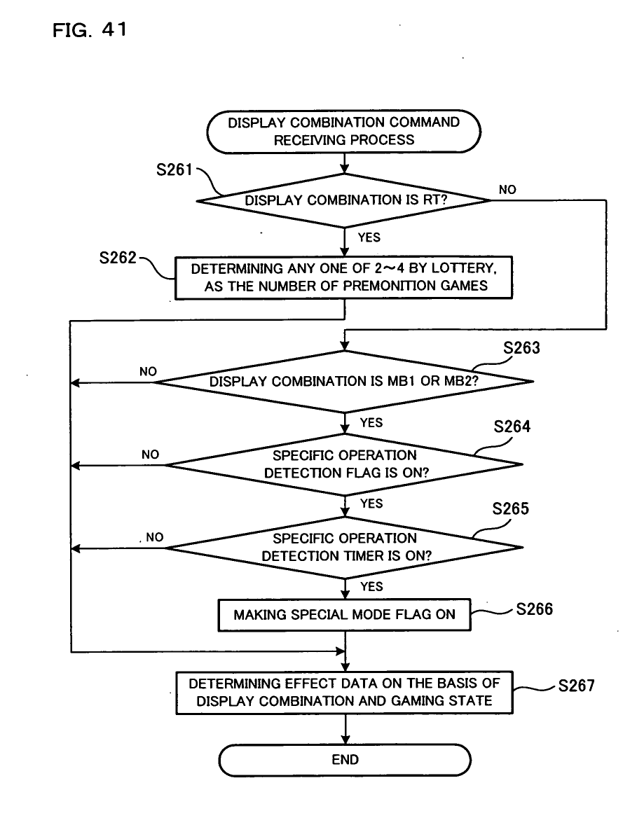

In the step S242, the MICOM determines the effect data corresponding to the baseball winning in accordance with the number of premonition games. Specifically, the MICOM determines the contents of effect determined in a step S262 of FIG. 41, which will be described later, and the effect data corresponding to the current number of premonition games, on the basis of the effect table (see FIG. 35). And, an image corresponding to the effect data determined in the process of the step S242 is displayed on the liquid crystal display unit 2b at the timing corresponding to the determined effect data, so that the baseball winning effect is carried out. In a step S243, the MICOM subtracts ┌1┘ from the number of premonition games and ends the start command receiving process.

In case that the number of premonition games becomes ┌0┘ by subtracting ┌1┘ from the number of premonition games in the step S243, the MICOM determines the effect data corresponding to the effect under RT operation. As a consequence, if the baseball winning effect is over, an image corresponding to the effect under RT operation is displayed on the liquid crystal display unit 2b. The effect under RT operation is an effect of notifying the player that the RT section is operating.

In the step S244, the MICOM determines whether the number of stop operation assistance games is ┌0┘ or not. If a result of the determination is YES, the MICOM proceeds to a step S247, otherwise proceeds to a step S245. The number stop operation assistance games is information for discriminating the remaining number of games in which a game, in which the perfect notification effect is carried, is continuously performed. The perfect notification effect is an effect in which when an internal winning combination except the losing is determined, the determined internal winning combination is notified without fail (i.e., in a probability of 100%). In addition, in the game in which the perfect notification effect is carried out, when the losing is determined as an internal winning combination, although the losing is not notified, it is thus indirectly notified that the losing has been determined as the internal winning combination.

If the perfect notification effect is carried out, the player can perceive the internal winning combination determined and perform the stop operation so that a combination of symbols corresponding to the determined internal winning combination is displayed along the activated line. Accordingly, since it is possible to prevent the player from carrying out the stop operation with the aim of displaying a combination of symbols on the activated line, which are not allowed to be displayed along the activated line, through the perfect notification effect, the player's burden can be reduced.

In the step S245, since the number of stop operation assistance games is not ┌0┘, the MICOM determines the effect data corresponding to the internal winning combination and the like so as to carry out the perfect notification effect, based on the effect table (see FIG. 35), and proceeds to a step S246. The image corresponding to the effect data determined in the process of the step S245 is displayed on the liquid crystal display unit 2b at the timing corresponding to the determined effect data, so that the perfect notification effect is carried out.

In the step S246, the MICOM subtracts ┌1┘ from the number of stop operation assistance games and ends the start command receiving process. In the step S247, the MICOM determines whether the internal winning combination is the losing or nor. If a result of the determination is YES, the MICOM ends the start command receiving process, otherwise proceeds to a step S248.

In the step S248, the MICOM determines the effect data based on the internal winning combination and the gaming state, and ends the start command receiving process. Specifically, in the step S248, the effect data corresponding to the paper airplane effect may be determined on the basis of the internal winning combination. Then, an image corresponding to the effect data determined in the process of the step S248 is displayed on the liquid crystal display unit 2b.

Herein, in the step S248, the one effect of the baseball losing A to C is determined in a probability of ┌1/200┘ by a lottery, on condition that it is under normal gaming state (except the RT section and a game in which the perfect notification effect is carried out). In addition, the baseball losing A to C is determined in the same probability, respectively.

In the step S248, in case that the one effect of the baseball losing A to C has been determined, the number of premonition games corresponding to the determined effect is pseudo-determined. Specifically, in case that the baseball losing A, the baseball losing B and the baseball losing C have been determined, ┌4┘, ┌3┘ and ┌2┘ are respectively determined as the number of premonition games.

Then, in the step S248, the MICOM determines the effect data on the basis of the effect table (see FIG. 35) in correspondence with the effect and the number of premonition games determined, and subtracts ┌1┘ from the number of premonition games. In addition, in a game after the next game, in the process of the step S242, based on the effect table (see FIG. 35), the effect data corresponding to the baseball losing effect is determined in accordance with the effect and the number of premonition games determined in the step S248. Continuously, in the process of the step S243, the number of premonition games is subtracted by ┌1┘. By doing so, the baseball losing effect which is continuously carried out over 2˜4 games on condition that it is under normal gaming state is started in a probability of ┌1/200┘.

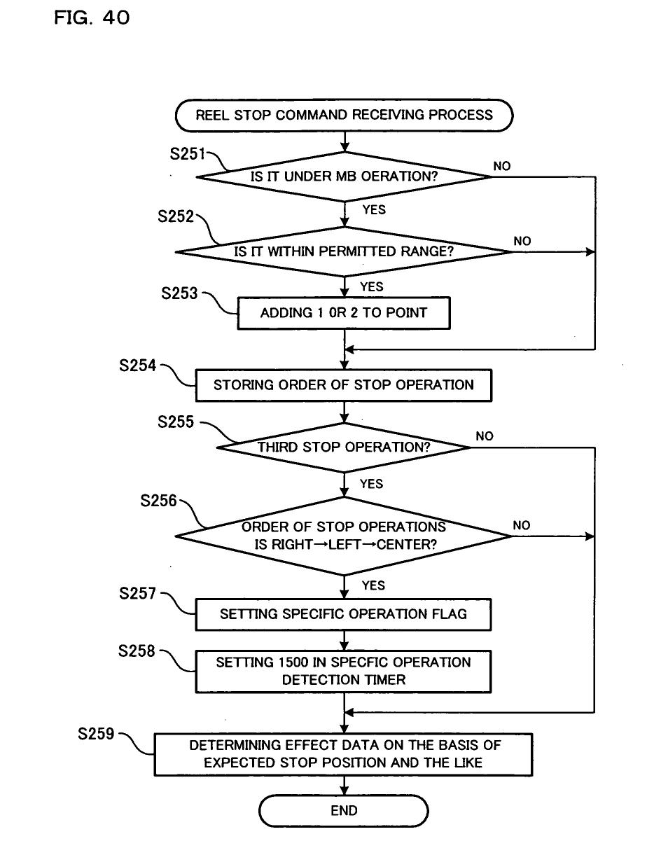

In the followings, it is described a reel stop command receiving process for carrying out a predetermined process which is carried out with the receiving of the reel stop command, with reference to FIG. 40. The reel stop command receiving process is started with the receiving of the reel stop command from the main control circuit 71.

First, the image control MICOM 81 determines whether the MB is operating, i.e., whether the middle bonus game is operating or not, and proceeds to a step S252 (step S251). In the step S252, the MICOM determines whether it is within a permitted range. Specifically, when a position of a marker to be displayed on the liquid crystal display unit 2b in a music game which is carried out in the middle bonus game is within the permitted range, the MICOM determines whether the stop button 7L, 7C, 7R corresponding to the marker has been pushed (which will be specifically described later). If a result of the determination is YES, the MICOM proceeds to a step S253, otherwise proceeds to a step S254.

In the step S253, the MICOM adds ┌1┘ or ┌2┘ to a point and proceeds to the step S254. The point is information in which ┌1┘ or ┌2┘ is cumulatively added whenever the stop button 7L, 7C, 7R corresponding to a corresponding marker is pushed when a position of a marker to be displayed on the liquid crystal display unit 2b in a music game which is carried out in the middle bonus game is within the permitted range.

In addition, an initial value of the point is ┌0┘ when the middle bonus game is started (i.e., the bonus operation command is received), and ┌1┘ or ┌2┘ is cumulatively added to the point whenever the process in the step S253 is carried out, until the corresponding middle bonus game is over.

In the step S254, the MICOM stores an order of the stop operations and proceeds to a step S255. Specifically, based on the information of the types of the stop buttons 7L, 7C, 7R, which is included in the received reel stop command, the MICOM stores the corresponding information in a predetermined area of the work RAM 84. In the step S255, the MICOM determines whether it is the third stop operation or not, based on the information of the types of the stop buttons 7L, 7C, 7R, which is included in the received reel stop command. If a result of the determination is YES, the MICOM proceeds to a step S256, otherwise proceeds to a step S259.

In the step S256, the MICOM determines whether the order of stop operations is ┌right→left→center┘, i.e., whether the stop operation has been carried out in order of the right stop button 7R, the left stop button 7L and the center stop button 7C (hereinafter, referred to as ┌specific stop order┘). If a result of the determination is YES, the MICOM proceeds to a step S257, otherwise proceeds to the step S259. In the step S257, the MICOM sets a specific operation detection flag (i.e., ON) and proceeds to a step S258.

The specific operation detection flag is information for discriminating whether the stop operations have been carried out in the specific stop order. In case that the stop operations have been carried out in the specific stop order, the specific operation detection flag is ON, and in case that the stop operations have not been carried out in the specific stop order, the specific operation detection flag is OFF. In the step S258, the MICOM sets ┌1500┘ as an initial value of a specific operation detection timer which is stored in the work RAM 84, and proceeds to a step S259. The specific operation detection flag is a timer (information) for determining whether the left stop button 7L has been continuously pushed for 3 seconds.

In the step S259, the MICOM determines the effect data based on the expected stop position and the like, and ends the reel stop command receiving process. As a consequence, an image corresponding to the effect data determined in the process of the step S248 is displayed on the liquid crystal display unit 2b.

In the followings, it is described a display combination command receiving process for carrying out a predetermined process which is carried out with the receiving of the display combination command, with reference to FIG. 41. The display combination command receiving process is started with the receiving of the display combination command from the main control circuit 71.

First, the image control MICOM 81 determines whether a display combination is RT or not, based on the information about the display combination included in the display combination command (step S261). If a result of the determination is YES, the MICOM proceeds to a step S262, otherwise proceeds to a step S263. In the step S262, the MICOM determines one of ┌2┘ to ┌4┘ as the number of premonition games by the lottery, and proceeds to a step S267. Specifically, the image control MICOM 81 determines one of the values ┌2┘ to ┌4┘ as the number of premonition games in the same probability, respectively, based on the random number value sampled from the random numbers which are generated from the MICOM.

In the step S262, in case that ┌4┘ is determined as the number of premonition games, the effect data corresponding to the baseball winning A is determined through the process in the step S142 of FIG. 39 in a next game and the effect of the baseball winning A is started. In addition, in case that ┌3┘ is determined as the number of premonition games, the effect data corresponding to the baseball winning B is determined through the process in the step S142 of FIG. 39 in a next game and the effect of the baseball winning B is started. In addition, in case that ┌2┘ is determined as the number of premonition games, the effect data corresponding to the baseball winning C is determined through the process in the step S142 of FIG. 39 in a next game and the effect of the baseball winning C is started.

In the step S263, the MICOM determines whether the display combination is MB1 or MB2, based on information about the display combination included in the display combination command. If a result of the determination is YES, the MICOM proceeds to a step S264, otherwise proceeds to a step S267. In the step S264, the MICOM determines whether the specific operation detection flag is ON or not. If a result of the determination is YES, the MICOM proceeds to a step S265, otherwise proceeds to the step S267. In the step S265, the MICOM determines whether the value of the specific operation detection timer is ┌0┘ or not. If a result of the determination is YES, the MICOM proceeds to a step S266, otherwise proceeds to the step S267.

In the step S266, the MICOM makes a special mode flag ON and proceeds to the step S267. The special mode flag is information for discriminating whether it is allowed a music D, which will be described later, to be selected or not. In case that the special mode flag is ON, it is allowed the music D to be selected. In case that the special mode flag is OFF, it is not allowed the music D to be selected.

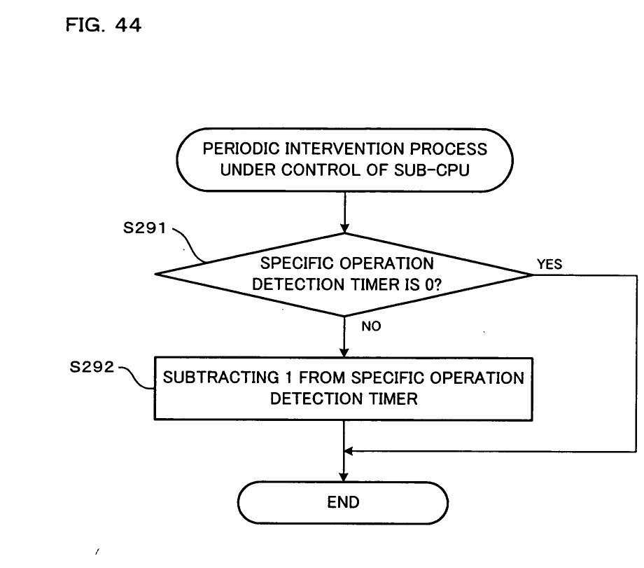

Herein, the process in the step S258 of FIG. 40 is carried out, on condition that the third stop operation has been carried out in the specific stop order (i.e., the result of the determination in the step S255 of FIG. 40 is YES and the result of the determination in the step S256 of FIG. 40 is also YES). In addition, the value ┌1500┘ which has been set as an initial value in the specific operation detection timer in the process of the step S258 in FIG. 40 is subtracted by ┌1┘ every 2 ms (see a step S292 in FIG. 44), on condition that the third stop operation command has been received (i.e., the push operation of the stop button is continuously carried out in the third stop operation) in a periodic intervention process (see FIG. 44) under control of the sub-CPU.

Accordingly, in case that the stop operation has been carried out in the specific stop order, if the push operation of the stop button 7C is continuously carried out in the third stop operation, the value of the specific operation detection timer becomes ┌0┘ after 3 seconds from when the corresponding stop operation has started. Then, a result of the determination in the step S265 becomes YES, the special mode flag becomes ON in the process of the step S266 and it is allowed the music D to be selected. In other words, it is allowed the music D to be selected, on condition that it has been carried out a stop operation (referred to as ┌specific stop operation┘) in which the left stop button 7L is continuously pushed for 3 seconds in the third stop operation of the stop operations which are carried out in the specific stop order.

In the step S267, the MICOM determines the effect data, based on the display combination and the gaming state, etc., and ends the display combination command receiving process. Then, an image corresponding to the effect data determined in the process of the step S267 is displayed on the liquid crystal display unit 2b.

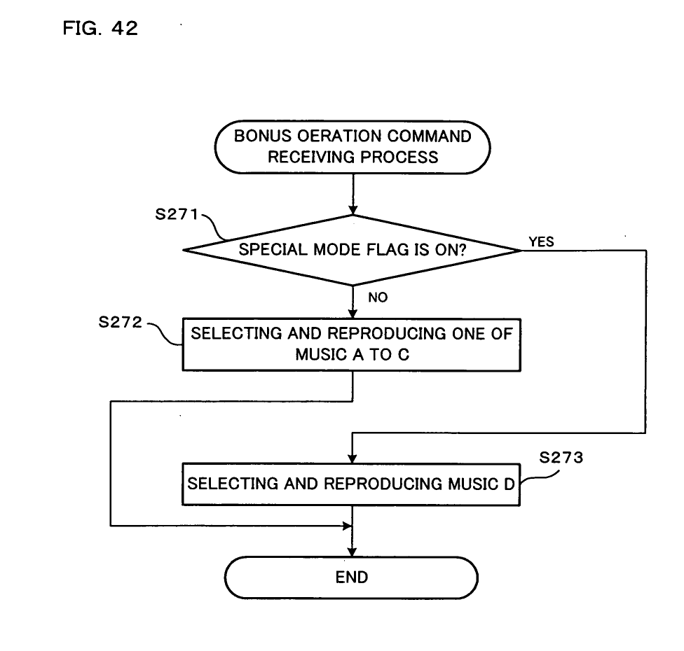

In the followings, it is described a bonus operation command receiving process for carrying out a predetermined process which is carried out with the receiving of the bonus operation command, with reference to FIG. 42. The bonus operation command receiving process is started with the receiving of the bonus operation command from the main control circuit 71.

First, the image control MICOM 81 determines whether the special mode flag is ON or not (step S271). If a result of the determination is YES, the MICOM proceeds to a step S273, otherwise proceeds to a step S272.

Herein, in one embodiment, in the middle bonus game, it is carried out a music game in which the stop operation is carried out in predetermined timing and order in correspondence with a type of music to be outputted and thus the value of the point is added. In the music game, basically, when the middle bonus game starts, one of music A to C is reproduced (i.e., outputted from the speakers 9L, 9R) which is selected by the player.

Specifically, when the middle bonus games starts, an image including identification information representing that the player can select the music A, an image including identification information representing that the player can select the music B and an image including identification information representing that the player can select the music C are sequentially displayed on the liquid crystal display device 2b. If the player carries out the insertion operation when the identification information is displayed, a music corresponding to the identification information displayed at the time of the insertion operation is selected. Then, the effect data corresponding to the type of the selected music is determined, and an image (for example, image shown in FIG. 50) corresponding to the effect data determined is displayed on the liquid crystal display unit 2b.

In the step S272, the MICOM selects (i.e., determines) and reproduces one of the music A to C, and ends the bonus operation command receiving process. Specifically, one of the music A to C is determined which is selected by the player through the insertion operation, and the determined music is reproduced (i.e., outputted from the speakers 9L, 9R). In addition, the effect data corresponding to the determined music of the music A to C is determined and an image corresponding to the determined effect data is displayed on the liquid crystal display unit 2b.

In the step S273, since the special mode flag is ON, the MICOM selects and reproduces the music D and ends the bonus operation command receiving process. Thereby, in case that the player carries out the specific stop operation to start the middle bonus game, the music D is reproduced (i.e., outputted from the speakers 9L, 9R) in the music game of the middle bonus game. In addition, the effect data corresponding to the music D is determined, and an image corresponding to the determined effect data is displayed on the liquid crystal display unit 2b.

By doing so, for example, in case that the player is bored with the music game in which the music A to C is reproduced, the player can carry out the specific stop operation to select the music D which cannot be basically selected. Accordingly, it is possible to keep up the player's interest in the music game.

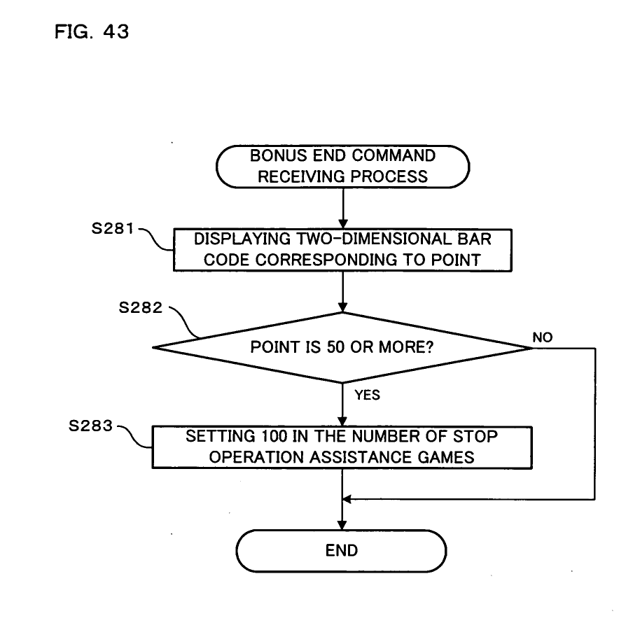

In the followings, it is described a bonus end command receiving process for carrying out a predetermined process which is carried out with the receiving of the bonus end command, with reference to FIG. 43. The bonus end command receiving process is started with the receiving of the bonus operation command from the main control circuit 71.

First, the image control MICOM 81 displays a two-dimensional bar code corresponding to the point, and proceeds to a step S282 (step S281). Specifically, the MICOM displays an image including a two-dimensional bar code such as QRcode (registered trademark) on the liquid crystal display device 2b, in accordance with the value of the point cumulatively added in the music game which has been carried out from after the middle bonus game has started (i.e., from after the bonus operation command has been received) until the corresponding middle bonus game is over.

The two-dimensional bar code includes information about URL corresponding to the value of point. The player can obtain the information of URL included in the two-dimensional bar code with a portable terminal such as cellular phone, and download the information corresponding to the URL, such as music data, from a server apparatus connected to the Internet. In other words, the payout corresponding to the value of point is awarded to the player by allowing the player to obtain the music data corresponding to the value of point cumulatively added in the music game.

In the step S282, the MICOM determines whether the point is 50 or more. If a result of the determination is YES, the MICOM proceeds to a step S283, otherwise ends the bonus end command receiving process. In the step S283, the MICOM sets 100 in the number of stop operation assistance games and ends the bonus end command receiving process. Thereby, if the middle bonus game is over, the perfect notification effect is continuously carried out over 100 games, on condition that the point is 50 or more (i.e., a result of the determination in the step S282 is YES).

In the followings, it is described a periodic intervention process under control of the sub-CPU for carrying out a predetermined process every time predetermined under control of the sub-CPU (image control MICOM 81), with reference to FIG. 44. The periodic intervention process is repetitively carried out every 2 ms.

First, the image control MICOM 81 determines whether the specific operation detection timer is 0 or not (step S291). If a result of the determination is YES, the MICOM ends the periodic intervention process under control of the sub-CPU, otherwise proceeds to a step S292. In the step S292, the MICOM subtracts 1 from the specific operation detection timer, on condition that the third stop operation command has been received (i.e., the stop button has been pushed in the third stop operation), and ends the periodic intervention process under control of the sub-CPU.

In the followings, it is described an example of an image displayed in the effect display area 23 (i.e., liquid crystal display unit 2b) for the effect, with reference to FIGS. 45 to 51.

FIG. 45 shows a display example A. The display example A is an example of an image which is displayed in the effect display area 23 as the paper airplane effect (i.e., paper airplanes A to C). In case that the effect data selected on the basis of the effect table (see FIG. 35) is ┌turning┘, the image is displayed in the effect display area 23 based on the corresponding effect data.

FIG. 45 shows a display example A. In the example A, it is displayed an image showing that the paper airplane 301 turns around a character 302. The image is displayed when the display combination command is received (i.e., when all the reels 3L, 3C, 3R are stopped).

In the effect of the paper airplane of the embodiment, an internal winning combination is notified through a color of the paper airplane. For example, the red paper airplane is displayed to notify that the internal winning combination is Cherry (i.e., color of a symbols constituting a combination of symbols corresponding to the internal winning combination is red). In case that the paper airplane effect is carried out as the perfect notification effect, the paper airplane of color corresponding to the internal winning combination is displayed without fail (i.e., in a probability of 100%), except that the losing is determined as the internal winning combination.

In addition, when the paper airplane effect is carried out in the carryover section, there is a case where the paper airplane of color corresponding to the internal winning combination is not always displayed. For example, even though the yellow paper airplane corresponding to Bell is not displayed (for example, even though the red paper airplane corresponding to Cherry has been displayed), there is a case where the combination of symbols corresponding to Bell is displayed along the activated line. By doing so, it is notified that the paper airplane effect is carried out in the carryover section.

Herein, although not shown in the effect table of FIG. 35, in fact, the effect data corresponding to the paper airplane is provided to correspond to the internal winning combination, too. For example, the effect table is provided with the effect data of paper airplane effect corresponding to Cherry. The effect data is determined, so that an image including the red paper airplane is displayed on the liquid crystal display unit 2b.

FIG. 45 is an example of an image which is displayed in the effect display area 23 in the first game of the baseball winning effect or baseball losing effect.

FIG. 46A is a display example of an image (i.e., image corresponding to the effect data ┌baseball stadium)┘ which is displayed by the start operation in the first game of baseball winning effect or baseball losing effect. In the display example of FIG. 46A, it is displayed an image showing a panoramic view of the baseball stadium.

FIG. 46B is a display example of an image (i.e., image corresponding to the effect data ┌bird's appearance┘) which is displayed by the first stop operation in the first game of baseball winning effect or baseball losing effect. In the display example of FIG. 46B, it is displayed an image showing a bird 302 in the impersonation of batter.

FIG. 46C is a display example of an image (i.e., image corresponding to the effect data ┌dog's appearance┘) which is displayed by the second stop operation in the first game of baseball winning effect or baseball losing effect. In the display example of FIG. 46C, it is displayed an image showing a dog 303 in the impersonation of pitcher.

FIG. 46D is a display example of an image (i.e., image corresponding to the effect data ┌both sides' appearance┘) which is displayed by the third stop operation in the first game of baseball winning effect or baseball losing effect. In the display example of FIG. 46D, it is displayed an image showing a bird 302 and a dog 303 facing each other.

FIG. 46E is a display example of an image (i.e., image corresponding to the effect data ┌both sides' appearance┘) which is displayed by receiving the display combination command in the first game of baseball winning effect or baseball losing effect. In the display example of FIG. 46E, it is displayed an image same as that of FIG. 46D.

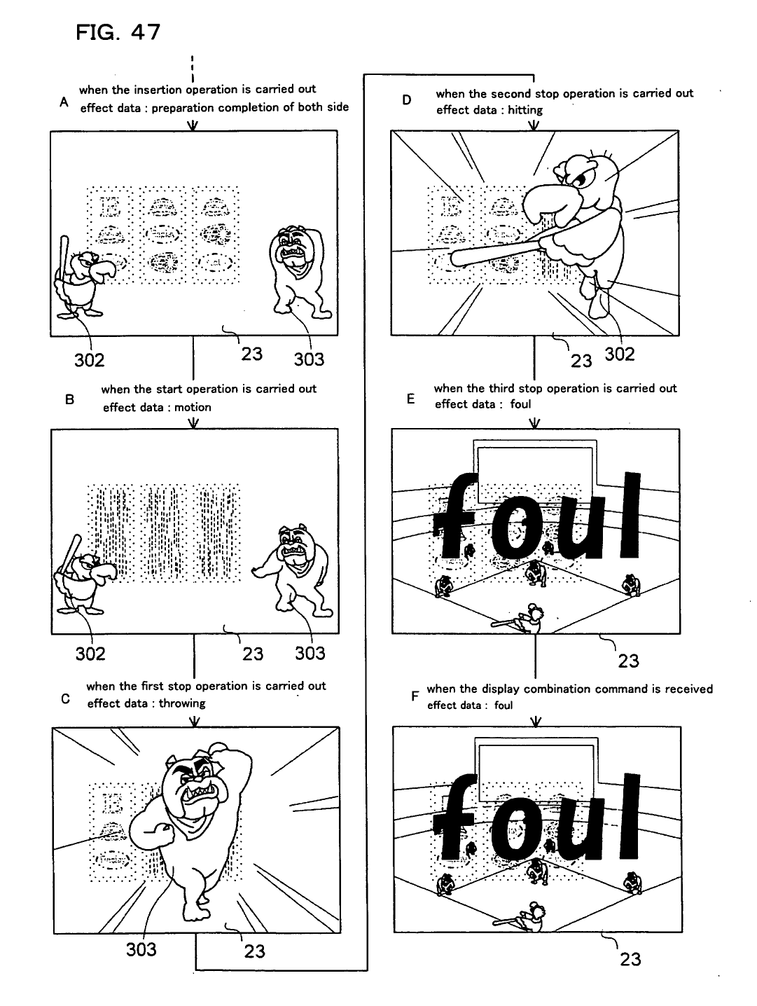

FIG. 47 is an example of an image which is displayed in the effect display area 23 in the second game of the baseball winning effect (except the baseball winning C) or baseball losing effect (except the baseball losing C).

FIG. 47A is a display example of an image (i.e., image corresponding to the effect data ┌preparation completion of both sides┘) which is displayed by the insertion operation in the second game of the baseball winning effect or baseball losing effect. In the display example of FIG. 47A, it is displayed an image showing that the bird 302 assumes a hitting posture with a bat and the dog 303 assumes a throwing posture.

FIG. 47B is a display example of an image (i.e., image corresponding to the effect data ┌motion┘) which is displayed by the start operation in the second game of the baseball winning effect or baseball losing effect. In the display example of FIG. 47B, it is displayed an image showing that the bird 302 starts to bat and the dog 303 holds the arm aloft for starting to throw a ball.

FIG. 47C is a display example of an image (i.e., image corresponding to the effect data ┌throwing┘) which is displayed by the first stop operation in the second game of the baseball winning effect or baseball losing effect. In the display example of FIG. 47C, the dog 303 is enlarged and it is displayed an image showing that the dog 303 holds the arm aloft to pitch.

FIG. 47D is a display example of an image (i.e., image corresponding to the effect data ┌hitting┘) which is displayed by the second stop operation in the second game of the baseball winning effect or baseball losing effect. In the display example of FIG. 47D, the bird 302 is enlarged and it is displayed an image showing that the bird 302 bats to hit the ball.

FIG. 47E is a display example of an image (i.e., image corresponding to the effect data ┌foul┘) which is displayed by the third stop operation in the second game of the baseball winning effect or baseball losing effect. In the display example of FIG. 47E, it is displayed an image showing that the bird hit a foul ball.

FIG. 47F is a display example of an image (i.e., image corresponding to the effect data ┌foul┘) which is displayed by the third stop operation in the second game of the baseball winning effect or baseball losing effect. In the display example of FIG. 47F, it is displayed an image same as that of FIG. 47E.

FIG. 48 is an example of an image which is displayed in the effect display area 23 in the last game of the baseball winning effect (i.e., fourth game of the baseball winning A, third game of the baseball winning B and second game of the baseball winning C).

As shown in FIGS. 48A to 48D, the examples of images which are displayed by the insertion, start, first and second operations are same as those of FIGS. 47A to 47D.

FIG. 48E is a display example of an image (i.e., image corresponding to the effect data ┌bird's expression┘) which is displayed by the third stop operation in the last game of the baseball winning effect. In the display example of FIG. 48E, the bird's face 302 is enlarged and it is displayed an image showing the bird's expression in detail.

FIG. 48F is a display example of an image (i.e., image corresponding to the effect data ┌homerun┘) which is displayed by receiving the display command (i.e., by stopping the rotations of all the reels 3L, 3C, 3R) in the last game of the baseball winning effect. In the display example of FIG. 48F, it is displayed an image (i.e., mode of the effect notifying that the replay time is operating) showing that the bird hit a homerun (i.e., the bird 302 won a victory over the dog 303).

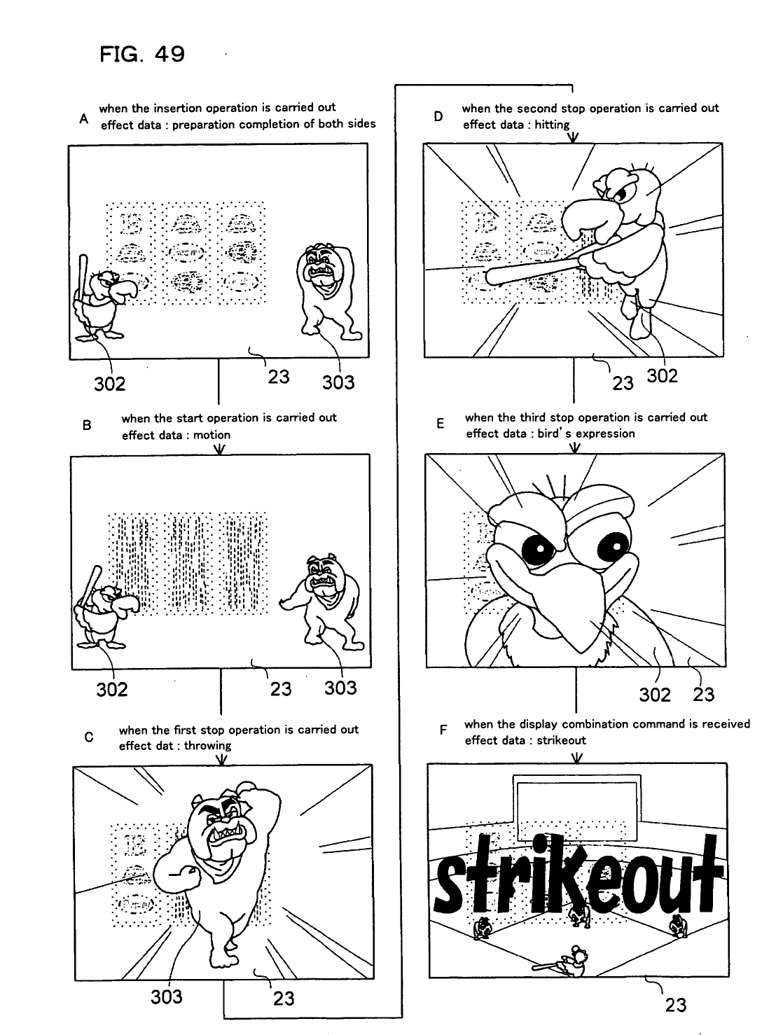

FIG. 49 is an example of an image which is displayed in the effect display area 23 in the last game of the baseball losing effect (i.e., fourth game of the baseball losing A, third game of the baseball losing B and second game of the baseball losing C).

As shown in FIGS. 49A to 49D, the examples of images which are displayed by the insertion, start, first and second operations are same as those of FIGS. 48A to 48D.

FIG. 49E is a display example of an image (i.e., image corresponding to the effect data ┌bird's expression┘) which is displayed, by the third stop operation in the last game of the baseball losing effect. In the display example of FIG. 48E, the bird's face 302 is enlarged and it is displayed an image showing the bird's expression in detail.

FIG. 49F is a display example of an image (i.e., image corresponding to the effect data ┌strikeout┘) which is displayed by the third stop operation in the last game of the baseball winning effect. In the display example of FIG. 49F, it is displayed an image showing that the bird 302 has been struck out.

Herein, in the baseball winning effect, it is displayed the image (see FIG. 48F) showing that the bird 302 won a victory over the dog 303 in the last of the effect (for example, when it is received the display combination command of the third game of the baseball winning B), so that the player perceives that the RT section is operating. In other words, it occurs such a situation that even though the RT section is operating, it is not definitely notified. In addition, in the baseball losing effect, it is displayed the image (see FIG. 49F) showing that the bird 302 lost the game to the dog 303 in the last of the effect (for example, when it is received the display combination command of the third game of the baseball losing B), and the player perceives that the RT section is not operating.

In the mean time, since the same image as the image displayed as the baseball winning effect is displayed until the middle of the baseball losing effect, it is difficult for the player to perceive that the RT section is not operating, to the last of the baseball losing effect. Accordingly, even though the RT section does not operate to the last of the baseball losing effect, it is possible to make the player expect whether it will be notified at the last stage of the corresponding effect that the RT section is operating. In other words, the player may expect that the RT section would be operating. Accordingly, it is possible to provide a gaming machine capable of keeping up the player's expectations even though the RT section is not operating.

In addition, in case that the continuous effect is carried out with the determination of RT as the internal winning combination and the notification is structured to hint that the RT section will operate from a next game, there occurs a contradiction between the control by the main control circuit 71 and the control by the sub-control circuit 72 (i.e., between the main control and the sub-control) when it is carried out a winning evasion control by an automatic stop. Specifically, even though the notification hinting that the RT section is operating has been carried out by the sub-control circuit 72, there is a worry that the main control circuit 71 may carry out the stop control for the reels 3L, 3C, 3R whose combination of symbols corresponding to RT determined as the internal winning combination is not displayed along the activated line.

In the mean time, in one embodiment, since the continuous effect is carried out after confirming that the combination of symbols corresponding to RT has been displayed along the activated line, it is possible to wipe away the above worry (accordingly, in the game in which RT has been determined as the internal winning combination, it is suitable a structure in which an effect is selected which gives the hint to such extent that the combination of symbols corresponding to RT is displayed along the activated line).

FIG. 50 shows a display example B. The display example B is an example of an image which is displayed in the effect display area 23 in an effect under RT operation. The effect under RT operation is started when the baseball winning effect is over during the operation of the RT section, and is over when the corresponding RT section is over. In other words, even though the RT section is operating, the effect under RT operation is not carried out until the baseball winning effect is over.

In the display example B of FIG. 50, it is displayed an image including a queen game mark 304 representing that the RT section is operating. By displaying such image, the player can play the game while certainly perceiving that the RT section is operating.

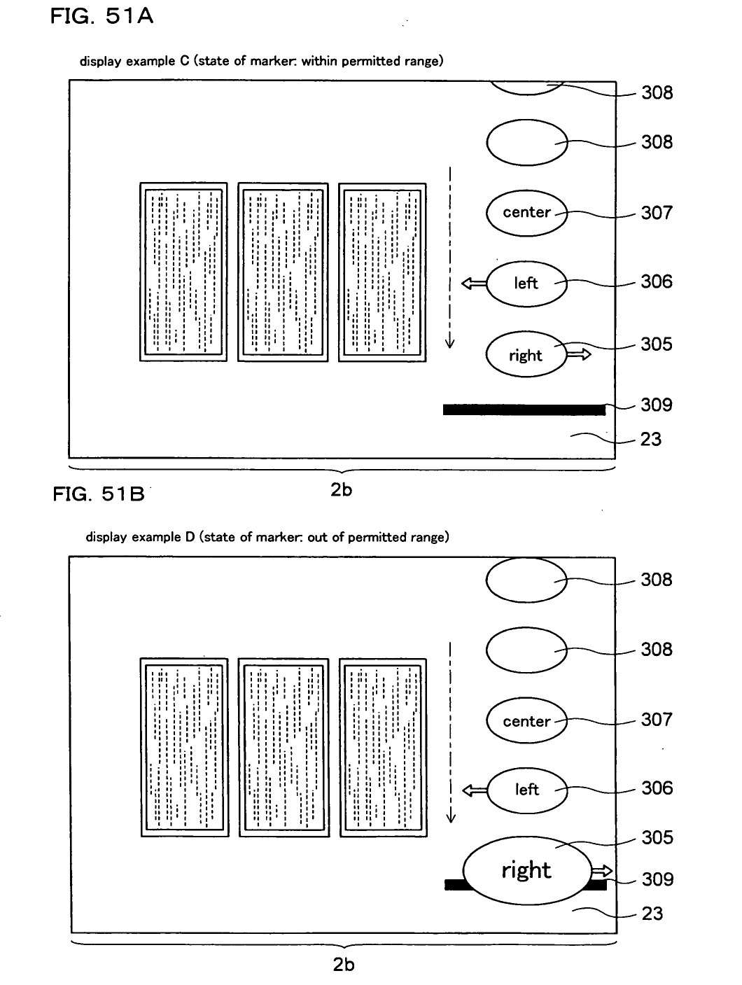

In the followings, it is described an image which is displayed in the effect display area 23 in a music game, and the stop operation of the player during the music game, with reference to FIG. 51.

Herein, in the music game, it is displayed images including plural elliptical markers 305 to 308 arranged in a row in the right area of the effect display area 23 (i.e., right marker 305, left marker 306, center mark 307 and plain marker 308) and a rectangular bar 309 which is long in a horizontal direction. Such images are continuously displayed, so that it is displayed in the effect display area 23 a moving picture showing that the markers arranged in a row move in arrow directions of FIGS. 51(1) and 51(2).

Each of the markers 305 to 308 is provided to correspond to the stop buttons 7L, 7C, 7R. Specifically, the right marker 305 corresponds to the right stop button 7R. In addition, the left marker 306 corresponds to the left stop button 7L. Additionally, the center marker 307 corresponds to the center stop button 7C. Further, the plain marker 308 corresponds to all the stop buttons 7L, 7C, 7R.

In the music game, in case that an image representing that any one of the markers 305 to 308 overlaps the bar 309 (such state of the marker is referred to as ┌within the permitted range┘) is displayed and it is carried out the push operation of the stop button corresponding to the corresponding marker at the timing at which such image is displayed, a predetermined value is added to the value of point.

Specifically, in case that the stop operation of the right stop button 7R is carried out at the time when the right marker 305 is within the permitted range, in case that the stop operation of the left stop button 7L is carried out at the time when the left marker 306 is within the permitted range, and in case that the stop operation of the center stop button 7C is carried out at the time when the center marker 307 is within the permitted range, ┌2┘ is added to the value of point. In addition, in case that the stop operation of any one of the stop buttons 7L. 7C, 7R is carried out at the time when the plain marker 308 is within the permitted range, ┌1┘ is added to the value of point.

In addition, in case that an image representing that any one of the markers 305 to 308 does not overlap the bar 309 (such state of the marker is referred to as ┌out of the permitted range┘) is displayed and it is carried out the push operation of the stop button corresponding to the corresponding marker at the timing at which such image is displayed, the value of point is not added.

In addition, if the music game starts,.the right marker 305, the left marker 306 and the center marker 307 are respectively allowed to be within the permitted range by one time (i.e., total 3 times). Accordingly, whenever the right marker 305, the left marker 306 and the center marker 307 are respectively allowed to be within the permitted range by one time, if the player successively pushes the stop button corresponding to the marker within the permitted range, ┌6┘ is added to the value of point in one game.

In addition, after the right marker 305, the left marker 306 and the center marker 307 are respectively allowed to be within the permitted range by one time, the plain marker 308 is allowed to be within the permitted range. Therefore, even though the player fails to push the stop button corresponding to the marker within the permitted range at the time when the right marker 305, the left marker 306 and the center marker 307 are within the permitted ranged, if the player pushes any one of the stop buttons 7L, 7C, 7R at the time when the plain marker 308 is within the permitted range, ┌1┘ is added to the value of point. As a result, it is possible to relieve the player who failed to push the stop button in the music game.

FIG. 51A shows a display example C. The display example C is an example of an image which is displayed in the effect display area 23 when the marker is out of the permitted range in the music game.

In the display example C of FIG. 51A, it is displayed an image representing that no markers 350 to 308 do not overlap the bar 309 (i.e., all the markers are out of the permitted range). In case that the player carries out the stop operation when such image is displayed, the value of point is not added.

FIG. 51B shows a display example D. The display example D is an example of an image which is displayed in the effect display area 23 when the marker is within the permitted range in the music game.

In the display example D of FIG. 51B, it is displayed an image representing that the right marker 305 overlaps the bar 309 (i.e., the right marker 305 is within the permitted range) with being enlarged. In case that the player pushes the right stop button 7R when such image is displayed, ┌2┘ is added to the value of point.

Like this, in one embodiment, in case that the markers 305 to 308 are within the permitted range, it is adapted to show an image of which the corresponding marker 305 to 308 is enlarged as compared to the case where the markers are out of the permitted range. Thereby, the player can push the stop buttons 7L, 7C, 7R while more correctly perceiving the timing at which the markers 305 to 308 are within the permitted range.

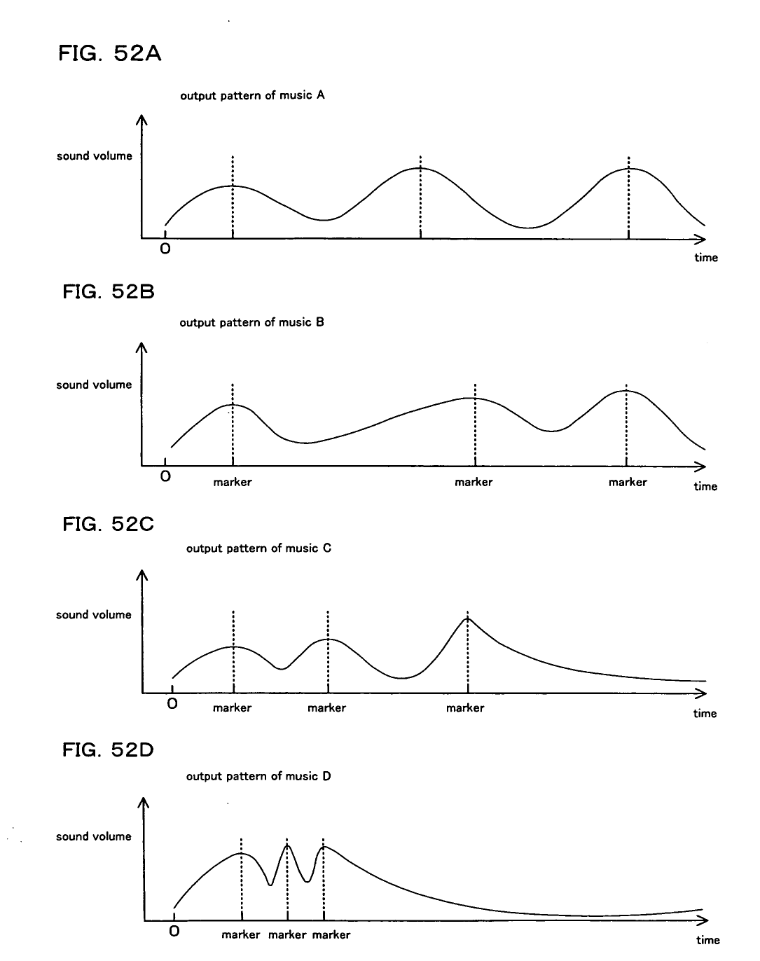

In the followings, it is described an output pattern in the music game and the degree of difficulty of the music game, with reference to graphs shown in FIG. 52.

FIGS. 52A to 52D are graphs showing output patterns of music A to D. These graphs comprise a x-axis in which the time from after a music game is started is indicated, and a y-axis in which a sound volume outputted from the music game is indicated. According to the graphs, when the music A to D is reproduced, the sound volume thereof is maximized at least 3 times. The time at which the sound volume of the music is maximized is approximately identical to the time at which the markers 305 to 307 are within the permitted range.

Accordingly, in the music game, when the marker 305 to 307 are within the permitted range and the player pushes the stop button corresponding to the corresponding marker 305 to 307 at the timing at which the sound volume of the music is maximized, the value of point is added. By doing so, the player can enjoy the rhythmical stop operation by carrying out the stop operation at the timing matched to the outputted music in the music game. In addition, in one embodiment, since the music game is carried out in the middle bonus game, it is possible to further improve the player's interest in the middle bonus game.

Herein, according to the output patterns of the music A to D shown in FIGS. 52A to 52D, a frequency that the sound volume of the music D is maximized is relatively higher than those of the sound volumes of the music A to C. In other words, the frequency that the markers 305 to 307 are allowed to be within the permitted range per time in the music game in which the music D is outputted is relatively higher than that of the music game in which the music A to C is outputted. Accordingly, an interval of time at which the markers 305 to 307 are within the permitted range in the music game in which the music D is outputted is relatively shorter than an interval of time at which the markers 305 to 307 are within the permitted range in the music game in which the music A to C is outputted.

Therefore, the player should carry out the stop operation with a relatively short time interval so that the point is added in the music game in which the music D is outputted, as compared to the music game in which the music A to C is outputted. As a result, the degree of difficulty of the music game in which the music D is outputted is relatively higher than that of the music game in which the music A to C is outputted. In the mean time, in one embodiment, in case that the specific stop operation is carried out to start the middle bonus game, it is adapted to output the music D in the music game.

By doing so, in case that the player gets used to the degree of difficulty of the music game in which the music A to C is outputted, the player himself may carry out a specific stop operation so that the more difficult music game is carried out, and enjoy the music game in which the music D is outputted. Accordingly, it is possible to increase the player's interest in the music game and to prevent the player's interest in the music game from being decreased because the player gets used to the degree of difficulty of the music game.

In addition, it is necessary for the player to carry out the specific stop operation, i.e., a stop operation which is not typically carried out so that the music D is outputted in the music game. By adopting such stop operation as a condition for outputting the music D in the music game, it is possible to evade a worry that the music game is started against the player's intention who is not interested in the music game having the high degree of difficulty. In addition, it is possible to provide a gaming machine with which both a player who is interested in a music game having the high degree of difficulty and a player who is not interested in the corresponding game can take pleasure in the music game.

### Modified Embodiment

While the invention has been described with reference to the embodiments, the invention is not limited thereto.

In one embodiment, when the combination of symbols consisting of two types of symbols (for example, ┌Replay-Replay-E┘) is displayed along the activated line, the RT section operates. However, the invention is not limited thereto. For example, when a combination of symbols (for example, ┌Bell-Replay-Bell┘) in which same symbols are not arranged to be adjacent to each other is displayed as the combination of symbols consisting of the two types of symbols, the RT section may operate.

In addition, when a combination of symbols consisting of different types of symbols (for example, ┌Replay-Bell-E┘) is displayed along the activated line, the RT section may operate. Also in such structure, it is possible to give the player a surprise that the RT section has started to operate without the player's knowing it. In addition, even though the RT section is not operating, it is possible to provide the player with expectations that the RT section may be operating.

In addition, if the RT section operates, on condition that the combination of symbols comprising a symbol (so-called ┌blank symbol┘) is displayed along the activated line, which does not award a payout to the player even though the combination of symbols consisting of same symbols (for example, ┌E┘) is displayed along the activated line, it is possible to increase the player's unexpectations.

In one embodiment, in case that the combination of symbols corresponding to RT is displayed along the activated line in the RT1 section, the RT1 section is over and the RT2 section operates which is continued over maximum 1,000 games. However, the invention is not limited thereto. For example, the RT2 section, which starts to operate after the RT1 section is over, may continue over the number of games besides 1,000 games. Also in such case, it is possible to prevent the game in which the RT section operates from being monotonous and to maintain the player's interest in the game during the RT section.

In one embodiment, in case that the combination of symbols corresponding to RT is displayed along the activated line in the RT1 section which operates on condition that the MB gaming state is over, the RT2 section operates, and in case that the combination of symbols corresponding to RT is displayed in the RT2 section, the RT2 section does not operate newly. However, the invention is not limited thereto.

For example, it may be structured as follows: in case that the combination of symbols corresponding to RT is displayed along the activated line in the RT1 section which operates on condition that the MB gaming state is over, the RT2 section does not operate, and in case that the combination of symbols corresponding to RT is displayed in the RT2 section, the RT2 section operates newly. Also in such case, the game in which the RT section operates becomes not monotonous, so that it is possible to maintain the player's interest in the game during the RT section, and to prevent the RT section from continuing beyond necessity.

In one embodiment, it is structured in such a way that the priority attraction-in ranking of RT (i.e., priority ranking ┌4┘) is lower than that of Small Win of 10 pieces (i.e., priority ranking ┌3┘) in accordance with the priority attraction-in ranking table (see FIG. 15), thereby preventing the combination of symbols corresponding to RT from being displayed along the activated line in the MB gaming state. However, the invention is not limited thereto.

Specifically, in addition to Small Win of 10 pieces, it may be provided Small Win having a priority attraction-in ranking higher than that of RT. Also in such case, in the MB gaming state, it is possible to prevent the combination of symbols corresponding to RT from being displayed along the activated line and the great difference between the payouts to be awarded to the players from occurring.

In addition, in one embodiment, it is structured in such a way that the priority attraction-in ranking of RT is lower than that of another Small Win, thereby preventing the combination of symbols corresponding to RT from being displayed along the activated line in the MB gaming state. However, the invention is not limited thereto. Specifically, in a gaming machine wherein a gaming state (for example, CT gaming state) operates in which the player's ability to perform the stop operation is reflected on payouts to be awarded to the player, as a gaming state different from the MB gaming state, the priority attraction-in ranking of RT may be lower than that of another Small Win.

Also in such structure, in the gaming state in which the player's ability to perform the stop operation is reflected on payouts to be awarded to the player, it is possible to prevent the combination of symbols corresponding to RT from being displayed along the activated line and the great difference between the payouts to be awarded to the players from occurring.

In one embodiment, while the RT section is basically continued over maximum 1,000 games, the invention is not limited thereto. Specifically, the RT section is preferably continued, to the utmost, over the number of games larger than a reciprocal of a probability that a bonus will be determined as an internal winning combination (for example, probability that MB1 and MB2, which are defined by an internal lottery table for the normal gaming state (see FIG. 8), will be determined as an internal winning combination).

By dosing so, it is possible to sufficiently increase a probability that a bonus will be determined as an internal winning combination in a period during which the RT section operates, and thus to further enhance a joy which may be obtained when the player recognizes that the RT section has operated.

In one embodiment, in the last game of the baseball winning effect, it is carried out the notification which enables the player to perceive that the RT section is operating (i.e., image corresponding to the effect data ┌homerun┘ is displayed┘, and in the last game of the baseball losing effect, it is carried out the notification which enables the player to perceive that the RT section is not operating (i.e., image corresponding to the effect data ┌strikeout┘ is displayed). However, the invention is not limited thereto. For example, in the baseball winning effect (i.e., premonition effect), it may not be carried out the notification which enables the player to perceive that the RT section is operating.

Also in such structure, the player can perceive that the effect under RT operation is started when the premonition effect is over and the RT section is operating. In addition, it may be structured in such a way that the same premonition effect is started in the normal gaming state, too, in addition to the RT section. By doing so, it is possible to provide the player with the expectations that the RT section is operating, even though the RT section does not operate.

In addition, in one embodiment, before it is carried out the control for stopping the rotations of the reels 3L, 3C, 3R, it is carried out the expectation of the display combination which may be determined after each of the reels 3L, 3C, 3R is stopped. After that, the control for stopping the rotations of the reels 3L, 3C, 3R is carried out on the basis of the corresponding expectation (for example, expected display combination data which is stored in the display combination storing area). However, the invention is not limited thereto. For example, it may be structured in such a way that it is provided a stop table for determining a stop mode (for example, expected stop position) of the reel in accordance with the operation of the stop button (for example, stop operation position when the stop button is pushed), and it is carried out the control for stopping the rotation of the reel by referring to the corresponding the stop table.

Further, in one embodiment, when ┌Replay-Replay-E┘, ┌Replay-Replay-Blue 7┘ or ┌Replay-Replay-Watermelon┘ is displayed along the activated line, RT (i.e., ┌000100000┘┘ becomes the display combination. In other words, the one display combination corresponds to the plural combinations of symbols. However, the invention is not limited thereto. For example, it may be structured in such a way that a combination of symbols corresponds to a display combination by one to one (for example, it may be provided display combinations corresponding to ┌Replay-Replay-E┘, ┌Replay-Replay-Blue 7┘ and ┌Replay-Replay-Watermelon┘, respectively).

Additionally, the invention can be applied to another gaming machine such as pachinko gaming machine, pachi-lot and the like, in addition to the gaming machine 1 of the embodiment. In addition, the invention can be applied to a game program which pseudo-executes the game of the pachi-slot machine 1 described in the embodiment 3 as a home gaming machine. In this case, a medium for recording the game program may include a CD-ROM, FD (flexible disk) and the other recording media.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
symbol display means having plural symbol display areas, each of which areas displaying a symbol, and displaying plural symbols;
start operation detection means for detecting a start operation;
internal winning combination determination means for determining an internal winning combination, based on the start operation detection carried out by said start operation detection means;
symbol varying means for varying symbols to be displayed by the symbol display means, on the basis of the start operation detection carried out by said start operation detection means;
stop operation detection means for detecting a stop operation;
stop control means for carrying out a stop control of the symbol variation carried out by said symbol varying means, based on the internal winning combination determined by said internal winning combination determination means and the stop operation detection carried out by said stop operation detection means; and
replay time operating means for starting an operation of replay time, on condition that a combination of symbols consisting of at least two types of symbols is displayed by a predetermined combination of the symbol display areas.

2. The gaming machine according to claim 1, wherein said replay time operating means starts the operation of replay time, on condition that a combination of symbols in which same symbols are not arranged to be adjacent to each other is displayed by the predetermined combination of the symbol display areas.

3. The gaming machine according to claim 2, wherein the replay time operating means starts the operation of replay time, on condition that a combination of symbols consisting of symbols different from each other is displayed by the predetermined combination of said symbol display areas.

4. A gaming machine comprising:
symbol display means for displaying plural symbols;
start operation detection means for detecting a start operation;
internal winning combination determination means for determining an internal winning combination, based on the start operation detection carried out by said start operation detection means;
symbol varying means for varying symbols to be displayed by said symbol display means, on the basis of the start operation detection carried out by said start operation detection means;
stop operation detection means for detecting a stop operation;
stop control means for carrying out a stop control of the symbol variation carried out by the symbol varying means, based on the internal winning combination determined by said internal winning combination determination means and the stop operation detection carried out by said stop operation detection means;
bonus game operating means for carrying out an operation of a bonus game;
first replay time operating means for starting an operation of replay time when the operation of the bonus game is over;
second replay time operating means for starting an operation of the replay time, on condition that a predetermined condition is fulfilled, when a combination of symbols predetermined is displayed by said symbol display means;
numerical value information update means for updating numerical value information, on condition that a start operation detection is carried out by said start operation detection means or a stop operation detection is carried out by said stop operation detection means; and
replay time ending means for ending the operation of replay time, when said numerical value information becomes a predetermined value as a result of the update carried out by said numerical value information update means,
wherein said predetermined condition is fulfilled when the replay time does not operate, which has started according as the combination of symbols predetermined is displayed by said symbol display means.

5. A gaming machine comprising:
symbol display means for displaying plural symbols;
start operation detection means for detecting a start operation;
internal winning combination determination means for determining an internal winning combination, based on the start operation detection carried out by said start operation detection means;
symbol varying means for varying symbols to be displayed by said symbol display means on the basis of the start operation detection carried out by said start operation detection means;
stop operation detection means for detecting a stop operation;
stop control means for carrying out a stop control of the symbol variation carried out by the symbol varying means, based on the internal winning combination determined by said internal winning combination determination means and the stop operation detection carried out by said stop operation detection means;
replay time operating means for carrying out an operation of replay time;
effect mode determination means for determining an effect mode;
specific effect section operation means for operating a specific effect section in which a mode of a specific effect is determined by said effect mode determination means, irrespective of whether the operation of the replay time is carried out or not;
numerical value information update means for updating numerical value information, on condition that a start operation detection is carried out by said start operation detection means or a stop operation detection is carried out by said stop operation detection means; and
specific effect section ending means for ending the specific effect section, when said numerical value information becomes a predetermined value, as a result of the update carried out by said numerical value information update means,
wherein on condition that the operation of replay time is carried out when the operation of said specific effect section is carried out or when the operation of said specific effect section is over, said effect mode determination means determines an effect mode notifying that the operation of the corresponding replay time is carried out.

6. A gaming machine comprising:
symbol display means for displaying plural symbols;
start operation detection means for detecting a start operation;
internal winning combination determination means for determining an internal winning combination, based on the start operation detection carried out by said start operation detection means;
symbol varying means for varying symbols to be displayed by said symbol display means, on the basis of the start operation detection carried out by said start operation detection means;
stop operation detection means for detecting a stop operation;
stop control means for carrying out a stop control of the symbol variation carried out by said symbol varying means, based on the internal winning combination determined by said internal winning prize determination means and the stop operation detection carried out by said stop operation detection means;
bonus game operating means for carrying out an operation of a bonus game in which said stop control means carries out a stop control of the symbol variation carried out by said symbol varying means, based on the stop operation detection carried out by said stop operation detection means, with regard to at least one of plural rows; and
replay time operating means for carrying out an operation of replay time when a combination of specific symbols is displayed by said symbol display means,
wherein said stop control means carries out the stop control of the symbol variation carried by said symbol varying means, based on priority ranking information in which a combination of symbols different from the combination of specific symbols has a priority over the combination of specific symbols.
